(19) United States
(12) Patent Application Publication
(10) Pub. No.: US 2023/0273345 A1
(43) Pub. Date: Aug. 31, 2023

(54) COATED ARTICLES HAVING NON-PLANAR SUBSTRATES AND METHODS FOR THE PRODUCTION THEREOF

(71) Applicants: CORNING INCORPORATED, CORNING, NY (US); CORNING PRECISION MATERIALS CO., LTD., ASAN-SI (KR)

(72) Inventors: Jaymin Amin, Corning, NY (US); Jason Thomas Harris, Horseheads, NY (US); Shandon Dee Hart, Elmira, NY (US); Karl William Koch, III, Elmira, NY (US); Carlo Anthony Kosik Williams, Painted Post, NY (US); Lin Lin, Painted Post, NY (US); Alexandre Michel Mayolet, Corning, NY (US); Dong-gun Moon, Yongin-si (KR); Jeonghong Oh, Cheonan-si (KR); James Joseph Price, Corning, NY (US); Charlene Marie Smith, Corning, NY (US); Ananthanarayanan Subramanian, Corning, NY (US); Ljerka Ukrainczyk, Ithaca, NY (US); Tingge Xu, Santa Clara, CA (US)

(21) Appl. No.: 18/113,140

(22) Filed: Feb. 23, 2023

Related U.S. Application Data
(60) Provisional application No. 63/314,041, filed on Feb. 25, 2022.
(60) Provisional application No. 63/442,486, filed on Feb. 1, 2023.

(51) Int. Cl. G02B 1/11

(52) U.S. Cl. CPC G02B 1/11

(57) ABSTRACT

Articles are described that may include substrates having a major surface, the major surface comprising a first portion and a second portion. A first direction that is normal to the first portion of the major surface may not be equal to a second direction that is normal to the second portion of the major surface. The angle between the first direction and the second direction may be at least 15 degrees. An optical coating may be disposed on at least the first portion and the second portion of the major surface. The optical coating may form an antireflective surface.

### CLAIM OF PRIORITY

This application claims the benefit of priority under 35 U.S.C. § 119(e) of U.S. Provisional Application No. 63/314,041, filed on Feb. 25, 2022, and of U.S. Provisional Application No. 63/442,486, filed on Feb. 1, 2023, the content of which is relied upon and incorporated herein by reference in its entirety.

### FIELD OF THE DISCLOSURE

This disclosure relates to coated articles and, more particularly, to coated articles having non-planar substrates.

### BACKGROUND

Cover articles are often used to protect critical devices within electronic products, to provide a user interface for input and/or display, and/or many other functions. Such products include mobile devices, such as smart phones, mp3 players, and computer tablets. Cover articles also include architectural articles, transportation articles (e.g., articles used in automotive applications, trains, aircraft, sea craft, etc.), appliance articles, or any article that requires some transparency, scratch-resistance, abrasion resistance, or a combination thereof. These applications often demand scratch-resistance and strong optical performance characteristics, in terms of maximum light transmittance and minimum reflectance. Furthermore, some cover applications require that the color exhibited or perceived, in reflection and/or transmission, does not change appreciably as the viewing angle is changed. In display applications, this is because if the color in reflection or transmission changes with viewing angle to an appreciable degree, the user of the product will perceive a change in color or brightness of the display, which can diminish the perceived quality of the display. In other applications, changes in color may negatively impact the aesthetic requirements or other functional requirements.

The optical performance of cover articles can be improved by using various anti-reflective coatings; however, known anti-reflective coatings are susceptible to wear, abrasion and/or scratch damage. Such wear, abrasion and scratch damage can compromise any optical performance improvements achieved by the anti-reflective coating. For example, optical filters are often made from multilayer coatings having differing refractive indices and made from optically transparent dielectric material (e.g., oxides, nitrides, and fluorides). Most of the typical oxides used for such optical filters are wide band-gap materials, which do not have the requisite mechanical properties, such as hardness, for use in mobile devices, architectural articles, transportation articles or appliance articles. Nitrides and diamond-like coatings may exhibit high hardness values but such materials typically do not exhibit the transmittance needed for such applications.

Some electronics incorporate non-planar cover articles. For example, some smart phone touch screens may be non-planar, where at least a portion of the cover article is curved on its surface. Similarly, some smart watches may be non-planar, where at least a portion of the cover article is curved on its surface. With the incorporation of non-planar articles, optical performance of coatings on cover articles may be altered. For example, a coating will be viewed at two different angles on different portions of a substrate if the substrate includes one or more curved, faceted, or otherwise shaped, non-planar surfaces in addition to a planar surface portion.

Conventional cover articles employing glass or glass-ceramic substrates and optical coatings can suffer from reduced article-level mechanical performance. In particular, the inclusion of optical coatings on these substrates has provided advantages in terms of optical performance and certain mechanical properties (e.g., scratch resistance); however, conventional combinations of these substrates and optical coatings (e.g., as optimized for improved scratch resistance with high modulus and/or hardness) has resulted in inferior strength levels for the resultant article. Notably, it appears that the presence of the optical coating on the substrate can disadvantageously reduce the strength level of the article to a level below the strength of the substrate in a bare form without the optical coating.

Accordingly, there is a need for non-planar cover articles, and methods for their manufacture, which are abrasion resistant, scratch-resistant, and/or have improved optical performance. There is also a need for optical coating configurations with these properties that are suitable for non-planar cover articles and the various line-of-sight processes for forming such coatings.

### SUMMARY

In one or more embodiments, a coated article may comprise a substrate having a major surface. The major surface may comprise a first portion and a second portion. A first direction that is normal to the first portion of the major surface may not be equal to a second direction that is normal to the second portion of the major surface. The angle between the first direction and the second direction may be at least 15 degrees. An optical coating may be disposed on at least the first portion and the second portion of the major surface. The optical coating may form an anti-reflective surface. A thickness of the optical coating on the second portion as measured normal to the major surface at the second portion may be 70% or less than a thickness of the optical coating on the first portion as measured normal to the major surface at the first portion. The coated article may exhibit a single side light reflectance of about 3% or less at all wavelengths from 410 nm to at least 1050 nm as measured at the first portion of the major surface at an angle of incidence of 5 degrees.

In another embodiment, a coated article may comprise a substrate having a major surface. The major surface may comprise a first portion and a second portion. A first direction that is normal to the first portion of the major surface may not be equal to a second direction that is normal to the second portion of the major surface. The angle between the first direction and the second direction may be at least 30 degrees. An optical coating may be disposed on at least the first portion and the second portion of the major surface. The optical coating may form an anti-reflective surface. The coated article may exhibit a photopic average single side light reflectance of about 8% or less as measured at the first portion of the major surface at an angle of incidence of 5 degrees.

In another embodiment, a coated article may comprise a substrate having a major surface. The major surface may comprise a first portion and a second portion. A first direction that is normal to the first portion of the major surface may not be equal to a second direction that is normal to the second portion of the major surface. The angle between the first direction and the second direction may be at least 15 degrees. An optical coating may be disposed on at least the first portion and the second portion of the major surface. The optical coating may form an anti-reflective surface. A thickness of the optical coating on the second portion as measured normal to the major surface at the second portion may be 70% or less than a thickness of the optical coating on the first portion as measured normal to the major surface at the first portion. A first surface reflected color of the coated article at the first portion may be defined by b*<2.5 for all angles of incidence from 0 degrees to 90 degrees as measured normal to the first portion of the major surface, as measured by the reflectance color coordinates in the (L*, a*, b*) colorimetry system under an International Commission on Illumination D65 illuminant. A first surface reflected color of the coated article at the second portion may be defined by b*<2.5 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

In another embodiment, a coated article may comprise a substrate having a major surface. The major surface may comprise a first portion and a second portion. A first direction that is normal to the first portion of the major surface may not be equal to a second direction that is normal to the second portion of the major surface. The angle between the first direction and the second direction may be at least 30 degrees. An optical coating may be disposed on at least the first portion and the second portion of the major surface. The optical coating may form an anti-reflective surface. A first surface reflected color of the coated article at the first portion may be defined by b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant. A first surface reflected color of the coated article at the second portion may be defined by b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant.

In yet another embodiment, a coated article may comprise a substrate having a major surface. The major surface may comprise a first portion and a second portion. A first direction that is normal to the first portion of the major surface may not equal to a second direction that is normal to the second portion of the major surface. The angle between the first direction and the second direction may be at least 15 degrees. An optical coating may be disposed on at least the first portion and the second portion of the major surface. The optical coating may form an anti-reflective surface. A thickness of the optical coating on the second portion as measured normal to the major surface at the second portion may be 50% or less than a thickness of the optical coating on the first portion as measured normal to the major surface at the first portion. A first surface reflected color of the coated article at the first portion may be defined by −10<a*<10 and −10<b*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant. A first surface reflected color of the coated article at the second portion may be defined by −10<a*<10 and −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

In yet another embodiment, a coated article may comprise a substrate having a major surface. The major surface may comprise a first portion and a second portion. A first direction that is normal to the first portion of the major surface may not be equal to a second direction that is normal to the second portion of the major surface. The angle between the first direction and the second direction may be at least 30 degrees. The coated article may comprise an optical film structure defining an outer surface. The optical film structure may be disposed on the major surface. The optical film structure may comprise a scratch-resistant layer and a plurality of alternating high refractive index (RI) and low RI layers. The optical film structure may further comprise an outer structure and an inner structure. The scratch-resistant layer may be disposed between the outer and inner structures. The outer structure may comprise at least one medium RI layer in contact with one of the high RI layers or the scratch-resistant layer. The medium RI layer may comprise a refractive index from 1.55 to 1.80. Each of the high RI layers may comprise a refractive index of greater than 1.80. Each of the low RI layers may comprise a refractive index of less than 1.55.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a cross-sectional side view of a coated article, according to one or more embodiments described herein;

FIG. 2 is a cross-sectional side view of a coated article, according to one or more embodiments described herein;

FIG. 3 is a cross-sectional side view of a coated article, according to one or more embodiments described herein;

FIG. 4 is a cross-sectional side view of a coated article, according to one or more embodiments described herein;

FIG. 5 is a cross-sectional side view of a coated article, according to one or more embodiments described herein;

FIG. 6 is a cross-sectional side view of a coated article, according to one or more embodiments described herein;

FIG. 7 is a cross-sectional side view of a coated article, according to one or more embodiments described herein;

FIG. 8 is a cross-sectional side view of a coated article, according to one or more embodiments described herein;

FIG. 9 is a plot of optical coating thickness scaling factor v. part surface curvature for a deposition process, according to one or more embodiments described herein;

FIG. 10A is a plan view of an exemplary electronic device incorporating any of the coated articles disclosed herein;

FIG. 10B is a perspective view of the exemplary electronic device of FIG. 10A;

FIG. 11 is a plot of first-surface reflected color with a D65 illuminant for all viewing angles from 0 to 90 degrees for the comparative optical coating at seven optical coating thickness scaling factor values;

FIG. 12 is a plot of first-surface photopic average reflectance v. incident light wavelength at a near-normal light incidence angle (5 degrees) for the comparative optical coating of FIG. 11 and aoptical coating of Example 1 of the disclosure;

FIG. 13 is a plot of first-surface reflected color with a D65 illuminant for all viewing angles from 0 to 90 degrees for the optical coating of Example 1 at eight optical coating thickness scaling factor values;

FIG. 14 is a plot of first-surface photopic average reflectance v. incident light wavelength at a near-normal light incidence angle (5 degrees) for an optical coating of Example 2 of the disclosure;

FIG. 15 is a plot of first-surface reflected color with a D65 illuminant for all viewing angles from 0 to 90 degrees for the exemplary optical coating of Example 2 at fourteen optical coating thickness scaling factor values;

FIG. 16 is a plot of first-surface photopic average reflectance v. incident light wavelength at a near-normal light incidence angle (5 degrees) for an optical coating of Example 3 of the disclosure;

FIG. 17 is a plot of first-surface reflected color with a D65 illuminant for all viewing angles from 0 to 90 degrees for the exemplary optical coating of Example 3 at fourteen optical coating thickness scaling factor values;

FIG. 18 is a plot of first-surface photopic average reflectance v. incident light wavelength at a near-normal light incidence angle (5 degrees) for an optical coating of Example 4 of the disclosure;

FIG. 19 is a plot of first-surface reflected color with a D65 illuminant for all viewing angles from 0 to 90 degrees for the exemplary optical coating of Example 4 at thirteen optical coating thickness scaling factor values;

FIG. 20 is a plot of first-surface photopic average reflectance v. incident light wavelength at a near-normal light incidence angle (5 degrees) for an optical coating of Example 5 of the disclosure;

FIG. 21 is a plot of first-surface reflected color with a D65 illuminant for all viewing angles from 0 to 90 degrees for the exemplary optical coating of Example 5 at fourteen optical coating thickness scaling factor values;

FIG. 22 is a plot of first-surface reflected color with a D65 illuminant for all viewing angles from 0 to 90 degrees for an exemplary optical coating of Example 5A of the disclosure at fourteen optical coating thickness scaling factor values;

FIG. 23 is a plot of first-surface photopic average reflectance v. incident light wavelength at a near-normal light incidence angle (5 degrees) for an optical coating of Example 6 of the disclosure;

FIG. 24 is a plot of first-surface reflected color with a D65 illuminant for all viewing angles from 0 to 90 degrees for the exemplary optical coating of Example 6 at fifteen optical coating thickness scaling factor values; and

FIG. 25 is a plot of first-surface reflected color with a D65 illuminant for all viewing angles from 0 to 90 degrees for an optical coating of Example 6A of the disclosure at fourteen optical coating thickness scaling factor values;

FIG. 26 is a plot of first-surface photopic average reflectance v. incident light wavelength at a near-normal light incidence angle (5 degrees) for an optical coating of Example 7 of the disclosure;

FIG. 27 is a plot of first-surface reflected color with a D65 illuminant for all viewing angles from 0 to 90 degrees for an optical coating of Example 7 of the disclosure at twelve optical coating thickness scaling factor values;

FIG. 28 is a plot of first-surface photopic average reflectance v. incident light wavelength at a near-normal light incidence angle (5 degrees) for an optical coating of Example 8 of the disclosure;

FIG. 29 is a plot of first-surface reflected color with a D65 illuminant for all viewing angles from 0 to 90 degrees for an optical coating of Example 8 of the disclosure at twelve optical coating thickness scaling factor values;

FIG. 30 is a plot of first-surface photopic average reflectance v. incident light wavelength at a near-normal light incidence angle (5 degrees) for an optical coating of Example 9 of the disclosure;

FIG. 31 is a plot of first-surface reflected color with a D65 illuminant for all viewing angles from 0 to 90 degrees for an optical coating of Example 9 of the disclosure at eight optical coating thickness scaling factor values;

FIG. 32 is a plot of first-surface photopic average reflectance v. incident light wavelength at a near-normal light incidence angle (5 degrees) for an optical coating of Example 10 of the disclosure;

FIG. 33 is a plot of first-surface reflected color with a D65 illuminant for all viewing angles from 0 to 90 degrees for an optical coating of Example 10 of the disclosure at seven optical coating thickness scaling factor values;

FIG. 34 is a plot of first-surface photopic average reflectance v. incident light wavelength at a near-normal light incidence angle (5 degrees) for an optical coating of Example 11 of the disclosure;

FIG. 35 is a plot of first-surface reflected color with a D65 illuminant for all viewing angles from 0 to 90 degrees for an optical coating of Example 11 of the disclosure at seven optical coating thickness scaling factor values;

FIG. 36 is a plot of first-surface photopic average reflectance v. incident light wavelength at a near-normal light incidence angle (5 degrees) for an optical coating of Example 12 of the disclosure;

FIG. 37 is a plot of first-surface reflected color with a D65 illuminant for all viewing angles from 0 to 90 degrees for an optical coating of Example 12 of the disclosure at eleven optical coating thickness scaling factor values;

FIG. 38 is a plot of first-surface photopic average reflectance v. incident light wavelength at a near-normal light incidence angle (8 degrees) for an optical coating of Example 13 of the disclosure at four optical coating thickness scaling factor values;

FIG. 39 is a plot of first-surface reflected color with a D65 illuminant for all viewing angles from 0 to 90 degrees for an optical coating of Example 13 of the disclosure at four optical coating thickness scaling factor values;

FIG. 40 is a plot of first-surface photopic average reflectance v. incident light wavelength at a near-normal light incidence angle (8 degrees) for an optical coating of Example 14 of the disclosure at eight optical coating thickness scaling factor values;

FIG. 41 is a plot of first-surface reflected color with a D65 illuminant for all viewing angles from 0 to 90 degrees for an optical coating of Example 14 of the disclosure at seven optical coating thickness scaling factor values;

FIG. 42 is a plot of first-surface photopic average reflectance v. incident light wavelength at a near-normal light incidence angle (6 degrees) for an optical coating of Example 15 of the disclosure at an optical coating thickness scaling factor of 1;

FIG. 43 is a plot of first-surface reflected color with a D65 illuminant for all viewing angles from 0 to 90 degrees for the exemplary optical coating of Example 15 at seven optical coating thickness scaling factor values.

### DETAILED DESCRIPTION

Described herein are coated articles that comprise optical coatings over non-linear substrates. Non-linear substrates may have non-uniform coating thicknesses when, for example, line-of-sight coating methods are employed. While non-uniform thickness may cause non-desirable optical properties over the coating, the embodiment disclosed herein may utilize coating designs that have low reflectance into the infrared light wavelength band. Such designs may accommodate coatings that are non-uniform in thickness, maintaining acceptable color and reflectiveness over the thick and thin portions of the coatings, as is described in detail herein.

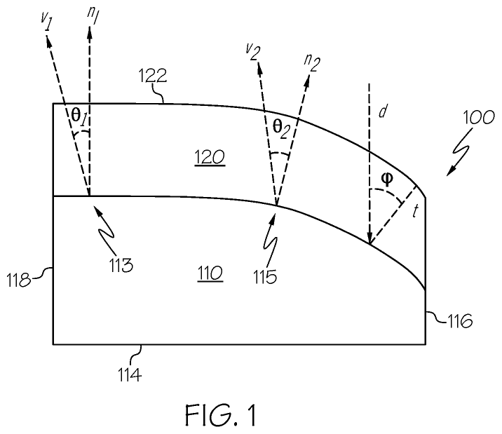

Reference will now be made in detail to various embodiments of coated articles, examples of which are illustrated in the accompanying drawings. Referring to FIG. 1, a coated article 100, according to one or more embodiments disclosed herein, may include a non-planar substrate 110, and an optical coating 120 disposed on the substrate. The non-planar substrate 110 may include opposing major surfaces 112, 114 and opposing minor surfaces 116, 118. The optical coating 120 is shown in FIG. 1 as being disposed on a first opposing major surface 112; however, the optical coating 120 may be disposed on the second opposing major surface 114 and/or one or both of the opposing minor surfaces, in addition to or instead of being disposed on the first opposing major surface 112. As is depicted, the major surface 114 may be flat. In other embodiments, the major surface 114 may be non-planar. The optical coating 120 forms an anti-reflective surface 122. The anti-reflective surface 122 forms an air-interface and generally defines the edge of the optical coating 120 as well as the edge of the overall coated article 100. The substrate 110 may be substantially transparent, as described herein.

According to the embodiments described herein, the substrate 110 may be non-planar. As used herein, non-planar substrates refer to substrates where at least one of the major surfaces 112, 114 of the substrate 110 is not geometrically flat in shape. For example, as shown in FIG. 1, a portion of major surface 112 may comprise a curved geometry. The degree of curvature of a major surface 112 may vary. For example, embodiments may have a curvature measured by an approximate radius of about 1 mm to several meters (i.e., nearly planar), such as from about 3 mm to about 30 mm, or from about 5 mm to about 10 mm. In embodiments, the non-planar substrate may comprise planar portions, as shown in FIG. 1. For example, a touch screen for a portable electronic device may comprise a substantially planar surface at or near its center and curved (i.e., non-planar) portions around its edges. Examples of such substrates include the cover glass from an Apple iPhone 6 smartphone or a Samsung Galaxy S6 Edge smartphone. While some embodiments of non-planar substrates are depicted, it should be understood that non-planar substrates may take on a wide variety of shapes, such as curved sheets, faceted sheets, sheets with angular surfaces, or even tubular sheets.

The non-planar substrate 110 comprises a major surface 112 which comprises at least two portions, a first portion 113 and a second portion 115, which are not flat relative to one another (i.e., the portions 113, 115 are not in the same plane or otherwise parallel to one another). According to some embodiments, the second portion 115 is curved or faceted in shape. A direction n₁ is normal to the first portion 113 of major surface 112 and a direction n₂ is normal to the second portion 115 at position 115A of major surface 112. In embodiments, the angle between n₁ and n₂ may be at least about 5 degrees, at least about 10 degrees, at least about 15 degrees, at least about 20 degrees, at least about 25 degrees, at least about 30 degrees, at least about 35 degrees, at least about 40 degrees, at least about 45 degrees, at least about 50 degrees, at least about 55 degrees, at least about 60 degrees, at least about 70 degrees, at least about 80 degrees, at least about 90 degrees, at least about 120 degrees, at least about 150 degrees, or even at least about 180 degrees (e.g., the angle between n₁ and n₂ may be 180 degrees for a tubular substrate. For example, the angle between n₁ and n₂ may be in a range from about 10 degrees to about 30 degrees, from about 10 degrees to about 45 degrees, from about 10 degrees to about 60 degrees, from about 10 degrees to about 75 degrees, from about 10 degrees to about 90 degrees, from about 10 degrees to about 120 degrees, from about 10 degrees to about 150 degrees, or from about 10 degrees to about 180 degrees. In additional embodiments, the angle between n₁ and n₂ (and/or n₃) may be in a range from about 10 degrees to about 80 degrees, from about 20 degrees to about 80 degrees, from about 30 degrees to about 80 degrees, from about 40 degrees to about 80 degrees, from about 50 degrees to about 80 degrees, from about 60 degrees to about 80 degrees, from about 70 degrees to about 80 degrees, from about 20 degrees to about 180 degrees, from about 30 degrees to about 180 degrees, from about 40 degrees to about 180 degrees, from about 50 degrees to about 180 degrees, from about 60 degrees to about 180 degrees, from about 70 degrees to about 150 degrees, or from about 80 degrees to about 180 degrees.

Light transmitted through or reflected by the coated article 100 may be measured in a viewing direction v (i.e., v₁ for n₁, v₂ for n₂), as shown in FIG. 1, which may be non-normal to the major surface 112 of the substrate 110. The viewing direction may be referred to as an incident illumination angle as measured from the normal direction at each surface. For example, and as will be explained herein, reflected color, transmitted color, average light reflectance, average light transmission, photopic reflectance, and photopic transmission. The viewing direction v defines an incident illumination angle θ which is the angle between the direction normal to a substrate surface n and the viewing direction v (i.e., θ₁ is the incident illumination angle between normal direction n₁ and viewing direction v₁, and θ₂ is the incident illumination angle between normal direction n₂ and viewing direction v₂). It should be understood that while FIG. 1 depicts incident illumination angles that are not equal to 0 degrees, in some embodiments, the incident illumination angle may be equal to about 0 degrees such that the v is equal to n. Optical properties of a portion of the coated article 100 may be different when varying the incident illumination angle θ.

As used herein, “transmitted color” and“reflected color” refer to the color transmitted or reflected through the coated articles of the disclosure with regard to color in the CIEL*,a*,b* colorimetry system under a D65 illuminant. More specifically, the “transmitted color” and “reflected color” are given by √(a*²+b*²), as these color coordinates are measured through transmission or reflectance of a D65 illuminant through the primary surfaces of the substrate of the transparent article over an incident angle range, e.g., from 0 degrees to 10 degrees.

In embodiments, the coated article may have a transmitted color √(a*²+b*²) with a D65 illuminant of less than 4 at incident angles from 0 degrees to 10 degrees. In embodiments, the coated article may have a transmitted color √(a*²+b*²) with a D65 illuminant of less than 2 or less than 1, at incident angles from 0 degrees to 10 degrees.

As used herein, the term “ring-on-ring test”, “Ring-on-Ring Test”, or “ROR Test” refers to a test employed to determine the failure strength or stress (in units of MPa) of transparent articles of the disclosure, along with comparative articles. Each ROR Test was conducted with a test arrangement using loading and supporting rings made of high-strength steel having diameters of 12.7 mm and 25.4 mm, respectively. In addition, the load bearing surfaces of the loading and supporting rings are machined to a radius of about 0.0625 inches to minimize stress concentrations in the contact region between the rings and the transparent articles. Further, the loading ring is placed on the outermost primary surface of the transparent article (e.g., on the outer surface of its optical film structure) and the supporting ring is placed on the innermost primary surface of the transparent article (e.g., on the second primary surface of its substrate). The loading ring incorporates a mechanism that enables articulation of the loading ring and that insures proper alignment and uniform loading of the test sample. In addition, each ROR Test was conducted by applying the loading ring against the transparent article at a loading rate of 1.2 mm/min. The term “average” in the context of an ROR Test is based on the mathematical average of failure stress measurements made on five (5) samples. Further, unless stated otherwise in specific instances of the disclosure, all failure stress values and measurements described herein refer to measurements from the ROR testing, which places the outer surface of the article in tension, as described in International Publication No. WO2018/125676, published on Jul. 5, 2018, entitled “Coated Articles with Optical Coatings Having Residual Compressive Stress,” and incorporated herein by reference in its entirety. A failure in each ROR Test typically occurs on the side of the sample opposite the loading ring which is in tension, and finite element modeling is used to provide an appropriate conversion from failure load to failure stress at the location of the failure. It is also understood that other failure strength tests can be employed to determine the failure strengths of the transparent articles of the disclosure, with an appropriate correlation made to the ROR values and results reported herein in this disclosure based on differences in test conditions, test specimen geometry, and other technical considerations understood by those with ordinary skill in the field. Nevertheless, unless otherwise noted, all average failure strength values reported for the transparent articles of the disclosure, along with comparative articles, are given as measured from an ROR Test.

Still referring to FIG. 1, in some embodiments, the thickness of the optical coating 120, as measured in the direction normal to the substrate major surface 112, may differ between portions of the optical coating 120 disposed over the first portion 113 and the second portion 115 of the substrate 110. For example, the optical coating 120 may be deposited onto the non-planar substrate 110 by a vacuum deposition technique such as, for example, chemical vapor deposition (e.g., plasma enhanced chemical vapor deposition (PECVD), low-pressure chemical vapor deposition, atmospheric pressure chemical vapor deposition, and plasma-enhanced atmospheric pressure chemical vapor deposition), physical vapor deposition (PVD) (e.g., reactive or nonreactive sputtering or laser ablation), thermal or e-beam evaporation and/or atomic layer deposition. Liquid-based methods may also be used such as spraying, dipping spin coating, or slot coating (for example, using sol-gel materials). In some embodiments, a PVD technique can be employed that relies on “metal-mode” reactive sputtering in which a thin metallic layer is deposited in one portion of a deposition chamber, and the film is reacted with gases such as oxygen or nitrogen in a different portion of the deposition chamber. In some embodiments, a PVD technique can be employed that relies on “in-line” reactive sputtering in which a material deposition and reaction occur in the same section of the deposition chamber. Generally, vapor deposition techniques may include a variety of vacuum deposition methods which can be used to produce thin films. For example, physical vapor deposition uses a physical process (such as heating or sputtering) to produce a vapor of material, which is then deposited on the object which is coated. These deposition processes, particularly the PVD methods, may have a “line-of-sight” character in which deposited materials move in a uniform direction during deposition onto the substrate regardless of the angle between the deposition direction and the angle normal to the substrate surface.

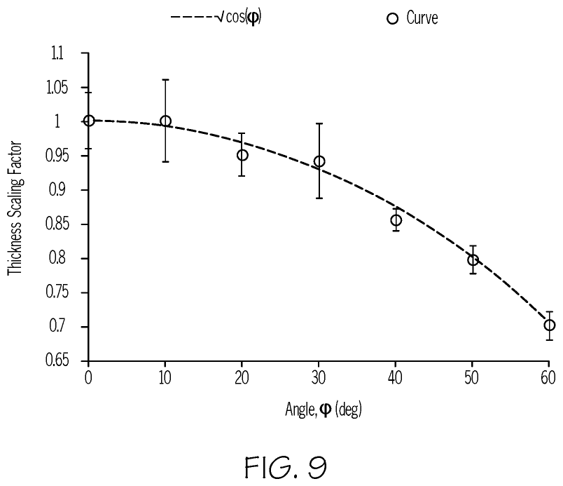

Referring to FIG. 1, arrow d shows a line-of-sight deposition direction. The deposition direction din FIG. 1 is normal to major surface 114 of the substrate 110, such as may be common in a system where the substrate rests on major surface 114 during deposition of the optical coating 120. The arrow of line d points in the direction of the line-of-sight deposition. Line t shows the direction normal to the major surface 112 of the substrate 110. The normal thickness of the optical coating 120, as measured in the direction normal to the major surface 112 is represented by the length of line t. The deposition angle φ is defined as the angle between the deposition direction d and the direction normal to the major surface 112 (i.e., line t). If the optical coating 120 is deposited with a line-of-sight deposition character, the thickness of a portion of the optical coating 120 has been observed for some vapor deposition processes to generally follow the square root of cosine of φ (see FIG. 9 and corresponding description). Thus, as φ increases, the thickness of the optical coating 120 decreases. While the actual thickness of optical coatings 120 deposited by vapor deposition may be different from that determined by the scalar of the square root of cosine φ, it provides an estimate useful for modeling optical coating designs which may have good performance when applied onto non-planar substrates 110. Additionally, while n₁ and d are in the same direction in FIG. 1, they need not be in the same direction in all embodiments. Without being bound by theory, it has also been observed that the physical vapor deposition processes of the disclosure do not always follow a completely line-of-sight character, as complex interactions between the sputtered atoms and molecules can interact with one another during deposition with the sputtering plasma as they travel from the sputtering target to the glass substrate 110. Nevertheless, one can tune the physical vapor deposition processes to achieve a square root of cosine of φ relationship (see FIG. 9 and corresponding description), which can then be advantageously employed in configuring the structure of the optical coating 120 to have desirable optical and mechanical properties at both of the first and second portions 113, 115.

It should be understood that throughout this disclosure, unless specified otherwise, thickness of the optical coating 120 is measured in the normal direction n. Based on a line-of-sight coating scheme that is directed at the first portion 113, the thickness of the coating will be thicker over the first portion 113 than the second portion 115. The difference in thickness can be described by a “scaling factor,” which is the difference in coating thickness between the two portions 113, 115. For example, and as is described herein, a scaling factor of 0.5 corresponds to an embodiment where the thickness of the coating at the second portion 115 is 50% of the thickness of the coating at the first portion 113, where both thicknesses are measured normal to the normal direction n.

Embodiments of the disclosure also include coated articles 100 (see FIGS. 1-8) having a range of part surface angles (part surface curvature) that are combined with an optical coating 120 in which the coating 120 is designed to be robust to thinning of the coating that occurs from various coating deposition processes. The net result is a coated article 100 having a range of part surface curvature angles with an optical coating 120 having controlled hardness, reflectance, color, and color shift with viewing angle over the entire surface of the article 100, including a portion or all of the curved regions (e.g., at second portion 115). In addition to absolute levels of hardness, reflectance, and color that meet certain targets, the coated articles 100 can also exhibit small changes in these values, particularly small changes in visible reflectance and color, when the thickness of the coating 120 is reduced by a scaling factor corresponding to the actual reduction in coating thickness that occurs in an industrially-scalable reactive sputtering process on a manufactured part with surface curvature angles from 0 to 90 degrees.

An important piece of understanding to create optimal coating designs for a coated article 100 (see FIGS. 1-8) with surface curvature, is an understanding of the particular coating process used to form the layers of the optical coating 120, and the level of line-of-sight coating effects that occur in that process. Some coating deposition processes have no line of sight behavior at all, such as atomic layer deposition, where one monolayer of molecules or atoms is deposited at a time. However, this process can be slow (at least as limited by current processing technology) and is typically too expensive for applications involving large substrates or industries that are cost sensitive, such as the consumer electronics and automotive industries. A more cost-effective process for forming the optical coating 120, reactive sputtering, is readily scalable to large areas and can be relatively low cost. However the nature of industrial reactive sputtering processes generally includes a deposition that has at least some line-of-sight character, meaning that the surfaces of the article directly facing the sputtering targets will receive more deposited material (resulting in a thicker coating), while surfaces of the article tilted at some angle relative to the sputtering targets (e.g., its curved surfaces) will generally receive less material, resulting in a thinner coating.

Accordingly, embodiments of the disclosure include coated articles 100 (see FIGS. 1-8) in which the optical coating 120 has been optimized with regard to the tradeoffs between hardness, reflectance, color, and number of coating layers. Adding an arbitrary number of layers to achieve an optical target (e.g., without consideration to hardness or other mechanical properties) in the optical coating will tend to reduce the hardness of the coating to levels below the required range for applications targeting scratch-resistant chemically strengthened glass for consumer electronics, automotive, and touch screen applications (e.g., to a hardness <<8 GPa, as measured by Berkovich Indenter Hardness Test at an indentation depth of about 100 nm or greater). In the case of coated articles 100 having curved surfaces (e.g., at the second portion 115 of the major surface 112), it can be important to assess how part surface curvature relates to the amount, or scale factor, by which the layers of the optical coating 120 will be reduced or thinned from their target design thicknesses. The target design thickness (or the thickness at 100% scale factor or 1.0 scale factor) is generally the thickness that is coated on the “flat” areas of the article 100 (e.g., at the first portion 113 of the major surface 112), those portions of the article 100 that are closest to directly facing the sputtering targets, or those portions of the article 100 that receive the most material from the sputtering targets. Any part of the article 100 that is curved away from this maximum thickness deposition direction will generally receive less material, resulting in a thinner coating on these curved areas as each of the layers of the coating 120 is formed. For optimal optical coating design for the optical coating 120 of embodiments of the coated articles 100 (see FIGS. 1-8), it can be beneficial to understand the design window in terms of target part curvature, as well as how part curvature corresponds to coating thinning in the deposition process. This can enable optical design of the coating 120 in such a way that optimizes, for example, reflectance and color over the target range of part angles and coating thickness variation, without sacrificing too much in terms of the hardness of the coating, number of layers in the coating, or other metrics. Said another way, without an understanding of the relevant window of part angles and coating thickness scale factors, one can over-design the coating to include too many layers to achieve a desired set of optical properties, thus sacrificing hardness and scratch resistance.

Referring now to FIG. 9, a plot is provided of optical coating thickness scaling factor v. part surface curvature for a deposition process. In particular, FIG. 9 shows the experimentally measured correspondence between part surface angle (i.e., at the second portion 115 of the major surface 112) and coating thickness scale factor (i.e., for the optical coating 120) for a reactive sputtering process employed on coated articles 100 (see FIGS. 1-8 and corresponding description above), according to embodiments of the disclosure. FIG. 9 can be employed to establish a target process window to optimize the deposition process employed to form the optical coating of articles of the disclosure. As shown in FIG. 9, the coating thickness scale factor follows a square root (cos(φ)) dependence, where p is the part surface angle. The data shown in FIG. 9 were obtained from measurements of sputtered thin films using known optical interference calculation methods with a sample fixture that allows rotation of a curved part and measurement of reflectance spectra along the normal angle at each point along the curvature of the part. As shown in FIG. 9, a part surface angle of 30 degrees corresponds to a coating thickness scaling factor of about 0.95, 40 degrees to about 0.85, 50 degrees to about 0.8, and 60 degrees to about 0.7. For example, a coated article 100 having a non-planar second portion 115 with an angle φ of 30 degrees relative to its first portion 113 can experience a thinning in the layers of its optical coating 120 above its second portion 115 by a scaling factor of 0.85. That is, the thickness of the layers of the optical coating 120 above the first portion 113 and above the second portion 115 can vary based on a thickness scaling factor, as shown in FIG. 9.

Referring again to FIG. 9, the presently disclosed designs of the coated articles 100 of the disclosure can be particularly optimized to with an optical coating 120 characterized by an advantageous combination of low reflectance, controlled color, and controlled color shift with viewing angle (incident light angle) at 100% thickness (1.0 scaling factor) as well as at thickness scaling factors of 0.7 (70%) or less. To calculate the optical performance for each thickness scaling factor, the 100% thickness layer design has all of its layers scaled by the same amount (the thickness scaling factor) and the optical results are re-calculated using transfer matrix method techniques according to principles understood by those with ordinary skill in the field of the disclosure. Optical index dispersion curves are measured for sputter deposited films of SiO₂, SiOₓN_{y}, and SiNₓ, (or other materials employed in the layers of the optical coating 120) and these index dispersion values are input into the optical models, according to principles understood by those of ordinary skill in the field of the disclosure.

According to some embodiments disclosed herein, the thickness of the optical coating 120 on the second portion 115 as measured normal to the major surface 112 at the second portion 115 may be 95% or less (i.e., scaling of 0.95 or less) than the thickness of the optical coating 120 on the first portion 113 as measured normal to the major surface 112 at the first portion 113. In additional embodiments, the thickness of the optical coating 120 on the second portion 115 as measured normal to the major surface 112 at the second portion 115 may be 95% or less (i.e., scaling of 0.95 or less), 90% or less (i.e., scaling of 0.9 or less), 85% or less (i.e., scaling of 0.85 or less), 80% or less (i.e., scaling of 0.80 or less), 75% or less (i.e., scaling of 0.75 or less), 70% or less (i.e., scaling of 0.70 or less), 65% or less (i.e., scaling of 0.65 or less), 60% or less (i.e., scaling of 0.6 or less), 55% or less (i.e., scaling of 0.55 or less), 50% or less (i.e., scaling of 0.5 or less), 45% or less (i.e., scaling of 0.45 or less), 40% or less (i.e., scaling of 0.4 or less), 35% or less (i.e., scaling of 0.35 or less), or even 30% or less (i.e., scaling of 0.3 or less), than the thickness of the optical coating 120 on the first portion 113 as measured normal to the major surface 112 at the first portion 113.

According to embodiments, as described herein, various portions of the coated article 100 (e.g., first portion 113 and second portion 115) may have optical characteristics such as light reflectivity, light transmittance, reflected color, and/or transmitted color, which appear similar to one another. For example, the optical characteristics at the first portion 113 may be similar to those at the second portion 115 when each is viewed in a direction about normal to the substrate 110 at the respective portion 113, 115 (i.e., θ₁ is equal to about 0 degrees and θ₂ is equal to about 0 degrees). In other embodiments, the optical characteristics at the first portion 113 may be similar to those at the second portion 115 when each is viewed at an incident illumination angle in a specified range relative to the normal direction at the respective portion 113, 115 (e.g., θ₁ is from about 0 degrees to about 90 degrees, θ₂ is from about 0 degrees to about 90 degrees). In additional embodiments, the optical characteristics at the first portion 113 may be similar to those at the second portion 115 when each is viewed in about the same direction (e.g., the angle between v₁ and v₂ is about equal to 0 degrees).

The optical coating 120 includes at least one layer of at least one material. The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed there between. In one or more embodiments a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

The thickness of the optical coating 120 may be about 1 μm or greater in the direction of deposition while still providing an article that exhibits the optical performance described herein. In some examples, the optical coating thickness in the direction of deposition may be in the range from about 1 μm to about 20 μm, from about 1 μm to about 10 μm, from about 1 μm to about 5 μm, from about 2 μm to about 10 μm, from about 2 μm to about 5 μm, from about 2 μm to about 4 μm, and all thickness values of the optical coating 120 between these thickness values. For example, the thickness of the optical coating 120 can be about 0.2 μm, 0.3 μm, 0.4 μm, 0.5 μm, 0.6 μm, 0.7 μm, 0.8 μm, 0.9 μm, 1 μm, 2 μm, 3 μm, 4 μm, 5 μm, 6 μm, 7 μm, 8 μm, 9 μm, 10 μm, 12 μm, 14 μm, 16 μm, 18 μm, 20 μm, and all thickness values between these thicknesses.

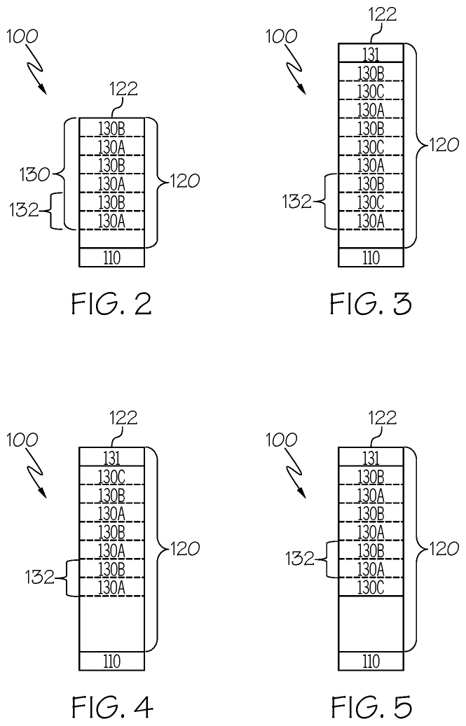

As used herein, the term “dispose” includes coating, depositing and/or forming a material onto a surface using any known method in the art. The disposed material may constitute a layer, as defined herein. The phrase “disposed on” includes the instance of forming a material onto a surface such that the material is in direct contact with the surface and also includes the instance where the material is formed on a surface, with one or more intervening material(s) between the disposed material and the surface. The intervening material(s) may constitute a layer, as defined herein. Additionally, it should be understood that while FIGS. 2-8 schematically depict planar substrates, FIGS. 2-8 should be considered as having non-planar substrates such as shown in FIG. 1, and are depicted as planar to simplify the conceptual teachings of the respective figures.

As shown in FIG. 2, the optical coating 120 may include an anti-reflective coating 130, which may include a plurality of layers (130A, 130B). In one or more embodiments, the anti-reflective coating 130 may include a period 132 comprising two or more layers. In one or more embodiments, the two or more layers may be characterized as having different refractive indices from each another. In one embodiment, the period 132 includes a first low RI layer 130A and a second high RI layer 130B. The difference in the refractive index of the first low RI layer and the second high RI layer may be about 0.01 or greater, about 0.05 or greater, about 0.1 or greater, or even about 0.2 or greater.

As used herein, the terms “low RI layer” and “high RI layer” refer to the relative values of the refractive index (“RI”) of layers of an optical coating of a transparent article according to the disclosure (i.e., low RI layer<high RI layer). Hence, low RI layers have refractive index values that are less than the refractive index values of high RI layers. Further, as used herein, “low RI layer” and “low index layer” are interchangeable with the same meaning. Likewise, “high RI layer” and “high index layer” are interchangeable with the same meaning.

As shown in FIG. 2, the anti-reflective coating 130 may include a plurality of periods 132. A single period 132 may include a first low RI layer 130A and a second high RI layer 130B, such that when a plurality of periods 132 are provided, the first low RI layer 130A (designated for illustration as “L”) and the second high RI layer 130B (designated for illustration as “H”) alternate in the following sequence of layers: L/H/L/H or H/L/H/L, such that the first low RI layer 130A and the second high RI layer 130B appear to alternate along the physical thickness of the optical coating 120. In the example in FIG. 2, the anti-reflective coating 130 includes three (3) periods 132. In some embodiments, the anti-reflective coating 130 may include up to twenty-five (25) periods 132 (also referred herein as “N” periods, in which N is an integer). For example, the anti-reflective coating 130 may include from about 2 to about 20 periods 132, from about 2 to about 15 periods 132, from about 2 to about 12 periods 132, from about 2 to about 10 periods 132, from about 2 to about 12 periods 132, from about 3 to about 8 periods 132, from about 3 to about 6 periods 132, or any other period 132 within these ranges. For example, the anti-reflective coating 130 may include 1, 2, 3, 4, 5, 6, 7, 8, 9, 10, 11, 12, 13, 14, 15, 16, 17, 18, 19, 20, 21, 22, 23, 24 or 25 period(s) 132.

In the embodiment shown in FIG. 3, the anti-reflective coating 130 may include an additional capping layer 131, which may include a lower refractive index material than the second high RI layer 130B. In some embodiments, the period 132 may include one or more third layers 130C, as shown in FIG. 3. The third layer(s) 130C may have a low RI, a high RI or a medium RI. In some embodiments, the third layer(s) 130C may have the same RI as the first low RI layer 130A or the second high RI layer 130B. In other embodiments, the third layer(s) 130C may have a medium RI that is between the RI of the first low RI layer 130A and the RI of the second high RI layer 130B. Alternatively, the third layer(s) 130C may have a refractive index greater than the second high RI layer 130B. The third layer 130C may be provided in the optical coating 120 in the following exemplary configurations: L_{third} layer/H/L/H/L; H_{third layer}/L/H/L/H; L/H/L/H/L_{third layer}; H/L/H/L/H_{third layer}; L_{third layer}/H/L/H/L/H_{third layer}; H_{third layer}/L/H/L/H/L_{third layer}; L_{third layer}/L/H/L/H; H_{third layer}/H/L/H/L; H/L/H/L/L_{third layer}; L/H/L/H/H_{third layer}; L_{third layer}/L/H/L/H/H_{third layer}; H_{third layer}/H/L/H/L/L_{third layer}; L/M_{third layer}/H/L/M/H; H/M/L/H/M/L; M/L/H/L/M; as well as other combinations. In these configurations, “L” without any subscript refers to the first low RI layer and “H” without any subscript refers to the second high RI layer. Reference to “L_{third sub-layer}” refers to a third layer having a low RI, “H_{third sub-layer}” refers to a third layer having a high RI and “Mf” refers to a third layer having a medium RI, all relative to the first layer and the second layer.

As used herein, the terms “low RI”, “high RI” and “medium RI” refer to the relative values for the RI to another (e.g., low RI<medium RI<high RI). In one or more embodiments, the term “low RI” when used with the first low RI layer or with the third layer, includes a range from about 1.3 to about 1.7 or 1.75. In one or more embodiments, the term “high RI” when used with the second high RI layer or with the third layer, includes a range from about 1.7 to about 2.6 (e.g., about 1.85 or greater). In some embodiments, the term “medium RI” when used with the third layer, includes a range from about 1.55 to about 1.8. In some instances, the ranges for low RI, high RI, and medium RI may overlap; however, in most instances, the layers of the anti-reflective coating 130 have the general relationship regarding RI of: low RI<medium RI<high RI.

In one or more embodiments, the term “medium RI”, when used with the medium RI layers 130C, includes a refractive index range from 1.55 to 1.80, 1.56 to 1.80, 1.6 to 1.75, and all indices within these ranges. In one or more embodiments, the term “high RI”, when used with the high RI layers 130B and/or scratch-resistant layer 150, can include a refractive index range of greater than 1.80, greater than 1.90, from about 1.8 to about 2.5, from about 1.8 to about 2.3, or from about 1.90 to about 2.5, and all indices between these ranges. Further, in a specific implementation, the medium RI layer(s) of the coated article 100 of the disclosure, may include a refractive index range from 1.55 to 1.90 or 1.55 to 1.80, and all values between these ranges, which may overlap in refractive index with the high RI layers 130B (e.g., as having a refractive index of greater than 1.80) of the optical film structure 120 or may not overlap in refractive index with the high RI layers 130B (e.g., as having a refractive index of greater than 1.90). In one or more embodiments, the difference in the refractive index of each of the low RI layers 130A (and/or capping layer 131), the medium RI layers 130C, and/or the high RI layers 130B (and/or scratch-resistant layer 150) may be about 0.01 or greater, about 0.05 or greater, about 0.1 or greater, or even about 0.2 or greater.

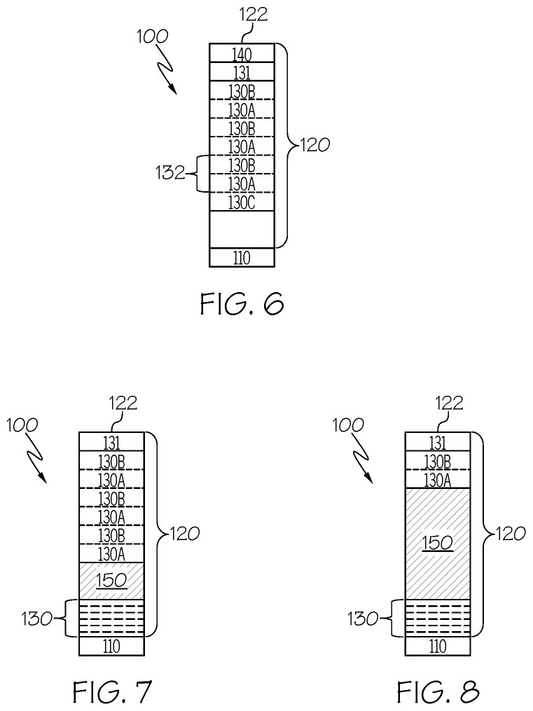

The third layer(s) 130C may be provided as a separate layer from a period 132 and may be disposed between the period 132 or plurality of periods 132 and the capping layer 131, as shown in FIG. 4. The third layer(s) may also be provided as a separate layer from a period 132 and may be disposed between the substrate 110 and the plurality of periods 132, as shown in FIG. 5. The third layer(s) 130C may be used in addition to an additional coating 140 instead of the capping layer 131 or in addition to the capping layer 131, as shown in FIG. 6. In some implementations, a third layer(s) 130C (not shown) is disposed adjacent to the scratch-resistant layer 150 or the substrate 110 in the configurations depicted in FIGS. 7 and 8.

Materials suitable for use in the anti-reflective coating 130 include: SiO₂, Al₂O₃, GeO₂, SiO, AlOₓN_{y}, AlN, SiNx, SiOₓN_{y}, SiᵤAlᵥOₓN_{y}, Ta₂O₅, Nb₂O₅, TiO₂, ZrO₂, TiN, MgO, MgF₂, BaF₂, CaF₂, SnO₂, HfO₂, Y₂O₃, MoO₃, DyF₃, YbF₃, YF₃, CeF₃, polymers, fluoropolymers, plasma-polymerized polymers, siloxane polymers, silsesquioxanes, polyimides, fluorinated polyimides, polyetherimide, polyethersulfone, polyphenylsulfone, polycarbonate, polyethylene terephthalate, polyethylene naphthalate, acrylic polymers, urethane polymers, polymethylmethacrylate, other materials cited below as suitable for use in a scratch-resistant layer, and other materials known in the art. Some examples of suitable materials for use in the first low RI layer include SiO₂, Al₂O₃, GeO₂, SiO, AlOₓN_{y}, SiOₓN_{y}, SiᵤAlᵥOₓN_{y}, MgO, MgAl₂O₄, MgF₂, BaF₂, CaF₂, DyF₃, YbF₃, YF₃, and CeF₃. The nitrogen content of the materials for use in the first low RI layer may be minimized (e.g., in materials such as Al₂O₃ and MgAl₂O₄). Some examples of suitable materials for use in the second high RI layer include SiᵤAlᵥOₓN_{y}, Ta₂O₅, Nb₂O₅, AlN, Si₃N₄, AlOₓN_{y}, SiOₓN_{y}, SiNₓ, SiNₓ:H_{y}, HfO₂, TiO₂, ZrO₂, Y₂O₃, Al₂O₃, MoO₃ and diamond-like carbon. In examples, the high RI layer may also be a high hardness layer or a scratch-resistant layer, and the high RI materials listed above may also comprise high hardness or scratch resistance. The oxygen content of the materials for the second high RI layer and/or the scratch-resistant layer may be minimized, especially in SiNₓ or AlNₓ materials. AlOₓN_{y} materials may be considered to be oxygen-doped AlNₓ, that is they may have an AlNₓ crystal structure (e.g. wurtzite) and need not have an AlON crystal structure. Exemplary AlOₓN_{y} high RI materials may comprise from about 0 atom % to about 20 atom % oxygen, or from about 5 atom % to about 15 atom % oxygen, while including 30 atom % to about 50 atom % nitrogen. Exemplary SiᵤAlᵥOₓN_{y} high RI materials may comprise from about 10 atom % to about 30 atom % or from about 15 atom % to about 25 atom % silicon, from about 20 atom % to about 40 atom % or from about 25 atom % to about 35 atom % aluminum, from about 0 atom % to about 20 atom % or from about 1 atom % to about 20 atom % oxygen, and from about 30 atom % to about 50 atom % nitrogen. The foregoing materials may be hydrogenated up to about 30% by weight. Exemplary SiᵤOₓN_{y} high RI materials may comprise from 45 atom % to 50 atom % silicon, 45 atom % to 50 atom % nitrogen, and 3 atom % to 10 atom % oxygen. In further implementations, the SiᵤOₓN_{y} high RI materials may comprise from 45 atom % to 50 atom % silicon, 35 atom % to 50 atom % nitrogen, and 3 atom % to 20 atom % oxygen. Where a material having a medium refractive index is desired, some embodiments may utilize AlN and/or SiOₓN_{y}. The hardness of the second high RI layer and/or the scratch-resistant layer may be characterized specifically. In some embodiments, the maximum hardness of the second high RI layer 130B and/or a scratch-resistant layer 150 (see FIGS. 7 and 8, and their corresponding description below), as measured by the Berkovich Indenter Hardness Test at an indentation depth of about 100 nm or greater, may be about 8 GPa or greater, about 10 GPa or greater, about 12 GPa or greater, about 15 GPa or greater, about 18 GPa or greater, or about 20 GPa or greater. In some cases, the second high RI layer 130B material may be deposited as a single layer and may be characterized as a scratch-resistant layer (e.g., scratch-resistant layer 150 depicted in FIGS. 7 and 8, and further described below), and this single layer may have a thickness between about 200 nm and 5000 nm for repeatable hardness determination. In other embodiments in which the second high RI layer 130B is deposited as a single layer in the form of a scratch-resistant layer (e.g., scratch resistant layer 150 as depicted in FIGS. 7 and 8), this layer may have a thickness from about 200 nm to about 5000 nm, from about 200 nm to about 3000 nm, from about 500 nm to about 5000 nm, from about 1000 nm to about 4000 nm, from about 1500 nm to about 4000 nm, from about 1500 nm to about 3000 nm, and all thickness values between these thicknesses.

In one or more embodiments, at least one of the layer(s) of the anti-reflective coating 130 may include a specific optical thickness range. As used herein, the term “optical thickness” is determined by the product of the physical thickness and the intensity attenuation coefficient of a layer. In one or more embodiments, at least one of the layers of the anti-reflective coating 130 may include an optical thickness in the range from about 2 nm to about 200 nm, from about 10 nm to about 100 nm, from about 15 nm to about 100 nm, from about 15 to about 500 nm, or from about 15 to about 5000 nm. In some embodiments, all of the layers in the anti-reflective coating 130 may each have an optical thickness in the range from about 2 nm to about 200 nm, from about 10 nm to about 100 nm, from about 15 nm to about 100 nm, from about 15 nm to about 500 nm, or from about 15 nm to about 5000 nm. In some cases, at least one layer of the anti-reflective coating 130 has an optical thickness of about 50 nm or greater. In some cases, each of the first low RI layers have an optical thickness in the range from about 2 nm to about 200 nm, from about 10 nm to about 100 nm, from about 15 nm to about 100 nm, from about 15 nm to about 500 nm, or from about 15 nm to about 5000 nm. In other cases, each of the second high RI layers have an optical thickness in the range from about 2 nm to about 200 nm, from about 10 nm to about 100 nm, from about 15 nm to about 100 nm, from about 15 nm to about 500 nm, or from about 15 nm to about 5000 nm. In yet other cases, each of the third layers have an optical thickness in the range from about 2 nm to about 200 nm, from about 10 nm to about 100 nm, from about 15 nm to about 100 nm, from about 15 nm to about 500 nm, or from about 15 nm to about 5000 nm.

In some embodiments, the top-most air-side layer may comprise a high RI layer 130B (see FIG. 2) that also exhibits high hardness. In some embodiments, an additional coating 140 (see FIG. 6 and its corresponding description below) may be disposed on top of this top-most air-side high RI layer (e.g., the additional coating may include a low-friction coating, an oleophobic coating, or an easy-to-clean coating). The addition of a low RI layer having a very low thickness (e.g., about 10 nm or less, about 5 nm or less, or about 2 nm or less) has minimal influence on the optical performance when added to the top-most air-side layer comprising a high RI layer. The low RI layer having a very low thickness may include SiO₂, an oleophobic or low-friction layer, or a combination of SiO₂ and an oleophobic material. Exemplary low-friction layers may include diamond-like carbon, such materials (or one or more layers of the optical coating) may exhibit a coefficient of friction less than 0.4, less than 0.3, less than 0.2, or even less than 0.1.

In one or more embodiments, the anti-reflective coating 130 may have a physical thickness of about 800 nm or less. The anti-reflective coating 130 may have a physical thickness in the range from about 10 nm to about 800 nm, from about 50 nm to about 800 nm, from about 100 nm to about 800 nm, from about 150 nm to about 800 nm, from about 200 nm to about 800 nm, from about 300 nm to about 800 nm, from about 400 nm to about 800 nm, from about 10 nm to about 750 nm, from about 10 nm to about 700 nm, from about 10 nm to about 650 nm, from about 10 nm to about 600 nm, from about 10 nm to about 550 nm, from about 10 nm to about 500 nm, from about 10 nm to about 450 nm, from about 10 nm to about 400 nm, from about 10 nm to about 350 nm, from about 10 nm to about 300 nm, from about 50 nm to about 300 nm, and all ranges and sub-ranges therebetween. In some embodiments, the anti-reflective coating 130 may have a physical thickness in the range from about 250 nm to about 1000 nm, from about 500 nm to about 1000 nm, and all ranges and sub-ranges therebetween. For example, the anti-reflective coating 130 may have a physical thickness of about 250 nm, 300 nm, 350 nm, 400 nm, 450 nm, 500 nm, 550 nm, 600 nm, 650 nm, 700 nm, 750 nm, 800 nm, 850 nm, 900 nm, 950 nm, 1000 nm, and all thicknesses between these thickness values.

In one or more embodiments, the anti-reflective coating 130 may be disposed over the scratch-resistant layer 150. It has been discovered that limiting the thickness of the anti-reflective coating 130 over the scratch-resistance layer 150 may improve hardness. In one or more embodiments, the anti-reflective coating 130 disposed over the scratch resistant layer 150 may have a physical thickness of about 1000 nm or less, 900 nm or less, 800 nm or less, 700 nm or less, 600 nm or less, 500 nm or less, or even 400 nm or less.

In one or more embodiments, the combined physical thickness of the second high RI layer(s) may be characterized. For example, in some embodiments, the combined thickness of the second high RI layer(s) may be about 100 nm or greater, about 150 nm or greater, about 200 nm or greater, about 250 nm or greater, about 300 nm or greater, about 350 nm or greater, about 400 nm or greater, about 450 nm or greater, about 500 nm or greater, about 550 nm or greater, about 600 nm or greater, about 650 nm or greater, about 700 nm or greater, about 750 nm or greater, about 800 nm or greater, about 850 nm or greater, about 900 nm or greater, about 950 nm or greater, or even about 1000 nm or greater. The combined thickness is the calculated combination of the thicknesses of the individual high RI layer(s) in the anti-reflective coating 130, even when there are intervening low RI layer(s) or other layer(s). In some embodiments, the combined physical thickness of the second high RI layer(s), which may also comprise a high-hardness material (e.g., a nitride or an oxynitride material), may be greater than 30% of the total physical thickness of the anti-reflective coating. For example, the combined physical thickness of the second high RI layer(s) may be about 40% or greater, about 50% or greater, about 60% or greater, about 70% or greater, about 75% or greater, or even about 80% or greater, of the total physical thickness of the anti-reflective coating 130 or the total physical thickness of the optical coating 120. Additionally or alternatively, the amount of the high refractive index material (which may also be a high-hardness material) included in the optical coating may be characterized as a percentage of the physical thickness of the upper most (i.e., user side or side of the optical coating opposite the substrate) 500 nm of the article or optical coating 120. Expressed as a percentage of the upper most 500 nm of the article or optical coating, the combined physical thickness of the second high RI layer(s) (or the thickness of the high refractive index material) may be about 50% or greater, about 60% or greater, about 70% or greater, about 80% or greater, or even about 90% or greater. In some embodiments, greater proportions of hard and high-index material within the anti-reflective coating can also simultaneously be made to also exhibit low reflectance, low color, and high abrasion resistance as further described elsewhere herein. In one or more embodiments, the second high RI layers may include a material having a refractive index greater than about 1.85 and the first low RI layers may include a material having a refractive index less than about 1.75. In some embodiments, the second high RI layers may include a nitride or an oxynitride material. In some instances, the combined thickness of all the first low RI layers in the optical coating (or in the layers that are disposed on the thickest second high RI layer of the optical coating) may be about 200 nm or less (e.g., about 150 nm or less, about 100 nm or less, about 75 nm or less, or about 50 nm or less).

The coated article 100 may include one or more additional coatings 140 disposed on the anti-reflective coating, as shown in FIG. 6. In one or more embodiments, the additional coating may include an easy-to-clean coating. An example of a suitable easy-to-clean coating is described in U.S. patent application Ser. No. 13/690,904, entitled “Process for Making of Glass Articles with Optical and Easy-to-Clean Coatings,” filed on Nov. 30, 2012, and published as U.S. Patent Application Publication No. 2014/0113083 on Apr. 24, 2014, the salient portions of each are incorporated by reference herein in their entirety. The easy-to-clean coating may have a thickness in the range from about 5 nm to about 50 nm and may include known materials such as fluorinated silanes. The easy-to-clean coating may alternately or additionally comprise a low-friction coating or surface treatment. Exemplary low-friction coating materials may include diamond-like carbon, silanes (e.g. fluorosilanes), phosphonates, alkenes, and alkynes. In some embodiments, the easy-to-clean coating may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm or from about 7 nm to about 10 nm, and all ranges and sub-ranges therebetween.

The additional coating 140 may include a scratch-resistant layer or layers. In some embodiments, the additional coating 140 includes a combination of easy-to-clean material and scratch-resistant material. In one example, the combination includes an easy-to-clean material and diamond-like carbon. Such additional coatings 140 may have a thickness in the range from about 5 nm to about 20 nm. The constituents of the additional coating 140 may be provided in separate layers. For example, the diamond-like carbon may be disposed as a first layer and the easy-to clean material can be disposed as a second layer on the first layer of diamond-like carbon. The thicknesses of the first layer and the second layer may be in the ranges provided above for the additional coating. For example, the first layer of diamond-like carbon may have a thickness of about 1 nm to about 20 nm or from about 4 nm to about 15 nm (or more specifically about 10 nm) and the second layer of easy-to-clean material may have a thickness of about 1 nm to about 10 nm (or more specifically about 6 nm). The diamond-like coating may include tetrahedral amorphous carbon (Ta—C), Ta—C:H, and/or a-C—H.

As mentioned herein, the optical coating 120 may include a scratch-resistant layer 150, which may be disposed between the anti-reflective coating 130 and the substrate 110. In some embodiments, the scratch-resistant layer 150 is disposed between the layers of the anti-reflective coating 130 (such as the scratch-resistant layer 150 as shown in FIGS. 7 and 8). The two sections of the anti-reflective coating 130 (i.e., a first section disposed between the scratch-resistant layer 150 and the substrate 110, and a second section disposed on the scratch-resistant layer) may have a different thickness from one another or may have essentially the same thickness as one another. The layers of the two sections of the anti-reflective coating 130 may be the same in composition, order, thickness and/or arrangement as one another or may differ from one another. In addition, the layers of the two sections of the anti-reflective coating 130 may comprise the same number of periods 132(N) or the number of periods 132 in each of these sections may differ from one another (see periods 132 shown in FIGS. 2-6 and described earlier). In addition, one or more optional layers 130C (not shown) can be disposed in either or both of the two sections (e.g., directly on the substrate 110, at the top of the first anti-reflective coating 130 section in contact with the scratch-resistant layer 150, at the bottom of the second anti-reflective coating 130 section in contact with the scratch-resistant layer 150, and/or at the bottom of the second anti-reflective coating in contact with the substrate 110).

Exemplary materials used in the scratch-resistant layer 150 (or the scratch-resistant layer used as an additional coating 140) may include an inorganic carbide, nitride, oxide, diamond-like material, or combination of these. Examples of suitable materials for the scratch-resistant layer 150 include metal oxides, metal nitrides, metal oxynitride, metal carbides, metal oxycarbides, and/or combinations thereof. Exemplary metals include B, Al, Si, Ti, V, Cr, Y, Zr, Nb, Mo, Sn, Hf, Ta and W. Specific examples of materials that may be utilized in the scratch-resistant layer 150 or coating may include Al₂O₃, AlN, AlOₓN_{y}, Si₃N₄, SiOₓN_{y}, SiᵤAlᵥOₓN_{y}, diamond, diamond-like carbon, SiₓC_{y}, SiₓO_{y}C_{z}, ZrO₂, TiOₓN_{y} and combinations thereof. The scratch-resistant layer 150 may also comprise nanocomposite materials, or materials with a controlled microstructure to improve hardness, toughness, or abrasion/wear resistance. For example, the scratch-resistant layer 150 may comprise nanocrystallites in the size range from about 5 nm to about 30 nm. In embodiments, the scratch-resistant layer 150 may comprise transformation-toughened zirconia, partially stabilized zirconia, or zirconia-toughened alumina. In embodiments, the scratch-resistant layer 150 exhibits a fracture toughness value greater than about 1 MPa m and simultaneously exhibits a hardness value greater than about 8 GPa.

The scratch-resistant layer 150 may include a single layer (as shown in FIGS. 7 and 8), or multiple sub-layers or single layers that exhibit a refractive index gradient. Where multiple layers are used, such layers form a scratch-resistant coating. For example, a scratch-resistant layer 150 may include a compositional gradient of SiᵤAlᵥOₓN_{y} where the concentration of any one or more of Si, Al, O and N are varied to increase or decrease the refractive index. The refractive index gradient may also be formed using porosity. Such gradients are more fully described in U.S. patent application Ser. No. 14/262,224, entitled “Scratch-Resistant Articles with a Gradient Layer”, filed on Apr. 28, 2014, and now issued as U.S. Pat. No. 9,703,011 on Jul. 11, 2017, the salient portions of each are hereby incorporated by reference in their entirety.

The scratch-resistant layer 150 may have a thickness from about 200 nm to about 5000 nm, according to some embodiments. In some implementations, the scratch-resistant layer 150 has a thickness from about 200 nm to about 5000 nm, from about 200 nm to about 3000 nm, from about 500 nm to about 5000 nm, from about 500 nm to 3000 nm, from about 500 nm to about 2500 nm, from about 1000 nm to about 4000 nm, from about 1500 nm to about 4000 nm, from about 1500 nm to about 3000 nm, and all thickness values between these thicknesses. For example, the thickness of the scratch-resistant layer 150 can be 200 nm, 300 nm, 400 nm, 500 nm, 600 nm, 700 nm, 800 nm, 900 nm, 1000 nm, 1100 nm, 1200 nm, 1300 nm, 1400 nm, 1500 nm, 1600 nm, 1700 nm, 1800 nm, 1900 nm, 2000 nm, 2100 nm, 2200 nm, 2300 nm, 2400 nm, 2500 nm, 2600 nm, 2700 nm, 2800 nm, 2900 nm, 3000 nm, 3500 nm, 4000 nm, 4500 nm, 5000 nm, and all thickness sub-ranges and thickness values between the foregoing thicknesses.

In one embodiment, depicted in FIG. 8, the optical coating 120 may comprise a scratch-resistant layer 150 that is integrated as a high RI layer, and one or more low RI layers 130A and high RI layers 130B may be positioned over the scratch-resistant layer 150, with an optional capping layer 131 positioned over the low RI layers 130A and high RI layers 130B, where the capping layer 131 comprises a low RI material. The scratch-resistant layer 150 may be alternately defined as the thickest hard layer or the thickest high RI layer in the overall optical coating 120 or in the overall coated article 100. Without being bound by theory, it is believed that the coated article 100 may exhibit increased hardness at indentation depths when a relatively thin amount of material is deposited over the scratch-resistant layer 150. However, the inclusion of low RI and high RI layers over the scratch-resistant layer 150 may enhance the optical properties of the coated article 100. In some embodiments, relatively few layers (e.g., only 1, 2, 3, 4, or 5 layers) may positioned over the scratch-resistant layer 150 and these layers may each be relatively thin (e.g., less than 100 nm, less than 75 nm, less than 50 nm, or even less than 25 nm). In other embodiments, a larger quantity of layers (e.g., 3 to 15 layers) may be positioned over the scratch-resistant layer 150 and each of these layers may also be relatively thin (e.g., less than 200 nm, less than 175 nm, less than 150 nm, less than 125 nm, less than 100 nm, less than 75 nm, less than 50 nm, and even less than 25 nm). In one implementation of the embodiment depicted in FIG. 8, the anti-reflective coating 130 may include a period 132 comprising four periods 132 above the scratch-resistant layer 150, four periods 132 below the scratch-resistant layer (i.e., N=8), a layer 130C disposed adjacent to the scratch-resistant layer 150 or substrate 110 (not shown), and a capping layer 131 (as shown in FIG. 8). In another implementation of the embodiment depicted in FIG. 8, the anti-reflective coating 130 may include a period 132 comprising five periods 132 above the scratch-resistant layer 150, five periods 132 below the scratch-resistant layer (i.e., N=8), a layer 130C disposed adjacent to the scratch-resistant layer 150 or substrate 110 (not shown), and a capping layer 131 (as shown in FIG. 8).

In embodiments, the layers deposited over the scratch-resistant layer 150 (i.e., on the air side of the scratch-resistant layer 150) may have a total thickness (i.e., in combination) of less than or equal to about 1000 nm, less than or equal to about 500 nm, less than or equal to about 450 nm, less than or equal to about 400 nm, less than or equal to about 350 nm, less than or equal to about 300 nm, less than or equal to about 250 nm, less than or equal to about 225 nm, less than or equal to about 200 nm, less than or equal to about 175 nm, less than or equal to about 150 nm, less than or equal to about 125 nm, less than or equal to about 100 nm, less than or equal to about 90 nm, less than or equal to about 80 nm, less than or equal to about 70 nm, less than or equal to about 60 nm, or even less than or equal to about 50 nm.

In embodiments, the coated article 100 can comprise an outer structure and an inner structure. In embodiments, each, or one of, the outer and inner structures can include a plurality of alternating low RI and high RI layers, 130A and 130B, respectively. In embodiments, each, or one of, the outer and inner structures can include a plurality of alternating medium RI and high RI layers. In some preferred implementations, the outer structure can include at least one medium RI layer in contact with one of the high RI layers and/or the scratch-resistant layer 150.

According to embodiments, each of the outer and inner structures can include a period of two or more layers, such as the low RI layer 130A and high RI layer 130B; or a low RI layer 130A, high RI layer 130B and a low RI layer 130A; or a high RI layer 130B and a medium RI layer 130C. Further, each of the outer and inner structures of the optical film structure 120 may include a plurality of periods 132, such as 1 to 30 periods, 1 to 25 periods, 1 to 20 periods, and all periods within the foregoing ranges. In addition, the number of periods 132, the number of layers of the outer and inner structures, and/or the number of layers within a given period 132 can differ or they may be the same. Further, in some implementations, the total amount of the plurality of alternating low RI and high RI layers 130A and 130B and the scratch-resistant layer 150 may range from 6 to 50 layers, 6 to 40 layers, 6 to 30 layers, 6 to 28 layers, 6 to 26 layers, 6 to 24 layers, 6 to 22 layer, 6 to 20 layers, 6 to 18 layers, 6 to 16 layers, and 6 to 14 layers, and all ranges of layers and amounts of layers between the foregoing values.

In embodiments (e.g., the coated article 100 depicted in FIGS. 7 and 8), the total thickness of low RI layer(s) (the sum of thickness of all low RI layers 130A, even if they are not in contact) that are positioned over the scratch-resistant layer 150 (i.e., on the air side of the scratch-resistant layer 150) may be less than or equal to about 500 nm, less than or equal to about 450 nm, less than or equal to about 400 nm, less than or equal to about 350 nm, less than or equal to about 300 nm, less than or equal to about 250 nm, less than or equal to about 225 nm, less than or equal to about 200 nm, less than or equal to about 175 nm, less than or equal to about 150 nm, less than or equal to about 125 nm, less than or equal to about 100 nm, less than or equal to about 90 nm, less than or equal to about 80 nm, less than or equal to about 70 nm, less than or equal to about 60 nm, less than or equal to about 50 nm, less than or equal to about 40 nm, less than or equal to about 30 nm, less than or equal to about 20 nm, or even less than or equal to about 10 nm.

The optical coating 120 and/or the coated article 100 may be described in terms of a hardness measured by a Berkovich Indenter Hardness Test. As used herein, the “Berkovich Indenter Hardness Test” includes measuring the hardness of a material on a surface thereof by indenting the surface with a diamond Berkovich indenter. The Berkovich Indenter Hardness Test includes indenting the anti-reflective surface 122 of the coated article 100 (see FIGS. 1-8) or the surface of any one or more of the layers in the optical coating 120 with the diamond Berkovich indenter to form an indent to an indentation depth in the range from about 50 nm to about 1000 nm (or the entire thickness of the optical coating 120 or layer thereof, whichever is less) and measuring the maximum hardness from this indentation along the entire indentation depth range or a segment of this indentation depth (e.g., in the range from about 100 nm to about 600 nm, e.g., at an indentation depth of 100 nm or greater, etc.), generally using the methods set forth in Oliver, W. C.; Pharr, G. M., “An improved technique for determining hardness and elastic modulus using load and displacement sensing indentation experiments,” J. Mater. Res., Vol. 7, No. 6, 1992, 1564-1583; and Oliver, W. C.; Pharr, G. M., “Measurement of Hardness and Elastic Modulus by Instrument Indentation: Advances in Understanding and Refinements to Methodology,” J. Mater. Res., Vol. 19, No. 1, 2004, 3-20, the salient portions of which are incorporated by reference within this disclosure in their entirety. As used herein, “hardness” refers to a maximum hardness, and not an average hardness.

As used herein, the “Berkovich Indenter Hardness Test” and “Berkovich Hardness Test” are used interchangeably to refer to a test for measuring the hardness of a material on a surface thereof by indenting the surface with a diamond Berkovich indenter. The Berkovich Indenter Hardness Test includes indenting the outermost surface (e.g., an exposed surface) of a single optical coating or the outer optical coating of a transparent article of the disclosure with the diamond Berkovich indenter to form an indent to an indentation depth in the range from about 50 nm to about 1000 nm (or the entire thickness of the outer or inner optical coating whichever is less) and measuring the maximum hardness from this indentation along the entire indentation depth range or a segment of this indentation depth (e.g., in the range from about 100 nm to about 600 nm), generally using the methods set forth in Oliver, W. C.; Pharr, G. M. An improved technique for determining hardness and elastic modulus using load and displacement sensing indentation experiments. J. Mater. Res., Vol. 7, No. 6, 1992, 1564-1583; and Oliver, W. C.; Pharr, G. M. Measurement of Hardness and Elastic Modulus by Instrument Indentation: Advances in Understanding and Refinements to Methodology. J. Mater. Res., Vol. 19, No. 1, 2004, 3-20. As used herein, each of “hardness” and “maximum hardness” interchangeably refers to a maximum hardness as measured along a range of indentation depths, and not an average hardness.

Typically, in nanoindentation measurement methods (such as by using a Berkovich indenter) of a coating that is harder than the underlying substrate, the measured hardness may appear to increase initially due to development of the plastic zone at shallow indentation depths and then increases and reaches a maximum value or plateau at deeper indentation depths. Thereafter, hardness begins to decrease at even deeper indentation depths due to the effect of the underlying substrate. Where a substrate having an increased hardness compared to the coating is utilized, the same effect can be seen; however, the hardness increases at deeper indentation depths due to the effect of the underlying substrate.

The indentation depth range and the hardness values at certain indentation depth range(s) can be selected to identify a particular hardness response of the optical film structures and layers thereof, described herein, without the effect of the underlying substrate. When measuring hardness of the optical film structure (when disposed on a substrate) with a Berkovich indenter, the region of permanent deformation (plastic zone) of a material is associated with the hardness of the material. During indentation, an elastic stress field extends well beyond this region of permanent deformation. As indentation depth increases, the apparent hardness and modulus are influenced by stress field interactions with the underlying substrate. The substrate influence on hardness occurs at deeper indentation depths (i.e., typically at depths greater than about 10% of the optical film structure or layer thickness). Moreover, a further complication is that the hardness response requires a certain minimum load to develop full plasticity during the indentation process. Prior to that certain minimum load, the hardness shows a generally increasing trend.

At small indentation depths (which also may be characterized as small loads) (e.g., up to about 50 nm), the apparent hardness of a material appears to increase dramatically versus indentation depth. This small indentation depth regime does not represent a true metric of hardness but instead, reflects the development of the aforementioned plastic zone, which is related to the finite radius of curvature of the indenter. At intermediate indentation depths, the apparent hardness approaches maximum levels. At deeper indentation depths, the influence of the substrate becomes more pronounced as the indentation depths increase. Hardness may begin to drop dramatically once the indentation depth exceeds about 30% of the optical coating 120 thickness or the layer thickness.

In some embodiments, the coated article 100 (e.g., as depicted in FIGS. 1-8) may exhibit a hardness of about 8 GPa or greater, about 10 GPa or greater, or about 12 GPa or greater (e.g., about 14 GPa or greater, about 16 GPa or greater, about 18 GPa or greater, or about 20 GPa or greater) when measured at the anti-reflective surface 122. The hardness of the coated article 100 may even be up to about 20 GPa or 30 GPa. Such measured hardness values may be exhibited by the optical coating 120 and/or the coated article 100 along an indentation depth of about 50 nm or greater, or about 100 nm or greater (e.g., from about 50 nm to about 300 nm, from about 50 nm to about 400 nm, from about 50 nm to about 500 nm, from about 50 nm to about 600 nm, from about 100 nm to about 300 nm, from about 100 nm to about 400 nm, from about 100 nm to about 500 nm, from about 100 nm to about 600 nm, from about 200 nm to about 300 nm, from about 200 nm to about 400 nm, from about 200 nm to about 500 nm, or from about 200 nm to about 600 nm). In one or more embodiments, the coated article 100 exhibits a hardness that is greater than the hardness of the substrate 110 (which can be measured on the opposite surface from the anti-reflective surface). Unless specified otherwise, the hardness may be measured normal to the thickest portion of the optical coating 120.

According to embodiments, the hardness may be measured at different portions of the coated article 100. For example, the coated article may exhibit a hardness of at least 8 GPa or greater at an indentation depth of at least about 100 nm or greater at the anti-reflective surface 122 at the first portion 113 and at the second portion 115. For example, the hardness at the first portion 113 and at second portion 115 may be about 8 GPa or greater, about 10 GPa or greater, or about 12 GPa or greater (e.g., about 14 GPa or greater, about 16 GPa or greater, about 18 GPa or greater, or about 20 GPa or greater).

According to embodiments, the coated articles described herein may have desirable optical properties (such as low reflectance and neutral color) at various portions of the coated article 100, such as the first portion 113 and the second portion 115. For example, light reflectance may be relatively low (and transmittance may be relatively high) at the first portion 113 and at the second portion 115 when each is viewed at an incident illumination angle near normal to the respective portions. In another embodiment, when each portion is viewed at a near normal incident illumination angle, the difference in color between the two portions may be insignificant to the naked eye. In another embodiment, when the portions are viewed at incident illumination angles that have the same direction, the color may be insignificant to the naked eye and there may be relatively low reflectance at each portion (i.e., the incident illumination angles relative to the surfaces of each portion are different because the portions are at an angle to one another, but the illumination direction is the same). Optical properties may include average light transmittance, average light reflectance, photopic reflectance, maximum photopic reflectance, photopic transmittance, reflected color (i.e., in L*a*b* color coordinates), and transmitted color (i.e., in L*a*b* color coordinates).

As used herein, the term “transmittance” is defined as the percentage of incident optical power within a given wavelength range transmitted through a material (e.g., the article, the substrate or the optical film or portions thereof). The term “reflectance” is similarly defined as the percentage of incident optical power within a given wavelength range that is reflected from a material (e.g., the article, the substrate, or the optical film or portions thereof). Reflectance may be measured as a single side reflectance (also referred herein as “first surface reflectance”) when measured at the anti-reflective surface 122 only (e.g., when removing the reflections from an uncoated back surface (e.g., 114 in FIG. 1) of the article, such as through using index-matching oils on the back surface coupled to an absorber, or other known methods). In one or more embodiments, the spectral resolution of the characterization of the transmittance and reflectance is less than 5 nm or 0.02 eV. The color may be more pronounced in reflection. The angular color shifts in reflection with viewing angle due to a shift in the spectral reflectance oscillations with incident illumination angle. Angular color shifts in transmittance with viewing angle are also due to the same shift in the spectral transmittance oscillation with incident illumination angle. The observed color and angular color shifts with incident illumination angle are often distracting or objectionable to device users, particularly under illumination with sharp spectral features such as fluorescent lighting and some LED lighting. Angular color shifts in transmission may also play a factor in color shift in reflection and vice versa. Factors in angular color shifts in transmission and/or reflection may also include angular color shifts due to viewing angle or angular color shifts away from a certain white point that may be caused by material absorption (somewhat independent of angle) defined by a particular illuminant or test system.

The coated article 100 may also be characterized by its photopic transmittance and reflectance at various portions. As used herein, photopic reflectance mimics the response of the human eye by weighting the reflectance versus wavelength spectrum according to the human eye's sensitivity. Photopic reflectance may also be defined as the luminance, or tristimulus Y value of reflected light, according to known conventions such as CIE color space conventions. The average photopic reflectance is defined in the below equation as the spectral reflectance, R(λ) multiplied by the illuminant spectrum, I(λ) and the CIE's color matching function y̅(λ), related to the eye's spectral response:

$$〈 {R}_{p} 〉 = {\int }_{380 nm}^{720 nm} R ( λ ) \times I ( λ ) \times \overline{y} ( λ ) d λ$$

In addition, “average reflectance” can be determined over the visible spectrum, or over other wavelength ranges, according to measurement principles understood by those skilled in the field of the disclosure, e.g., in the infrared spectrum from 840 nm to 950 nm, etc. Unless otherwise noted, all reflectance values reported or otherwise referenced in this disclosure are associated with testing through both primary surfaces of the substrate and optical film structure(s) of the transparent articles of the disclosure, e.g., a “two-surface” average photopic reflectance. In cases where “one-surface” or “first-surface” reflectance is specified, the reflectance from the rear surface of the article is eliminated through optical bonding to a light absorber, allowing the reflectance of only the first surface to be measured.

The usability of a transparent article in an electronic device (e.g., as a protective cover) can be related to the total amount of reflectance in the article. Photopic reflectance is particularly important for display devices that employ visible light. Lower reflectance in a cover transparent article over a lens and/or a display associated with the device can reduce multiple-bounce reflections in the device that can generate ‘ghost images’. Thus, reflectance has an important relationship to image quality associated with the device, particularly its display and any of its other optical components (e.g., a lens of a camera). Low-reflectance displays also enable better display readability, reduced eye strain, and faster user response time (e.g., in an automotive display, where display readability can also correlate to driver safety). Low-reflectance displays can also allow for reduced display energy consumption and increased device battery life, since the display brightness can be reduced for low-reflectance displays compared to standard displays, while still maintaining the targeted level of display readability in bright ambient environments.

The average photopic transmittance is defined in the below equation as the spectral transmittance, T(λ) multiplied by the illuminant spectrum, I(λ) and the CIE's color matching function y̅(λ), related to the eye's spectral response:

$$〈 {T}_{p} 〉 = {\int }_{380 nm}^{720 nm} T ( λ ) \times I ( λ ) \times \overline{y} ( λ ) d λ$$

It should also be understood that the photopic transmittance and/or reflectance can be reported as the maximum photopic transmittance and/or reflectance within a given spectral range (e.g., from 425 nm to 950 nm).

According to embodiments described herein, the reflectance may be relatively low in wavelength bands that extend into the infra-red (IR) spectrum. Generally, visible light forms an interface with IR light at about 700 nm. Surprisingly, it has been discovered that extending low reflectance into the IR band is beneficial for coatings that are reduced in thickness due to, for example, line-of-sight deposition. That is, a coating may be designed for the thick region (e.g., over the first portion 113) that has low IR reflectivity, and in turn the coating with reduced thickness (e.g., over the second portion 115) will maintain low reflectivity over visible light wavelengths. Without being bound by theory, it is believed that the low reflectivity band in a coating is reduced in bandwidth range when the coating thickness is reduced. In some embodiments, the bandwidth of the low reflectivity bandwidth may scale about linearly with the thickness of the coating. For example, a coating that has a 3% or lower reflectivity up to 1500 nm in its thick portion may have 3% or lower reflectivity up to about 750 nm in portions half the thickness of the thick portion, or a coating that has a 3% or lower reflectivity up to 1500 nm in its thick portion may have 3% or lower reflectivity up to about 1000 nm in portions two-thirds the thickness of the thick portion. As such, it is discovered that an improvement for coating systems on curved surfaces may be observed when low IR reflectivity is present in the coating in its thick portions.

According to one or more embodiments, the coated article 100 may exhibit a single side light reflectance of about 3% or less at all wavelengths from 410 nm to at least 1050 nm as measured at the anti-reflective surface 122 at the first portion 113 of the substrate 110 at an angle of incidence of 5 degrees. In additional embodiments, the coated article 100 may exhibit a single side light reflectance of about 3% or less at all wavelengths from 410 nm to at least 1100 nm, at least 1150 nm, at least 1200 nm, at least 1250 nm, at least 1300 nm, at least 1350 nm, at least 1400 nm, at least 1450 nm, at least 1500 nm, at least 1550 nm, at least 1600 nm, at least 1650 nm, at least 1700 nm, at least 1750 nm, at least 1800 nm, at least 1850 nm, at least 1900 nm, at least 1950 nm, at even least 2000 nm, as measured at the anti-reflective surface 122 at the first portion 113 of the substrate 110 at an angle of incidence of 5 degrees. In some embodiments, the first portion 113 is analogous to the thickest portion of the optical coating 120, as is described herein.

In additional embodiments, the coated article 100 may exhibit a single side light reflectance of about 2.8% or less, about 2.6% or less, about 2.5% or less, about 2.4% or less, about 2.2% or less, about 2% or less, about 1.8% or less, about 1.6% or less, about 1.5% or less, about 1.4% or less, about 1.2% or less, or even about 1% or less, at all wavelengths from 410 nm to at least 1050 nm, at least 1100 nm, at least 1150 nm, at least 1200 nm, at least 1250 nm, at least 1300 nm, at least 1350 nm, at least 1400 nm, at least 1450 nm, at least 1500 nm, at least 1550 nm, at least 1600 nm, at least 1650 nm, at least 1700 nm, at least 1750 nm, at least 1800 nm, at least 1850 nm, at least 1900 nm, at least 1950 nm, at even least 2000 nm, as measured at the anti-reflective surface 122 at the first portion 113 of the substrate 110 at an angle of incidence of 5 degrees, 30 degrees, 45 degrees, or 60 degrees, in all combinations of reflectance percentage, wavelength range, and angle of incidence disclosed.

According to one or more embodiments, the coated article 100 may exhibit a photopic average single side light reflectance of about 8% or less, about 7% or less, about 6% or less, about 5% or less, about 4% or less, or about 3% or less at wavelengths from 410 nm to at least 1050 nm as measured at the anti-reflective surface 122 at the first portion 113 of the substrate 110 at an angle of incidence of 5 degrees. In additional embodiments, the coated article 100 may exhibit a photopic average single side light reflectance of about 8% or less, about 7% or less, about 06% or less, about 5% or less, about 4% or less, or about 3% or less at all wavelengths from 410 nm to at least 1100 nm, at least 1150 nm, at least 1200 nm, at least 1250 nm, at least 1300 nm, at least 1350 nm, at least 1400 nm, at least 1450 nm, at least 1500 nm, at least 1550 nm, at least 1600 nm, at least 1650 nm, at least 1700 nm, at least 1750 nm, at least 1800 nm, at least 1850 nm, at least 1900 nm, at least 1950 nm, at even least 2000 nm, as measured at the anti-reflective surface 122 at the first portion 113 of the substrate 110 at an angle of incidence of 5 degrees. In some embodiments, the first portion 113 is analogous to the thickest portion of the optical coating 120, as is described herein.

In additional embodiments, the coated article 100 may exhibit a photopic average single sidelight reflectance of about 2.8% or less, about 2.6% or less, about 2.4% or less, about 2.4% or less, about 2.2% or less, about 02% or less, about 1.8% or less, about 1.6% or less, about 1.5% or less, about 1.4% or less, about 1.2% or less, or even about 1% or less, at wavelengths from 410 nm to at least 1050 nm, at least 1100 nm, at least 1150 nm, at least 1200 nm, at least 1250 nm, at least 1300 nm, at least 1350 nm, at least 1400 nm, at least 1450 nm, at least 1500 nm, at least 1550 nm, at least 1600 nm, at least 1650 nm, at least 1700 nm, at least 1750 nm, at least 1800 nm, at least 1850 nm, at least 1900 nm, at least 1950 nm, at even least 2000 nm, as measured at the anti-reflective surface 122 at the first portion 113 of the substrate 110 at an angle of incidence of 5 degrees, 30 degrees, 45 degrees, or 60 degrees, in all combinations of reflectance percentage, wavelength range, and angle of incidence disclosed.

According to the embodiments disclosed herein, the reflected color of the coated article 100 may be relatively color less at the first portion 113 and at the second portion 115. As used herein, color refers to the a* and b*, under the CIE L*, a*, b* colorimetry system in reflectance and/or transmittance. In particular, the reflected color of the coated article 100 at portions 113 and 115 may be relatively color less at angles of incidence of from 0 degrees (normal) to 90 degrees (parallel to the anti-reflective surface 122). The illuminant can include standard illuminants as determined by the CIE, including A illuminants (representing tungsten-filament lighting), B illuminants (daylight simulating illuminants), C illuminants (daylight simulating illuminants), D series illuminants (representing natural daylight), and F series illuminants (representing various types of fluorescent lighting). For example, International Commission on Illumination D65 illuminant may be utilized for measurement.

According to one or more embodiments, the first surface reflected color of the coated article 100 at the first portion 113 may be defined by a* is less than or equal to 10, less than or equal to 9, less than or equal to 8, less than or equal to 7, less than or equal to 6, less than or equal to 5, less than or equal to 4, less than or equal to 3, less than or equal to 2, or less than or equal to 1 and/or a* is at least −10, at least −9, at least −8, at least −7, at least −6, at least −5, at least −4, at least −3, at least −2, or at least −1 for all angles of incidence from 0 degrees to 90 degrees as measured normal to the first portion 113. The first surface reflected color of the coated article 100 at the first portion 113 may be defined by b* is less than or equal to 10, less than or equal to 9, less than or equal to 8, less than or equal to 7, less than or equal to 6, less than or equal to 5, less than or equal to 4, less than or equal to 3, less than or equal to 2, or less than or equal to 1 and/or b* is at least −10, at least −9, at least −8, at least −7, at least −6, at least −5, at least −4, at least −3, at least −2, or at least −1 for all angles of incidence from 0 degrees to 90 degrees as measured normal to the first portion 113. According to additional embodiments, the disclosed ranges of a* and b* may be measured over angles of incidence ranging from 0 degrees to 80 degrees, to 70 degrees, to 60 degrees, to 50 degrees, to 40 degrees, to 30 degrees, or to 20 degrees.

According to one or more embodiments, the first surface reflected color of the coated article 100 at the second portion 115 may be defined by a* is less than or equal to 10, less than or equal to 9, less than or equal to 8, less than or equal to 7, less than or equal to 6, less than or equal to 5, less than or equal to 4, less than or equal to 3, less than or equal to 2, or less than or equal to 1 and/or a* is at least −10, at least −9, at least −8, at least −7, at least −6, at least −5, at least −4, at least −3, at least −2, or at least −1 for all angles of incidence from 0 degrees to 90 degrees as measured normal to the second portion 115. The first surface reflected color of the coated article 100 at the second portion 115 may be defined by b* is less than or equal to 10, less than or equal to 9, less than or equal to 8, less than or equal to 7, less than or equal to 6, less than or equal to 5, less than or equal to 4, less than or equal to 3, less than or equal to 2, or less than or equal to 1 and/or b* is at least −10, at least −9, at least −8, at least −7, at least −6, at least −5, at least −4, at least −3, at least −2, or at least −1 for all angles of incidence from 0 degrees to 90 degrees as measured normal to the second portion 115. According to additional embodiments, the disclosed ranges of a* and b* may be measured over angles of incidence ranging from 0 degrees to 80 degrees, to 70 degrees, to 60 degrees, to 50 degrees, to 40 degrees, to 30 degrees, or to 20 degrees. In embodiments having the above described a* and/or b*, the thickness of the optical coating 120 on the second portion 115 is 70% or less (i.e., scaling of 0.7 or less), 65% or less (i.e., scaling of 0.65 or less), 60% or less (i.e., scaling of 0.6 or less), 55% or less (i.e., scaling of 0.55 or less), 50% or less (i.e., scaling of 0.5 or less), 45% or less (i.e., scaling of 0.45 or less), 40% or less (i.e., scaling of 0.4 or less), 35% or less (i.e., scaling of 0.35 or less), or even 300% or less (i.e., scaling of 0.3 or less), than the thickness of the optical coating 120 on the first portion 113.

According to one or more embodiments, the first surface reflected color of the coated article 100 at the first portion 113 is defined by b*<2.5 for all angles of incidence from 0 degrees to 90 degrees as measured normal to the first portion 113 of the major surface 112, and the first surface reflected color of the coated article 100 at the second portion 115 is defined by b*<2.5 for all angles of incidence from 0 degrees to 90 degrees as measured normal to the second portion 115 of the major surface 112, where the scaling factor is 0.7 or less.

According to another embodiment, the first surface reflected color of the coated article 100 at the first portion 113 is defined by −10<a*<10 and −10<b*<10 for all angles of incidence from 0 degrees to 90 degrees as measured normal to the first portion 113 of the major surface 112, and the first surface reflected color of the coated article 100 at the second portion 115 is defined by −10<a*<10 and −10<b*<10 for all angles of incidence from 0 degrees to 90 degrees as measured normal to the second portion 115 of the major surface 112, where the scaling factor is 0.5 or less.

According to another embodiment, the first surface reflected color of the coated article 100 at the first portion 113 is defined by −2<a*<2 and −2<b*<2 for all angles of incidence from 0 degrees to 90 degrees as measured normal to the first portion 113 of the major surface 112, and the first surface reflected color of the coated article 100 at the second portion 115 is defined by −2<a*<2 and −2<b*<2 for all angles of incidence from 0 degrees to 90 degrees as measured normal to the second portion 115 of the major surface 112, where the scaling factor is 0.7 or less.

According to another embodiment, the first surface reflected color of the coated article 100 at the first portion 113 is defined by −10<a*<10 and −10<b*<10 for all angles of incidence from 0 degrees to 90 degrees as measured normal to the first portion 113 of the major surface 112, and the first surface reflected color of the coated article 100 at the second portion 115 is defined by −10<a*<10 and −10<b*<10 for all angles of incidence from 0 degrees to 90 degrees as measured normal to the second portion 115 of the major surface 112, where the scaling factor is 0.6 or less.

According to another embodiment, the first surface reflected color of the coated article 100 at the first portion 113 is defined by b*<4 for all angles of incidence from 0 degrees to 90 degrees as measured normal to the first portion 113 of the major surface 112, and the first surface reflected color of the coated article 100 at the second portion 115 is defined by b*<4 for all angles of incidence from 0 degrees to 90 degrees as measured normal to the second portion 115 of the major surface 112, where the scaling factor is 0.6 or less.

According to another embodiment, the first surface reflected color of the coated article 100 at the first portion 113 is defined by −6<a*<6 and −10<b*<10 for all angles of incidence from 0 degrees to 90 degrees as measured normal to the first portion 113 of the major surface 112, and the first surface reflected color of the coated article 100 at the second portion 115 is defined by −6<a*<6 and −10<b*<10 for all angles of incidence from 0 degrees to 90 degrees as measured normal to the second portion 115 of the major surface 112, where the scaling factor is 0.35 or less.

The substrate 110 may include an inorganic material and may include an amorphous substrate, a crystalline substrate, or a combination thereof. The substrate 110 may be formed from man-made materials and/or naturally occurring materials (e.g., quartz and polymers). For example, in some instances, the substrate 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins(PO) and cyclicpolyolefins (cyclic-PO), polyvinylchloride (PVC), acrylic polymers including polymethyl methacrylate (PMMA)(including copolymers and blends), thermoplastic urethanes (TPU), polyetherimide (PEI) and blends of these polymers with each other. Other exemplary polymers include epoxy, styrenic, phenolic, melamine, and silicone resins.

In some specific embodiments, the substrate 110 may specifically exclude polymeric, plastic and/or metal materials. The substrate 110 may be characterized as alkali-including substrates (i.e., the substrate includes one or more alkalis). In one or more embodiments, the substrate 110 exhibits a refractive index in the range from about 1.45 to about 1.55. In specific embodiments, the substrate 110 may exhibit an average strain-to-failure at a surface on one or more opposing major surfaces that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In specific embodiments, the substrate 110 may exhibit an average strain-to-failure at its surface on one or more opposing major surfaces of about 1.2%, about 1.4%, about 1.6%, about 1.8%, about 2.2%, about 2.4%, about 2.6%, about 2.8%, or about 3% or greater.

Suitable substrates 110 may exhibit an elastic modulus (or Young's modulus) in the range from about 30 GPa to about 120 GPa. In some instances, the elastic modulus of the substrate may be in the range from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, from about 70 GPa to about 120 GPa, and all ranges and sub-ranges therebetween.

In one or more embodiments, the amorphous substrate may include glass, which may be strengthened or non-strengthened. Examples of suitable glass include soda lime glass, alkali aluminosilicate glass, alkali containing borosilicate glass and alkali aluminoborosilicate glass. In some variants, the glass may be free of Lithia. In one or more alternative embodiments, the substrate 110 may include crystalline substrates such as glass ceramic substrates (which may be strengthened or non-strengthened) or may include a single crystal structure, such as sapphire. In one or more specific embodiments, the substrate 110 includes an amorphous base (e.g., glass) and a crystalline cladding (e.g., sapphire layer, a polycrystalline alumina layer and/or or a spinel (MgAl₂O₄) layer).

The substrate 110 of one or more embodiments may have a hardness that is less than the hardness of the overall coated article 100 (as measured by the Berkovich Indenter Hardness Test described herein). The hardness of the substrate 110 may be measured using known methods in the art, including but not limited to the Berkovich Indenter Hardness Test or Vickers hardness test.

The substrate 110 may be substantially optically clear, transparent and free from light scattering elements. In such embodiments, the substrate may exhibit an average light transmittance over the optical wavelength regime of about 85% or greater, about 86% or greater, about 87% or greater, about 88% or greater, about 89% or greater, about 90% or greater, about 91% or greater, or about 92% or greater. In one or more alternative embodiments, the substrate 110 may be opaque or exhibit an average light transmittance over the optical wavelength regime of less than about 10%, less than about 9%, less than about 8%, less than about 7%, less than about 6%, less than about 5%, less than about 4%, less than about 3%, less than about 2%, less than about 1%, or less than about 0.5%. In some embodiments, these light reflectance and transmittance values may be a total reflectance or total transmittance (taking into account reflectance or transmittance on both major surfaces of the substrate) or may be observed on a single side of the substrate (i.e., on the anti-reflective surface 122 only, without taking into account the opposite surface). Unless otherwise specified, the average reflectance or transmittance of the substrate alone is measured at an incident illumination angle of 0 degrees relative to the substrate major surface 112 (however, such measurements may be provided at incident illumination angles of 45 degrees or 60 degrees). The substrate 110 may optionally exhibit a color, such as white, black, red, blue, green, yellow, orange etc.

Additionally or alternatively, the physical thickness of the substrate 110 may vary along one or more of its dimensions for aesthetic and/or functional reasons. For example, the edges of the substrate 110 may be thicker as compared to more central regions of the substrate 110. The length, width and physical thickness dimensions of the substrate 110 may also vary according to the application or use of the coated article 100.

The substrate 110 may be provided using a variety of different processes. For instance, where the substrate 110 includes an amorphous substrate such as glass, various forming methods can include float glass processes and down-draw processes such as fusion draw and slot draw.

Once formed, a substrate 110 may be strengthened to form a strengthened substrate. As used herein, the term “strengthened substrate” may refer to a substrate that has been chemically strengthened, for example through ion-exchange of larger ions for smaller ions in the surface of the substrate. However, other strengthening methods known in the art, such as thermal tempering, or utilizing a mismatch of the coefficient of thermal expansion between portions of the substrate to create compressive stress and central tension regions, may be utilized to form strengthened substrates.

Where the substrate 110 is chemically strengthened by an ion exchange process, the ions in the surface layer of the substrate are replaced by—or exchanged with—larger ions having the same valence or oxidation state. Ion exchange processes are typically carried out by immersing a substrate in a molten salt bath containing the larger ions to be exchanged with the smaller ions in the substrate. It will be appreciated by those skilled in the art that parameters for the ion exchange process, including, but not limited to, bath composition and temperature, immersion time, the number of immersions of the substrate in a salt bath (or baths), use of multiple salt baths, additional steps such as annealing, washing, and the like, are generally determined by the composition of the substrate and the desired compressive stress (CS), depth of compressive stress layer (or depth of layer DOL, or depth of compression DOC) of the substrate that result from the strengthening operation. By way of example, ion exchange of alkali metal-containing glass substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass substrates are immersed in multiple ion exchange baths, with washing and/or annealing steps between immersions, are described in U.S. patent application Ser. No. 12/500,650, filed Jul. 10, 2009, by Douglas C. Allan et al., entitled “Glass with Compressive Surface for Consumer applications” and claiming priority from U.S. Provisional Patent Application No. 61/079,995, filed Jul. 11, 2008, in which glass substrates are strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass substrates are strengthened by ion exchange in a first bath is diluted with an effluent ion, followed by immersion in a second bath having a smaller concentration of the effluent ion than the first bath. The contents of U.S. patent application Ser. No. 12/500,650 and U.S. Pat. No. 8,312,739 are incorporated herein by reference in their entirety.

The degree of chemical strengthening achieved by ion exchange may be quantified based on the parameters of central tension (CT), surface CS, and depth of compression (DOC). Compressive stress (including surface CS) is measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety. Maximum CT values are measured using a scattered light polariscope (SCALP) technique known in the art. As used herein, DOC means the depth at which the stress in the chemically strengthened alkali aluminosilicate glass article described herein changes from compressive to tensile. DOC may be measured by FSM or SCALP depending on the ion exchange treatment. Where the stress in the glass article is generated by exchanging potassium ions into the glass article, FSM is used to measure DOC. Where the stress is generated by exchanging sodium ions into the glass article, SCALP is used to measure DOC. Where the stress in the glass article is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass articles is measured by FSM.

In one or more embodiments, a substrate 110 can have a surface CS of 200 MPa or greater, 250 MPa or greater, 300 MPa or greater, e.g., 400 MPa or greater, 450 MPa or greater, 500 MPa or greater, 550 MPa or greater, 600 MPa or greater, 650 MPa or greater, 700 MPa or greater, 750 MPa or greater or 800 MPa or greater. In one or more embodiments, the substrate 110 may have a surface CS of from about 200 MPa to about 1200 MPa, from about 200 MPa to about 1000 MPa, from about 200 MPa to about 800 MPa, from about 200 MPa to about 600 MPa, or from about 200 MPa to about 400 MPa.

In one or more embodiments, the substrate 110 may have a DOC (formerly DOL) of from 5 μm to 150 μm, from 5 μm to 125 μm, from 5 μm to 100 μm, from 5 μm to 50 μm, from 5 μm to 25 μm, from 5 μm to 15 μm, from 10 μm to 150 μm, from 10 μm to 125 μm, from 10 μm to 100 μm, from 10 μm to 50 μm, from 10 μm to 25 μm, or from 10 μm to 15 μm.

In one or more embodiments, the substrate 110 may have maximum central tension (CT) value of greater than or equal to 80 MPa, greater than or equal to 90 MPa, greater than or equal to 110 MPa, greater than or equal to 120 MPa, greater than or equal to 130 MPa, greater than or equal to 140 MPa, or greater than or equal to 150 MPa. In one or more embodiments, the substrate 110 may have maximum central tension (CT) value of less than or equal to 200 MPa, less than or equal to 190 MPa, less than or equal to 180 MPa, less than or equal to 170 MPa, less than or equal to 160 MPa, less than or equal to 150 MPa, or less than or equal to 140 MPa. In one or more embodiments, the substrate 110 may have maximum central tension (CT) value of from 80 MPa to 200 MPa, from 80 MPa to 180 MPa, from 80 MPa to 160 MPa, from 80 MPa to 140 MPa, from 100 MPa to 200 MPa, from 100 MPa to 180 MPa, from 100 MPa to 160 MPa, from 100 MPa to 140 MPa.

The substrate 110 may have a DOC (formerly DOL) of 5 μm or greater, 10 μm or greater, 15 μm or greater, 20 μm or greater (e.g., 25 μm, 30 μm, 35 μm, 40 μm, 45 μm, 50 μm, 55 μm, 60 μm, 65 μm, 70 μm, 75 μm, 80 μm or greater) and/or a CT of 10 MPa or greater, 20 MPa or greater, 30 MPa or greater, 40 MPa or greater (e.g., 42 MPa, 45 MPa, or 50 MPa or greater) but less than 200 MPa (e.g., 195, 190, 185, 180, 175, 170, 165, 160, 155, 150, 145, 140, 135, 130, 125, 120, 115, 110, 105, 100, 95, 90, 85, 80, 75, 70, 65, 60, 55 MPa or less). In one or more specific embodiments, the substrate 110 has one or more of the following: a surface CS greater than 500 MPa, a DOC (formerly DOL) greater than 15 μm, and a CT greater than 18 MPa.

Example glasses that may be used in the substrate 110 may include alkali aluminosilicate glass compositions or alkali aluminoborosilicate glass compositions, though other glass compositions are contemplated. Such glass compositions are capable of being chemically strengthened by an ion exchange process. One example glass composition comprises SiO₂, B₂O₃ and Na₂O, where (SiO₂+B₂O₃)≥66 mol. %, and Na₂O≥9 mol. %. In an embodiment, the glass composition includes at least 6 wt. % aluminum oxide. In a further embodiment, the substrate includes a glass composition with one or more alkaline earth oxides, such that a content of alkaline earth oxides is at least 5 wt. %. Suitable glass compositions, in some embodiments, further comprise at least one of K₂O, MgO, and CaO. In a particular embodiment, the glass compositions used in the substrate can comprise 61-75 mol. % SiO2; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

A further example glass composition suitable for the substrate 110 comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

A still further example glass composition suitable for the substrate 110 comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In a particular embodiment, an alkali aluminosilicate glass composition suitable for the substrate 110 comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio (Al₂O₃+B₂O₃)/Σmodifiers (i.e., sum of modifiers) is greater than 1, where in the ratio the components are expressed in mol. % and the modifiers are alkali metal oxides. This glass composition, in particular embodiments, comprises: 58-72 mol. % SiO₂; 9-17 mol. % Al₂O₃; 2-12 mol. % B₂O₃; 8-16 mol. % Na₂O; and 0-4 mol. % K₂O, wherein the ratio (Al₂O₃+B₂O₃)/Σmodifiers (i.e., sum of modifiers) is greater than 1.

In still another embodiment, the substrate 110 may include an alkali aluminosilicate glass composition comprising: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. % SiO₂+B₂O₃+CaO 69 mol. %; Na₂O+K₂O+B₂O₃+MgO+CaO+SrO>10 mol. %; 5 mol. %≤MgO+CaO+SrO≤8 mol. %; (Na₂O+B₂O₃)—Al₂O₃≤2 mol. %; 2 mol. %≤Na₂O —Al₂O₃≤6 mol. %; and 4 mol. %≤(Na₂O+K₂O)—Al₂O₃ 10 mol. %.

In an alternative embodiment, the substrate 110 may comprise an alkali aluminosilicate glass composition comprising: 2 mol % or more of Al₂O₃ and/or ZrO₂, or 4 mol % or more of Al₂O₃ and/or ZrO₂.

Where the substrate 110 includes a crystalline substrate, the substrate may include a single crystal, which may include Al₂O₃. Such single crystal substrates are referred to as sapphire. Other suitable materials for a crystalline substrate include polycrystalline alumina layer and/or spinel (MgAl₂O₄).

Optionally, the substrate 110 may be crystalline and include a glass ceramic substrate, which may be strengthened or non-strengthened. Examples of suitable glass ceramics may include Li₂O—Al₂O₃—SiO₂ system (i.e. LAS-System) glass ceramics, MgO—Al₂O₃—SiO₂ system (i.e. MAS-System) glass ceramics, and/or glass ceramics that include a predominant crystal phase including β-quartz solid solution, β-spodumene ss, cordierite, and lithium disilicate. The glass ceramic substrates may be strengthened using the chemical strengthening processes disclosed herein. In one or more embodiments, MAS-System glass ceramic substrates may be strengthened in Li₂SO₄ molten salt, whereby an exchange of 2Li⁺ for Mg²⁺ can occur.

The substrate 110 according to one or more embodiments can have a physical thickness ranging from about 100 μm to about 5 mm in various portions of the substrate 110. Example substrate 110 physical thicknesses range from about 100 μm to about 500 μm (e.g., 100, 200, 300, 400 or 500 μm). Further example substrate 110 physical thicknesses range from about 500 μm to about 1000 μm (e.g., 500, 600, 700, 800, 900 or 1000 μm). The substrate 110 may have a physical thickness greater than about 1 mm (e.g., about 2, 3, 4, or 5 mm). In one or more specific embodiments, the substrate 110 may have a physical thickness of 2 mm or less, 1.5 mm or less, 1.0 mm or less, or less than 0.6 mm. The substrate 110 may be acid polished or otherwise treated to remove or reduce the effect of surface flaws.

As noted earlier, embodiments of the coated articles 100 (see FIGS. 1-8) of the disclosure include an optical coating 120 with low reflectance and controlled color. The optical coating 120 in these articles 100 can be optimized to give desirable combinations of hardness, reflectance, color, and color shift over a range of viewing angles. These desirable combinations are maintained when the coating 120 is at its original design thickness, and when all the layers in the coating are thinned by a scale factor that corresponds to the coating thinning that can occur during a variety of vacuum deposition techniques due to line-of-sight effects in the coating process, such as reactive sputtering, thermal evaporation, CVD, PECVD, and the like.

According to some embodiments of the transparent articles of the disclosure, advantageous article-level failure stress levels can be achieved through the control of the composition, arrangement and/or processing of the optical film structures employed in the transparent articles. Notably, the composition, arrangement and/or processing of the optical film structures can be adjusted to obtain residual compressive stress levels of at least 700 MPa (e.g., from 700 to 1100 MPa) and an elastic modulus of at least 140 GPa (e.g., from 140 to 170 GPa, or from 140 to 180 GPa). These optical film structure mechanical properties unexpectedly correlate to average failure stress levels of 700 MPa or greater in the transparent articles employing these optical film structures, as measured in an ROR test with the outer surface of the optical film structure of the article placed in tension.

With further regard to the residual compressive stress and elastic modulus levels (along with hardness levels) of the optical coating 120, these properties can be controlled through adjustments to the stoichiometry and/or thicknesses of the low RI layers 130A, high RI layers 130B, and scratch resistant layer 150. In embodiments, the residual compressive stress and elastic modulus levels (and hardness levels) exhibited by the optical coating 120 can be controlled through adjustments to the processing conditions for sputtering the layers of the structure 120, particularly its high RI layers 130B and scratch resistant layer 150. In some implementations, for example, a reactive sputtering process can be employed to deposit high RI layers 130B comprising a silicon-containing nitride or a silicon-containing oxynitride. Further, these high RI layers 130B can be deposited by applying power to a silicon sputter target in a reactive gaseous environment containing argon gas (e.g., at flow rates from 50 to 150 sccm), nitrogen gas (e.g., at flow rates from 200 to 250 sccm) and oxygen gas, with residual compressive stress and elastic modulus levels largely dictated by the selected oxygen gas flow rate. For example, a relatively low oxygen gas flow rate (e.g., 45 sccm) can be employed according to the foregoing argon and nitrogen gas flow conditions to produce high RI layers 130B with a SiOₓN_{y} stoichiometry such that its optical coating 120 exhibits a residual compressive stress of about 942 MPa, hardness of 17.8 GPa and an elastic modulus of 162.6 GPa. As another example, a relatively high oxygen gas flow rate (e.g., 65 sccm) can be employed according to the foregoing argon and nitrogen gas flow conditions to produce high RI layers 130B with a SiOₓN_{y} stoichiometry such that the optical coating 120 exhibits a residual compressive stress of about 913 MPa, hardness of 16.4 GPa and an elastic modulus of 148.4 GPa. Accordingly, the stoichiometry of the optical coating 120, particularly its high RI layers 130B and scratch resistant layer 150, can be controlled to achieve targeted residual compressive stress and elastic modulus levels, which unexpectedly correlate to the advantageously high average failure stress levels in the transparent articles 100 (e.g., greater than or equal to 700 MPa).

According to some implementations, the coated articles may exhibit a first-surface (i.e., through one of the primary surfaces of the substrate 110, reflected color with a D65 illuminant, as given by √(a*²+b*²), of less than 10, less than 8, less than 6, less than 4, less than 3, or even less than 2, as measured at normal incidence, from 0 to 10 degrees, or over all incidence angles from 0 to 90 degrees. For example, the transparent articles 100 can exhibit a reflected color of less than 10, 9, 8, 7, 6, 5, 4, 3.75, 3.5, 3.25, 3, 2.75, 2.5, 2.25, 2, 1.9, 1.8, 1.7, 1.6, 1.5, 1.4, 1.3, 1.2, 1.1, 1, or even lower, as measured at normal incidence, from 0 to 10 degrees, or over all incidence angles from 0 to 90 degrees.

The coated articles disclosed may be employed for protection and/or covers of displays, camera lenses, sensors and/or light source components within or otherwise part of electronic devices, along with protection of other components (e.g., buttons, speakers, microphones, etc.). These transparent articles with a protective function employ an optical coating disposed on a glass-ceramic substrate such that the article exhibits a combination of high hardness, high damage resistance and desirable optical properties, including high photopic transmittance and low transmitted color. The optical coating can include a scratch-resistant layer, at any of various locations within the structure. Further, the optical coatings of these articles can include a plurality of alternating high and low refractive index layers, with each high index layer and a scratch resistant layer comprising nitride or an oxynitride and each low index layer comprising an oxide.

With regard to mechanical properties, the transparent articles of the disclosure can exhibit a maximum hardness of 10 GPa or greater or 12 GPa or greater (or even greater than 14 GPa in some instances), as measured by a Berkovich Hardness Test over an indentation depth range from 100 nm to about 500 nm in the optical coating. The glass-ceramic substrates employed in these articles can have an elastic modulus of greater than 85 GPa, or greater than 95 GPa in some instances. These substrates also can exhibit a fracture toughness of greater than 0.8 MPa·√m, or greater than 1 MPa·√m in some instances.

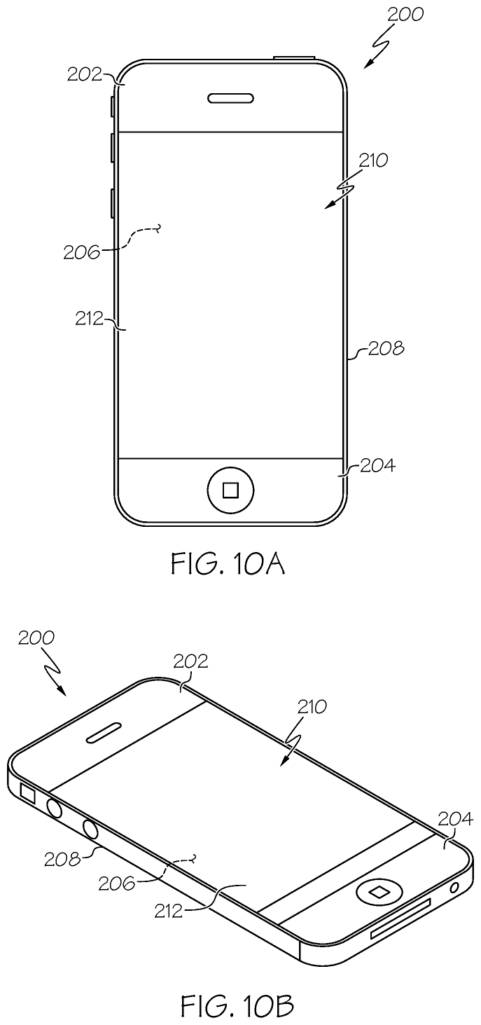

The coated articles disclosed herein may be incorporated into another article such as an article with a display (or display articles) (e.g., consumer electronics, including mobile phones, tablets, computers, navigation systems, and the like), architectural articles, transportation articles (e.g., automotive, trains, aircraft, sea craft, etc.), appliance articles, or any article that requires some transparency, scratch-resistance, abrasion resistance or a combination thereof. An exemplary article incorporating any of the coated articles disclosed herein is shown in FIGS. 10A and 10B. Specifically, FIGS. 10A and 10B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display. In some embodiments, at least one of the cover substrate 212 or a portion of housing 202 may include any of the coated articles disclosed herein.

### EXAMPLES

Various embodiments will be further clarified by the following examples. The optical properties (e.g., photopic reflectance and transmittance) of the examples were modeled using a computation. The computation was carried out using the thin-film design program “Essential Macleod” available from Thin Film Center, Inc. of Tucson Ariz. The spectral transmittance was computed on a 1 nm interval for a selected wavelength range. Transmittance at each wavelength of a given coated article was calculated based on inputted layer thicknesses and refractive indices of each layer. Refractive index values for materials of the coatings were experimentally derived or found in available literature. To experimentally determine the refractive index of a material, dispersion curves for the materials of the coating materials were prepared. Layers of each coating material were formed onto silicon wafers by DC, RF or RF superimposed DC reactive sputtering from a silicon or an aluminum target at a temperature of about 50° C. using ion assist. The wafer was heated to 200° C. during deposition of some layers and targets having a 3 inch diameter were used. Reactive gases used included nitrogen and oxygen; argon was used as the inert gas. The RF power was supplied to the silicon target at 13.56 Mhz and DC power was supplied to the Si target, Al target and other targets.

The refractive indices (as a function of wavelength) of each of the formed layers and the glass substrate were measured using spectroscopic ellipsometry. The refractive indices thus measured were then used to calculate reflectance spectra for the examples. The examples use a single refractive index value in their descriptive tables for convenience, which corresponds to a point selected from the dispersion curves at about 550 nm wavelength.

Comparative examples are supplied as a comparison to the performance of the coatings, and these comparative examples may have inferior optical performance when deposited on a non-planar substrate.

### Comparative Example A

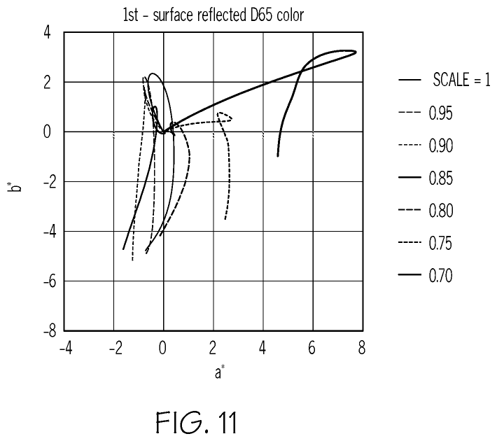

A planar glass substrate was coated with the comparative coating of Table 1 below, designated Comp. Ex. A. Optical properties of the Comp. Ex. 1 are shown in Table 2 and FIG. 11. In particular, Table 2 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 11 is a plot of first-surface reflected color with a D65 illuminant for all viewing angles from 0 to 90 degrees at seven optical coating thickness scaling factor values, 1, 0.95, 0.9, 0.85, 0.80, 0.75 and 0.7, each of which corresponds to part surface angles of approximately 0 degrees, about 25 degrees, about 35 degrees, about 43 degrees, about 50 degrees, about 55 degrees and about 60 degrees, respectively (see FIG. 9).

TABLE 1
Comparative Ex. A, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 20 | 1.476 |
| 2 | SiOxNy | 8.14 | 1.943 |
| 3 | SiO2 | 67.12 | 1.476 |
| 4 | SiOxNy | 21.57 | 1.943 |
| 5 | SiO2 | 50.82 | 1.476 |
| 6 | SiOxNy | 39.32 | 1.943 |
| 7 | SiO2 | 26.68 | 1.476 |
| 8 | SiOxNy | 56.09 | 1.943 |
| 9 | SiO2 | 8 | 1.476 |
| 10 | SiOxNy | 1500 | 1.943 |
| 11 | SiO2 | 14.56 | 1.476 |
| 12 | SiNx | 38.39 | 2.014 |
| 13 | SiO2 | 46.3 | 1.476 |
| 14 | SiNx | 25.19 | 2.014 |
| 15 | SiO2 | 81.14 | 1.476 |
| 16 | SiNx | 24.93 | 2.014 |
| 17 | SiO2 | 44.65 | 1.476 |
| 18 | SiNx | 152.62 | 2.014 |
| 19 | SiO2 | 102.28 | 1.476 |
| N/A | Air | N/A | 1 |

TABLE 2
Comparative Ex. A, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 0.98 | 0.80 | 0.61 | 0.65 | 1.60 | 6.80 | 16.23 | 18.43 |
| 30 degree AOI | 0.92 | 0.83 | 0.77 | 0.93 | 2.49 | 8.90 | 17.59 | 17.43 |
| 45 degree AOI | 1.49 | 1.50 | 1.53 | 1.86 | 4.49 | 12.11 | 19.29 | 17.08 |
| 60 degree AOI | 4.85 | 4.95 | 5.02 | 5.76 | 10.14 | 18.39 | 23.01 | 19.81 |

As is evident from Table 2 and FIG. 11, the comparative example (Comp. Ex. A) has a low reflectance at 5 degree incidence and full 100% thickness. However, over the range of coating thickness scale factors from 0.6-1.0, from 0.5-1.0, from 0.4-1.0, and from 0.3-1.0, Comp. Ex. A exhibits generally higher and non-preferred levels of variation in reflectance. In particular, Comp. Ex. A is characterized by: greater than 0.9% max-min change in absolute % R(Y) and a max/min ratio of greater than 2.0 at 5 degrees AOI; greater than 1.5% max-min change in absolute % R(Y) and a max/min ratio of greater than 3.0 at 30 degrees AOI; greater than 2.5% max-min change in absolute % R(Y) and a max/min ratio of greater than 3.0 at 45 degrees AOI; and greater than 5.0% max-min change in absolute % R(Y) and a max/min ratio of greater than 2.0 at 60 deg. AOI for thickness scaling factors of 0.6 or less. Further, the range of color (considering all viewing angles from 0 to 90 degrees) rises well above values of a*=5 for thickness scaling factors of 0.7 or less, corresponding to part surface angles of about 60 degrees or more (for example processes where coating thickness follows a sqrt(cosine) dependence on part surface angle).

### Example 1

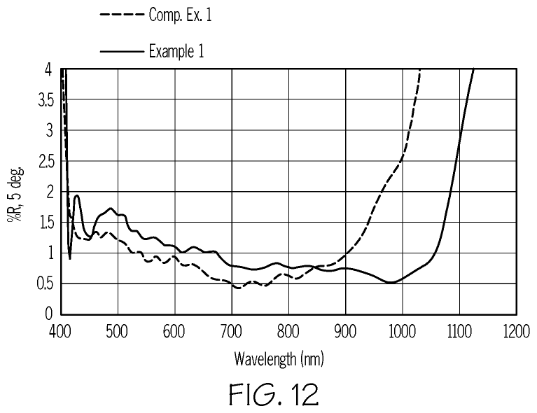

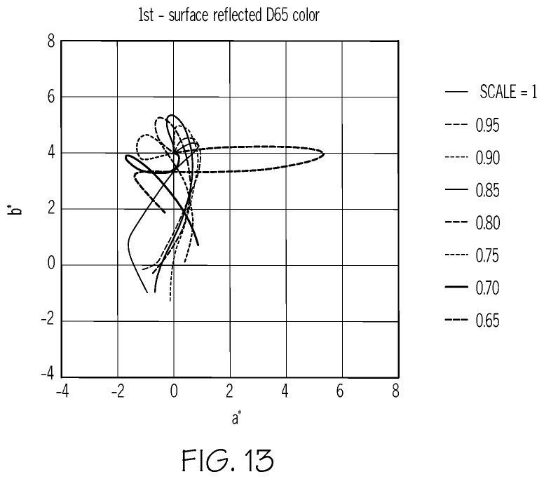

A glass substrate was coated with the exemplary coating of Table 3 below, designated Ex. 1, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. In Ex. 1, the glass substrate had a borosilicate composition (e.g., 75 mol % SiO₂, 10 mol % B₂O₃, 8.6 mol % Na₂O, 5.6 mol % K₂O, and 0.7 mol % BaO). The antireflective layers (layers above the thick scratch resistant layer, layers 13-32) of Ex. 1 coated article comprises 54.9% SiNₓ by volume %. Optical properties of the Ex. 1 coated article are shown in Table 4 and FIGS. 12-13. In particular, Table 4 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 12 is a plot of first-surface photopic reflectance v. wavelength at a near-normal light incidence angle (5 degrees) for Comp. Ex. A and Ex. 1 at an optical coating thickness scaling factor values of 1. Further, FIG. 13 is a plot of first-surface reflected color with a D65 illuminant for all viewing angles from 0 to 90 degrees at eight optical coating thickness scaling factor values, 1, 0.95, 0.9, 0.85, 0.80, 0.75, 0.7, and 0.65, each of which corresponds to part surface angles of 0 degrees, about 25 degrees, about 35 degrees, about 43 degrees, about 50 degrees, about 55 degrees, about 60 degrees, and XX degrees respectively (see FIG. 9).

TABLE 3
Ex. 1, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 29.3 | 1.465 |
| 2 | SiOxNy | 7.05 | 1.943 |
| 3 | SiO2 | 77.3 | 1.465 |
| 4 | SiOxNy | 14.65 | 1.943 |
| 5 | SiO2 | 69.7 | 1.465 |
| 6 | SiOxNy | 27.74 | 1.943 |
| 7 | SiO2 | 45.9 | 1.465 |
| 8 | SiOxNy | 44.96 | 1.943 |
| 9 | SiO2 | 22.1 | 1.465 |
| 10 | SiOxNy | 60.1 | 1.943 |
| 11 | SiO2 | 6 | 1.465 |
| 12 | SiOxNy | 1800 | 1.943 |
| 13 | SiNx | 33.51 | 2.042 |
| 14 | SiO2 | 12.29 | 1.465 |
| 15 | SiNx | 66.97 | 2.042 |
| 16 | SiO2 | 22.6 | 1.465 |
| 17 | SiNx | 58.4 | 2.042 |
| 18 | SiO2 | 38.82 | 1.465 |
| 19 | SiNx | 51.33 | 2.042 |
| 20 | SiO2 | 40.82 | 1.465 |
| 21 | SiNx | 62.31 | 2.042 |
| 22 | SiO2 | 32.55 | 1.465 |
| 23 | SiNx | 58.17 | 2.042 |
| 24 | SiO2 | 54.29 | 1.465 |
| 25 | SiNx | 33.07 | 2.042 |
| 26 | SiO2 | 76.43 | 1.465 |
| 27 | SiNx | 36 | 2.042 |
| 28 | SiO2 | 1.465 | 36.47 |
| 29 | SiNx | 2.042 | 94.05 |
| 30 | SiO2 | 1.465 | 13.34 |
| 31 | SiNx | 2.042 | 44.27 |
| 32 | SiO2 | 1.465 | 114.13 |
| N/A | Air | N/A | 1 |

TABLE 4
Ex. 1, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 1.29 | 1.10 | 0.92 | 0.81 | 0.77 | 3.54 | 13.97 | 12.97 |
| 30 degree AOI | 1.20 | 1.08 | 1.00 | 0.98 | 1.05 | 5.60 | 15.26 | 12.63 |
| 45 degree AOI | 1.70 | 1.69 | 1.73 | 1.72 | 2.18 | 8.99 | 16.79 | 13.16 |
| 60 degree AOI | 4.95 | 5.11 | 5.24 | 5.15 | 6.66 | 15.69 | 20.31 | 16.62 |

As is evident from Table 4 and FIG. 12, the exemplary coated article of this example (Ex. 1) has a single-surface photopic average reflectance of less than 200 at 100% coating thickness, as well as for all coating thickness scaling factors from 60% to 100%. The single-surface photopic average reflectance remains in a narrow range for coating thickness scaling factors from 0.6 to 1.0, where 1.0 represent the full 100% design thickness. Over this entire range of thickness scaling from 0.6 to 1.0, the single-surface photopic average reflectance remains from 0.75 to 1.3 at 5 deg AOI, from 0.9 to 1.2 at 30 deg. AOI, from 1.6 to 2.2 at 45 deg. AOI, and from 4.9 to 6.7 at 60 deg. AOI.

Ex. 1 also demonstrates an average reflectance of less than 3% for all thickness scaling factors from 60% to 100% at all incident light (viewing) angles from 0 (normal) to 45 degrees. Ex. 1 also demonstrates a first-surface reflectance of less than 3% for all wavelengths from 410 nm to 1100 nm (i.e., a maximum reflectance in this wavelength range) at 5 degrees incidence at a thickness scaling factor of 1. On the contrary, Comp. Ex. A demonstrates a first-surface reflectance of less than 3% for all wavelengths from 410 nm to 1010 nm.

As is also evident from FIG. 13, the coated article of this example (Ex. 1) further demonstrates a first-surface reflected color at normal incidence that has b*<2.5 or even <2 for all thickness scaling factors from 65% to 100% for all viewing angles from 0 to 90 degrees.

### Example 2

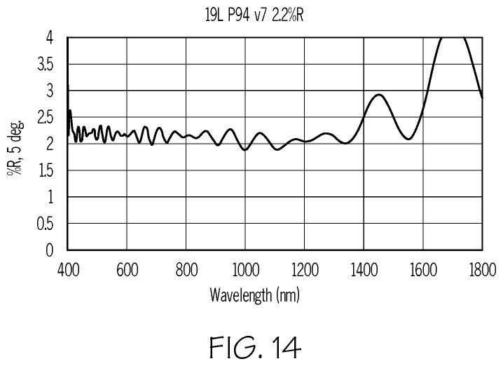

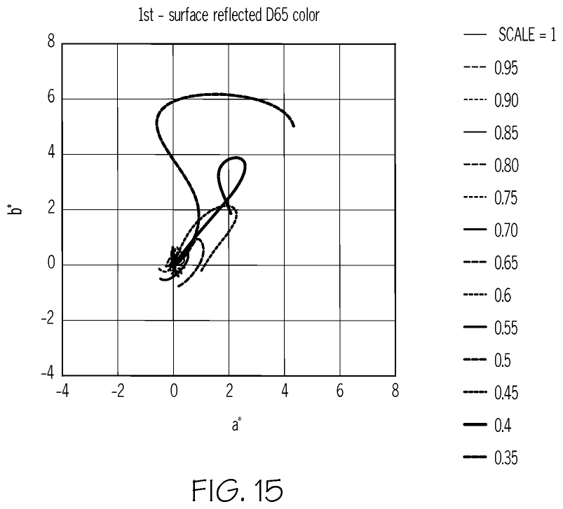

A glass substrate was coated with the exemplary coating of Table 5 below, designated Ex. 2, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 2 coated article comprises 32.9% SiNₓ by volume %. Optical properties of the Ex. 2 coated article are shown in Table 6 and FIGS. 14-15. In particular, Table 6 shows the first-surface photopic photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 14 is a plot of first-surface photopic photopic reflectance v. wavelength at a near-normal light incidence angle (5 degrees) for Ex. 2 at an optical coating thickness scaling factor value of 1. Further, FIG. 15 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 5
Ex. 2, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 25 | 1.465 |
| 2 | SiOxNy | 10 | 1.943 |
| 3 | SiO2 | 69.2 | 1.465 |
| 4 | SiOxNy | 21.4 | 1.943 |
| 5 | SiO2 | 57.9 | 1.465 |
| 6 | SiOxNy | 35.5 | 1.943 |
| 7 | SiO2 | 38.3 | 1.465 |
| 8 | SiOxNy | 50.5 | 1.943 |
| 9 | SiO2 | 19.6 | 1.465 |
| 10 | SiOxNy | 62.6 | 1.943 |
| 11 | SiO2 | 6.4 | 1.465 |
| 12 | SiOxNy | 2050 | 1.943 |
| 13 | SiO2 | 8 | 1.465 |
| 14 | SiNx | 42.5 | 2.042 |
| 15 | SiO2 | 25.75 | 1.465 |
| 16 | SiNx | 40.5 | 2.042 |
| 17 | SiO2 | 47.2 | 1.465 |
| 18 | SiNx | 22.1 | 2.042 |
| 19 | SiO2 | 133.0 | 1.465 |
| N/A | Air | N/A | 1 |

TABLE 6
Ex. 2, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.19 | 2.19 | 2.19 | 2.20 | 2.20 | 2.17 | 2.45 | 3.86 |
| 30 degree AOI | 2.26 | 2.28 | 2.29 | 2.31 | 2.31 | 2.35 | 2.82 | 4.51 |
| 45 degree AOI | 2.96 | 2.99 | 3.01 | 3.05 | 3.09 | 3.24 | 3.97 | 6.01 |
| 60 degree AOI | 6.45 | 6.49 | 6.58 | 6.71 | 6.85 | 7.17 | 8.22 | 10.50 |

As is evident from Table 6 and FIG. 14, the exemplary coated article of this example (Ex. 2) has a single-surface photopic average reflectance of less than 300 at coating thickness scaling factors from 400% to 1000% at all incident light (viewing) angles from 5 degrees to 30 degrees. The single-surface photopic average reflectance remains in a narrow range for coating thickness scaling factors from 0.4 to 1.0, where 1.0 represent the full 100% design thickness. Over this entire range of thickness scaling from 0.4 to 1.0, the single-surface photopic average reflectance remains from 2.1 to 2.5 at 5 degrees AOI, from 2.2 to 2.9 at 30 degrees AOI, from 2.9 to 4.0 at 45 degrees AOI, and from 6.4 to 8.3 at 60 degrees AOI.

Ex. 2 also demonstrates a first-surface reflectance of less than 3% for all wavelengths from 410 nm to 1610 nm (i.e., a maximum reflectance in this wavelength range) at 5 degrees incidence at a thickness scaling factor of 1.

As is also evident from FIG. 15, the coated article of this example (Ex. 2) demonstrates a reflected color b*<10, <5, or even <2 for thickness scaling factors from 50% to 100% for all viewing angles from 0 to 90 degrees. Further, Ex. 2 demonstrates a reflected color a*<2 or even <1.5 for thickness scaling factors from 50% to 100% for all viewing angles from 0 to 90 degrees. Further, Ex. 2 demonstrates a reflected color b*, where −2<b*<2 for thickness scaling factors from 50% to 100% for all viewing angles from 0 to 90 degrees. Further, Ex. 5A demonstrates a reflected color a*, where −2<a*<2 for thickness scaling factors from 50% to 100% for all viewing angles from 0 to 90 degrees.

### Example 3

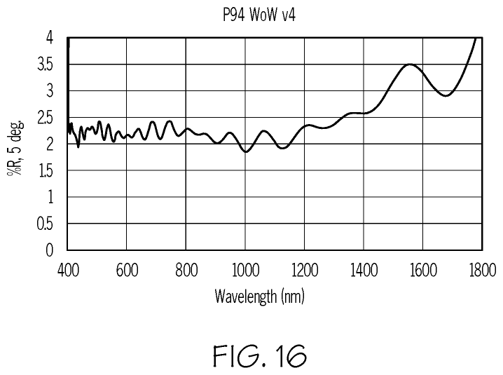

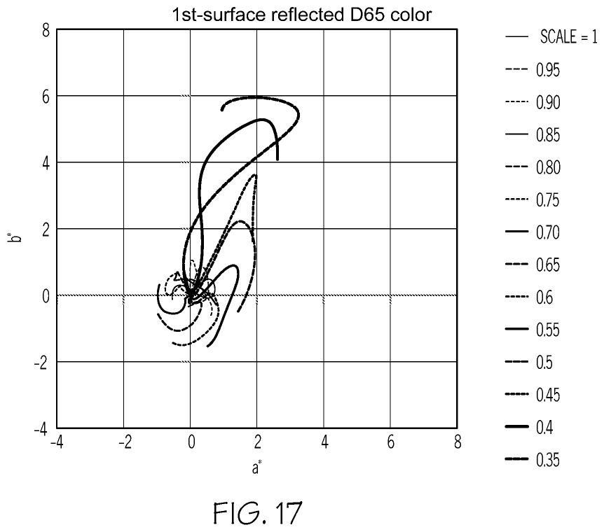

A glass substrate was coated with the exemplary coating of Table 7 below, designated Ex. 3, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 3 coated article comprises 24.0% SiNₓ by volume %. Optical properties of the Ex. 3 coated article are shown in Table 8 and FIGS. 16-17. In particular, Table 8 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 16 is a plot of first-surface photopic reflectance v. wavelength at a near-normal light incidence angle (5 degrees) for Ex. 3 at an optical coating thickness scaling factor value of 1. Further, FIG. 17 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 7
Ex. 3, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 20 | 1.476 |
| 2 | SiOxNy | 11.5 | 1.829 |
| 3 | SiO2 | 69.1 | 1.476 |
| 4 | SiOxNy | 25.2 | 1.829 |
| 5 | SiO2 | 58.96 | 1.476 |
| 6 | SiOxNy | 40.6 | 1.829 |
| 7 | SiO2 | 39.78 | 1.476 |
| 8 | SiOxNy | 56.56 | 1.829 |
| 9 | SiO2 | 20.82 | 1.476 |
| 10 | SiOxNy | 69.27 | 1.829 |
| 11 | SiO2 | 6.8 | 1.476 |
| 12 | SiOxNy | 1960 | 1.829 |
| 13 | SiNx | 12.98 | 2.042 |
| 14 | SiO2 | 27.24 | 1.465 |
| 15 | SiNx | 33.01 | 2.042 |
| 16 | SiO2 | 50.09 | 1.465 |
| 17 | SiNx | 20.62 | 2.042 |
| 18 | SiO2 | 133.99 | 1.465 |
| N/A | Air | N/A | 1 |

TABLE 8
Ex. 3, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.19 | 2.20 | 2.26 | 2.28 | 2.18 | 2.19 | 2.75 | 4.31 |
| 30 degree AOI | 2.28 | 2.32 | 2.37 | 2.35 | 2.27 | 2.42 | 3.20 | 4.81 |
| 45 degree AOI | 2.99 | 3.05 | 3.10 | 3.07 | 3.07 | 3.40 | 4.39 | 5.98 |
| 60 degree AOI | 6.49 | 6.63 | 6.73 | 6.74 | 6.85 | 7.39 | 8.57 | 10.19 |

As is evident from Table 8 and FIG. 16, the exemplary coated article of this example (Ex. 3) has a single-surface photopic average reflectance of less than 3% at coating thickness scaling factors from 50% to 100% at all incident light (viewing) angles from 5 degrees to 30 degrees. The single-surface photopic average reflectance remains in a narrow range for coating thickness scaling factors from 0.4 to 1.0, where 1.0 represent the full 100% design thickness. Over this entire range of thickness scaling from 0.4 to 1.0, the single-surface photopic average reflectance remains from 2.1 to 2.8 at 5 deg. AOI, from 2.2 to 3.2 at 30 deg. AOI, from 2.9 to 4.4 at 45 deg. AOI, and from 6.4 to 8.6 at 60 deg. AOI.

Ex. 3 also demonstrates a first-surface reflectance of less than 3% for all wavelengths from 410 nm to 1480 nm (i.e., a maximum reflectance in this wavelength range) at 5 degrees incidence at a thickness scaling factor of 1.

As is also evident from FIG. 17, the coated article of this example (Ex. 3) demonstrates a reflected color b*<10, <5, or even <2.5 for thickness scaling factors from 50% to 100% for all viewing angles from 0 to 90 degrees. Further, Ex. 2 demonstrates a reflected color a*< for thickness scaling factors from 50% to 100% for all viewing angles from 0 to 90 degrees.

### Example 4

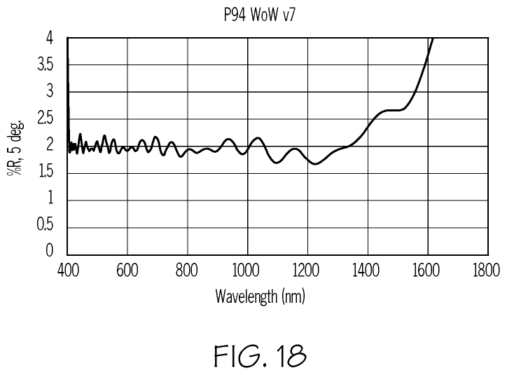

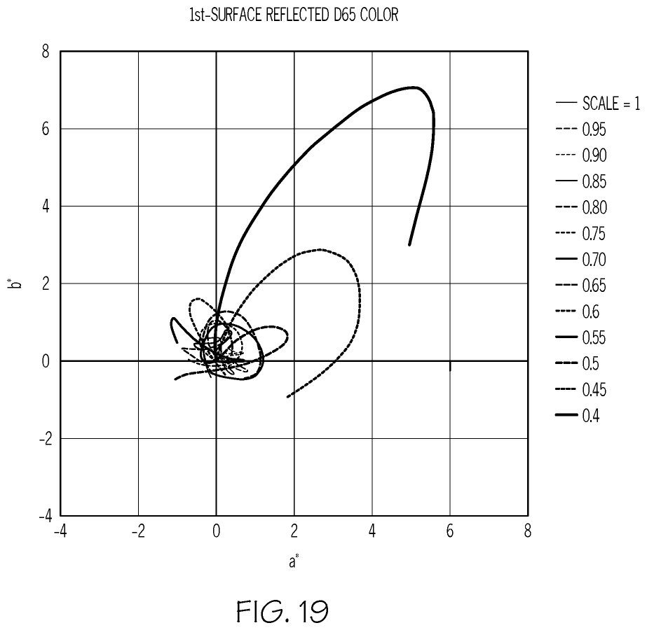

A glass substrate was coated with the exemplary coating of Table 9 below, designated Ex. 4, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 4 coated article comprises 52.5% SiNₓ by volume %. Optical properties of the Ex. 4 coated article are shown in Table 10 and FIGS. 18-19. In particular, Table 10 shows the first-surface photopic photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 18 is a plot of first-surface photopic reflectance v. wavelength at a near-normal light incidence angle (5 degrees) for Ex. 4 at an optical coating thickness scaling factor value of 1. Further, FIG. 19 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, and 0.40.

TABLE 9
Ex. 4, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 20 | 1.476 |
| 2 | SiOxNy | 11.5 | 1.829 |
| 3 | SiO2 | 69.1 | 1.476 |
| 4 | SiOxNy | 25.21 | 1.829 |
| 5 | SiO2 | 58.96 | 1.476 |
| 6 | SiOxNy | 40.59 | 1.829 |
| 7 | SiO2 | 39.78 | 1.476 |
| 8 | SiOxNy | 56.56 | 1.829 |
| 9 | SiO2 | 20.82 | 1.476 |
| 10 | SiOxNy | 69.27 | 1.829 |
| 11 | SiO2 | 6.8 | 1.476 |
| 12 | SiOxNy | 1960 | 1.829 |
| 13 | SiNx | 22.93 | 2.042 |
| 14 | SiO2 | 20.14 | 1.476 |
| 15 | SiNx | 55.16 | 2.042 |
| 16 | SiO2 | 16.55 | 1.476 |
| 17 | SiNx | 76.53 | 2.042 |
| 18 | SiO2 | 16.64 | 1.476 |
| 19 | SiNx | 60.93 | 2.042 |
| 20 | SiO2 | 37.82 | 1.476 |
| 21 | SiNx | 29.77 | 2.042 |
| 22 | SiO2 | 130.89 | 1.476 |
| N/A | Air | N/A | 1 |

TABLE 10
Ex. 4, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 1.98 | 1.98 | 1.98 | 1.95 | 2.00 | 1.96 | 2.33 | 5.34 |
| 30 degree AOI | 2.03 | 2.06 | 2.06 | 2.05 | 2.16 | 2.15 | 2.84 | 6.25 |
| 45 degree AOI | 2.71 | 2.76 | 2.76 | 2.83 | 3.00 | 3.05 | 4.21 | 8.00 |
| 60 degree AOI | 6.19 | 6.26 | 6.37 | 6.58 | 6.74 | 6.97 | 8.86 | 12.74 |

As is evident from Table 10 and FIG. 18, the exemplary coated article of this example (Ex. 4) has a single-surface photopic average reflectance of less than 3% at coating thickness scaling factors from 40% to 100% at all incident light (viewing) angles from 5 degrees to 30 degrees. The single-surface photopic average reflectance remains in a narrow range for coating thickness scaling factors from 0.4 to 1.0, where 1.0 represent the full 100% design thickness. Over this entire range of thickness scaling from 0.4 to 1.0, the single-surface photopic average reflectance remains from 1.9 to 2.4 at 5 deg. AOI, from 2.0 to 2.9 at 30 deg. AOI, from 2.7 to 4.2 at 45 deg. AOI, and from 6.1 to 8.9 at 60 deg. AOI.

Ex. 4 also demonstrates a first-surface reflectance of less than 3% for all wavelengths from 410 nm to 1555 nm (i.e., a maximum reflectance in this wavelength range) at 5 degrees incidence at a thickness scaling factor of 1.

As is also evident from FIG. 19, the coated article of this example (Ex. 4) demonstrates a reflected color b*, where −2<b*<2 for thickness scaling factors from 50% to 100% for all viewing angles from 0 to 90 degrees. Further, Ex. 4 demonstrates a reflected color a*, where −2<a*<2 for thickness scaling factors from 50% to 100% for all viewing angles from 0 to 90 degrees.

### Example 5

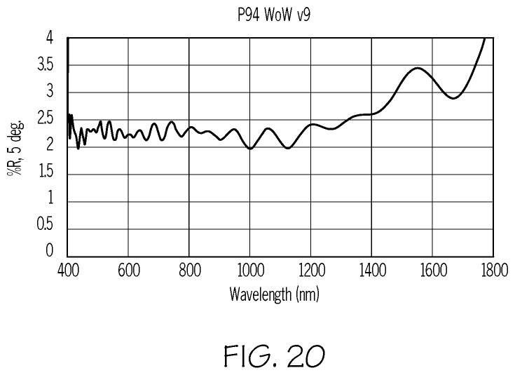

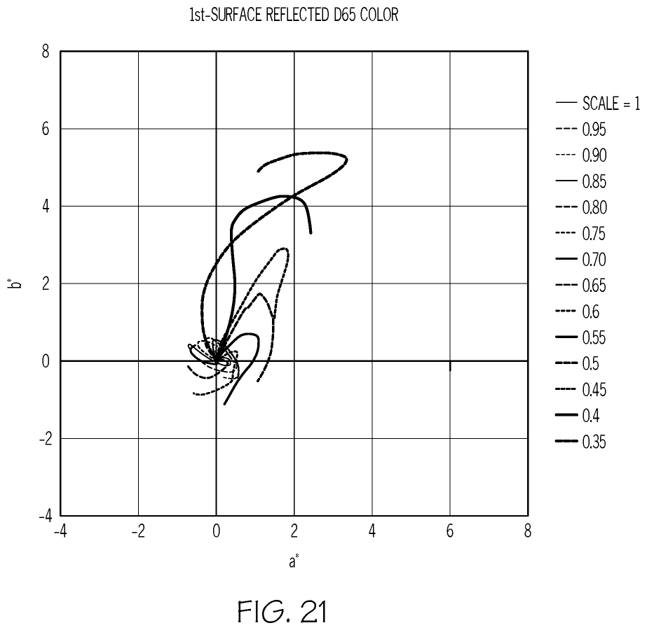

A glass substrate was coated with the exemplary coating of Table 11 below, designated Ex. 5, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 5 coated article comprises 35.0% SiOₓN_{y} by volume %. Optical properties of the Ex. 5 coated article are shown in Table 12 and FIGS. 20-21. In particular, Table 12 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 20 is a plot of first-surface photopic reflectance v. wavelength at a near-normal light incidence angle (5 degrees) for Ex. 5 at an optical coating thickness scaling factor value of 1. Further, FIG. 21 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 11
Ex. 5, Coated Glass Article

| | | Layer | Refractive |
|---|---|---|---|
| | | thickness | index @ |
| Layer | Material | (nm) | 550 nm |
| substrate | Glass | | 1.51 |
| 1 | SiO2 | 20 | 1.476 |
| 2 | SiOxNy | 11.5 | 1.829 |
| 3 | SiO2 | 69.1 | 1.476 |
| 4 | SiOxNy | 25.21 | 1.829 |
| 5 | SiO2 | 58.96 | 1.476 |
| 6 | SiOxNy | 40.59 | 1.829 |
| 7 | SiO2 | 39.78 | 1.476 |
| 8 | SiOxNy | 56.56 | 1.829 |
| 9 | SiO2 | 20.82 | 1.476 |
| 10 | SiOxNy | 69.27 | 1.829 |
| 11 | SiO2 | 6.8 | 1.476 |
| 12 | SiOxNy | 1960 | 1.829 |
| 13 | SiO2 | 9.34 | 1.465 |
| 14 | SiOxNy | 58.47 | 1.829 |
| 15 | SiO2 | 33.71 | 1.465 |
| 16 | SiOxNy | 32.05 | 1.829 |
| 17 | SiO2 | 125.16 | 1.465 |
| N/A | Air | N/A | 1 |

TABLE 12
Ex. 5, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.27 | 2.27 | 2.31 | 2.35 | 2.30 | 2.30 | 2.77 | 4.21 |
| 30 degree AOI | 2.36 | 2.38 | 2.44 | 2.46 | 2.42 | 2.52 | 3.17 | 4.64 |
| 45 degree AOI | 3.07 | 3.12 | 3.19 | 3.21 | 3.21 | 3.45 | 4.30 | 5.78 |
| 60 degree AOI | 6.59 | 6.69 | 6.78 | 6.81 | 6.91 | 7.39 | 8.49 | 10.09 |

As is evident from Table 12 and FIG. 20, the exemplary coated article of this example (Ex. 5) has a single-surface photopic average reflectance of less than 3% at coating thickness scaling factors from 50% to 100% at all incident light (viewing) angles from 5 degrees to 30 degrees. The single-surface photopic average reflectance remains in a narrow range for coating thickness scaling factors from 0.4 to 1.0, where 1.0 represent the full 100% design thickness. Over this entire range of thickness scaling from 0.4 to 1.0, the single-surface photopic average reflectance remains from 2.2 to 2.8 at 5 deg. AOI, from 2.3 to 3.2 at 30 deg. AOI, from 3.0 to 4.4 at 45 deg. AOI, and from 6.5 to 8.5 at 60 deg. AOI.

Ex. 5 also demonstrates a first-surface reflectance of less than 3% for all wavelengths from 405 nm to 1475 nm (i.e., a maximum reflectance in this wavelength range) at 5 degrees incidence at a thickness scaling factor of 1. Example 5 was designed with a thin antireflective layer stack (259 nm thickness) above the thickest hard layer, which may improve hardness and scratch resistance, while still achieving a wide AR bandwidth.

As is also evident from FIG. 21, the coated article of this example (Ex. 5) demonstrates a reflected color b*, where −2<b*<2 for thickness scaling factors from 50% to 100% for all viewing angles from 0 to 90 degrees. Further, Ex. 5 demonstrates a reflected color a*, where −2<a*<2 for thickness scaling factors from 50% to 100% for all viewing angles from 0 to 90 degrees.

### Example 5A

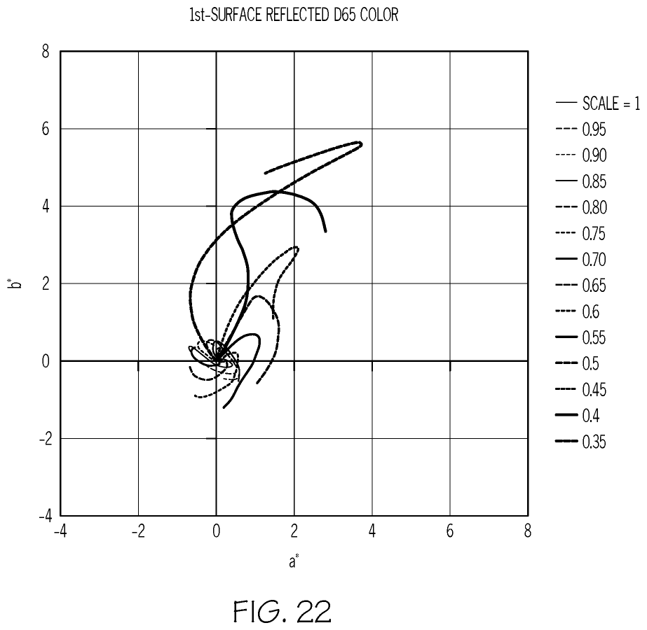

According to this example, a variant of the optical coating of the prior example (Ex. 5) was fabricated with a similar configuration, except that the substrate was changed to chemically strengthened glass-ceramic. Specifically, a glass-ceramic substrate was coated with the exemplary coating of Table 13 below, designated Ex. 5A, according to the principles of the disclosure. The antireflective layers of Ex. 5A coated article comprises 35.0% SiOₓN_{y} by volume %. Optical properties of the Ex. 5A coated article are shown in Table 14 and FIG. 22. In particular, Table 14 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 22 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 13
Ex. 5A, Coated Glass Article

| | | Layer | Refractive |
|---|---|---|---|
| | | thickness | index @ |
| Layer | Material | (nm) | 550 nm |
| | Glass-ceramic | Substrate | 1.533 |
| 1 | SiO2 | 25 | 1.476 |
| 2 | SiOxNy | 13.73 | 1.829 |
| 3 | SiO2 | 65.95 | 1.476 |
| 4 | SiOxNy | 25.35 | 1.829 |
| 5 | SiO2 | 58.89 | 1.476 |
| 6 | SiOxNy | 38.58 | 1.829 |
| 7 | SiO2 | 40.85 | 1.476 |
| 8 | SiOxNy | 53.6 | 1.829 |
| 9 | SiO2 | 22.19 | 1.476 |
| 10 | SiOxNy | 66 | 1.829 |
| 11 | SiO2 | 8 | 1.476 |
| 12 | SiOxNy | 1960 | 1.829 |
| 13 | SiO2 | 9.34 | 1.465 |
| 14 | SiOxNy | 58.47 | 1.829 |
| 15 | SiO2 | 33.71 | 1.465 |
| 16 | SiOxNy | 32.05 | 1.829 |
| 17 | SiO2 | 125.16 | 1.465 |
| N/A | Air | N/A | 1 |

TABLE 14-
Ex. 5A, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.27 | 2.27 | 2.31 | 2.35 | 2.30 | 2.29 | 2.78 | 4.22 |
| 30 degree AOI | 2.36 | 2.38 | 2.44 | 2.46 | 2.42 | 2.52 | 3.17 | 4.62 |
| 45 degree AOI | 3.07 | 3.12 | 3.19 | 3.21 | 3.21 | 3.45 | 4.30 | 5.76 |
| 60 degree AOI | 6.59 | 6.69 | 6.78 | 6.81 | 6.91 | 7.38 | 8.49 | 10.12 |

As is evident from Table 14, the exemplary coated article of this example (Ex. 5A) has a single-surface photopic average reflectance of less than 3% at coating thickness scaling factors from 50% to 100% at all incident light (viewing) angles from 5 degrees to 30 degrees.

As is also evident from FIG. 22, the coated article of this example (Ex. 5A) demonstrates a reflected color b*, where −2<Kb*<2 for thickness scaling factors from 50% to 100% for all viewing angles from 0 to 90 degrees. Further, Ex. 5A demonstrates a reflected color a*, where −2<a*<2 for thickness scaling factors from 50% to 100% for all viewing angles from 0 to 90 degrees.

### Example 6

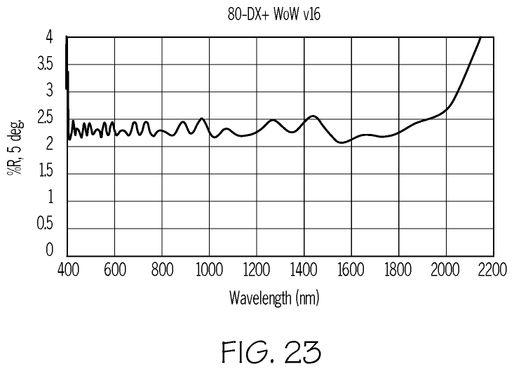

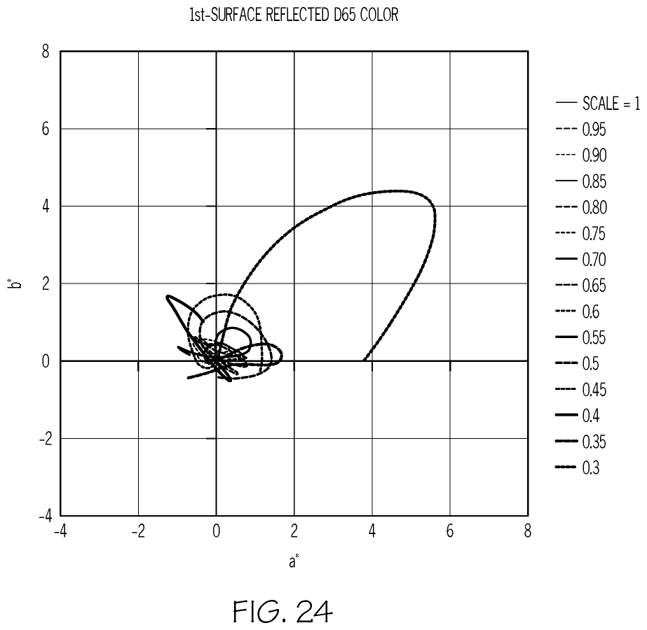

A glass substrate was coated with the exemplary coating of Table 15 below, designated Ex. 6, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 6 coated article comprises 59.5% SiNₓ by volume %. Optical properties of the Ex. 6 coated article are shown in Table 16 and FIGS. 23-24. In particular, Table 16 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 23 is a plot of first-surface photopic reflectance v. wavelength at a near-normal light incidence angle (5 degrees) for Ex. 6 at an optical coating thickness scaling factor value of 1. Further, FIG. 24 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 15
Ex. 6, Coated Glass Article

| | | Layer | Refractive |
|---|---|---|---|
| | | thickness | index @ |
| Layer | Material | (nm) | 550 nm |
| | Glass | Substrate | 1.51 |
| 1 | SiO2 | 20 | 1.476 |
| 2 | SiOxNy | 8.94 | 1.829 |
| 3 | SiO2 | 75.91 | 1.476 |
| 4 | SiOxNy | 18.39 | 1.829 |
| 5 | SiO2 | 76.53 | 1.476 |
| 6 | SiOxNy | 28.52 | 1.829 |
| 7 | SiO2 | 64.29 | 1.476 |
| 8 | SiOxNy | 40.92 | 1.829 |
| 9 | SiO2 | 47.75 | 1.476 |
| 10 | SiOxNy | 54.51 | 1.829 |
| 11 | SiO2 | 30.95 | 1.476 |
| 12 | SiOxNy | 66.96 | 1.829 |
| 13 | SiO2 | 16.5 | 1.476 |
| 14 | SiOxNy | 74.92 | 1.829 |
| 15 | SiO2 | 6 | 1.476 |
| 16 | SiOxNy | 1900 | 1.829 |
| 17 | SiNx | 18.66 | 2.042 |
| 18 | SiO2 | 18.79 | 1.476 |
| 19 | SiNx | 38.88 | 2.042 |
| 20 | SiO2 | 15.82 | 1.476 |
| 21 | SiNx | 42.67 | 2.042 |
| 22 | SiO2 | 12.48 | 1.476 |
| 23 | SiNx | 61.37 | 2.042 |
| 24 | SiO2 | 8.4 | 1.476 |
| 25 | SiNx | 92.2 | 2.042 |
| 26 | SiO2 | 8 | 1.476 |
| 27 | SiNx | 75.76 | 2.042 |
| 28 | SiO2 | 22.57 | 1.476 |
| 29 | SiNx | 49.73 | 2.042 |
| 30 | SiO2 | 48.35 | 1.476 |
| 31 | SiNx | 24.94 | 2.042 |
| 32 | SiO2 | 140.68 | 1.476 |
| N/A | Air | N/A | 1 |

TABLE 16
Ex. 6, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.29 | 2.30 | 2.31 | 2.31 | 2.36 | 2.32 | 2.47 | 2.56 |
| 30 degree AOI | 2.37 | 2.39 | 2.41 | 2.41 | 2.48 | 2.47 | 2.69 | 3.02 |
| 45 degree AOI | 3.08 | 3.11 | 3.14 | 3.18 | 3.25 | 3.33 | 3.62 | 4.33 |
| 60 degree AOI | 6.63 | 6.68 | 6.75 | 6.85 | 6.93 | 7.25 | 7.51 | 8.88 |

As is evident from Table 16 and FIG. 23, the exemplary coated article of this example (Ex. 6) has a single-surface photopic average reflectance of less than 300 at coating thickness scaling factors from 50% to 100% at all incident light (viewing) angles from 5 degrees to 30 degrees. The single-surface photopic average reflectance remains in a narrow range for coating thickness scaling factors from 0.3 to 1.0, where 1.0 represent the full 100% design thickness. Over this entire range of thickness scaling from 0.3 to 1.0, the single-surface photopic average reflectance remains from 2.2 to 2.6 at 5 deg. AOI, from 2.3 to 3.1 at 30 deg. AOI, from 3.0 to 4.4 at 45 deg. AOI, and from 6.6 to 8.9 at 60 deg. AOI.

Ex. 6 also demonstrates a first-surface reflectance of less than 3% for all wavelengths from 405 nm to 2050 nm (i.e., a maximum reflectance in this wavelength range) at 5 degrees incidence at a thickness scaling factor of 1.

As is also evident from FIG. 24, the coated article of this example (Ex. 6) demonstrates a reflected color b*, where −2<b*<2 for thickness scaling factors from 35% to 100% for all viewing angles from 0 to 90 degrees. Further, Ex. 6 demonstrates a reflected color a*, where −2<a*<2 for thickness scaling factors from 35% to 100% for all viewing angles from 0 to 90 degrees.

### Example 6A

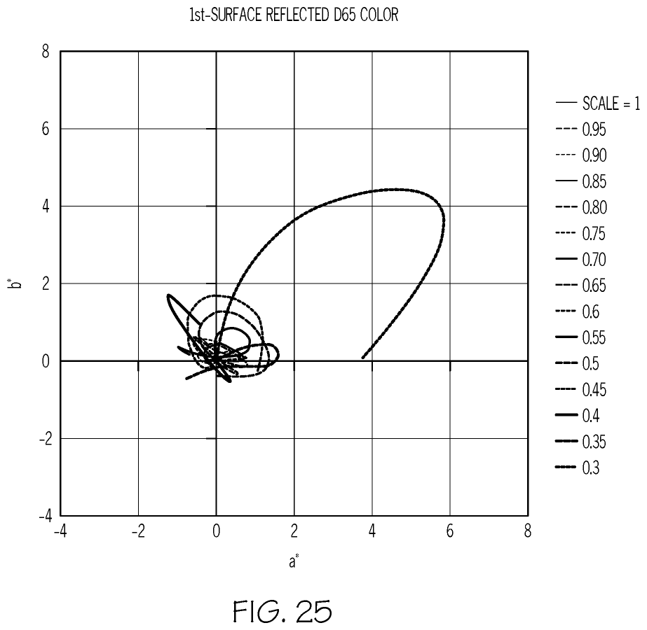

According to this example, a variant of the optical coating of the prior example (Ex. 6) was fabricated with a similar configuration, except that the substrate was changed to chemically strengthened glass-ceramic (Specifically, a glass substrate was coated with the exemplary coating of Table 17 below, designated Ex. 6A, according to the principles of the disclosure. The antireflective layers of Ex. 6 coated article comprises 59.5% SiNₓ by volume %. Optical properties of the Ex. 6S coated article are shown in Table 16 and FIGS. 25. In particular, Table 16 shows the first-surface photopic average reflectance v. coating thickness scaling factor (% R(Y)) at four light incidence angles (5 degrees, 30 degrees, 45 degrees, and 60 degrees) at eight optical coating thickness scaling factor values, 1, 0.9, 0.8, 0.7, 0.6, 0.5, 0.4, and 0.3. FIG. 25 is a plot of first-surface reflected color with a D65 illuminant for all viewing angles from 0 to 90 degrees at fourteen optical coating thickness scaling factor values, 1, 0.95, 0.9, 0.85, 0.80, 0.75, 0.7, 0.65, 0.60, 0.55, 0.50, 0.45, 0.40, and 0.35.

TABLE 17
Ex. 6A, Coated Glass Article

| | | Layer | Refractive |
|---|---|---|---|
| | | thickness | index@ |
| Layer | Material | (nm) | 550 nm |
| | Glass-ceramic | Substrate | 1.533 |
| 1 | SiO2 | 25 | 1.476 |
| 2 | SiOxNy | 12.54 | 1.829 |
| 3 | SiO2 | 71.63 | 1.476 |
| 4 | SiOxNy | 21.03 | 1.829 |
| 5 | SiO2 | 73.87 | 1.476 |
| 6 | SiOxNy | 29.33 | 1.829 |
| 7 | SiO2 | 63.3 | 1.476 |
| 8 | SiOxNy | 40.23 | 1.829 |
| 9 | SiO2 | 48.18 | 1.476 |
| 10 | SiOxNy | 52.74 | 1.829 |
| 11 | SiO2 | 32.29 | 1.476 |
| 12 | SiOxNy | 64.81 | 1.829 |
| 13 | SiO2 | 18.38 | 1.476 |
| 14 | SiOxNy | 72.37 | 1.829 |
| 15 | SiO2 | 8 | 1.476 |
| 16 | SiOxNy | 1900 | 1.829 |
| 17 | SiNx | 18.66 | 2.042 |
| 18 | SiO2 | 18.79 | 1.476 |
| 19 | SiNx | 38.88 | 2.042 |
| 20 | SiO2 | 15.82 | 1.476 |
| 21 | SiNx | 42.67 | 2.042 |
| 22 | SiO2 | 12.48 | 1.476 |
| 23 | SiNx | 61.37 | 2.042 |
| 24 | SiO2 | 8.4 | 1.476 |
| 25 | SiNx | 92.2 | 2.042 |
| 26 | SiO2 | 8 | 1.476 |
| 27 | SiNx | 75.76 | 2.042 |
| 28 | SiO2 | 22.57 | 1.476 |
| 29 | SiNx | 49.73 | 2.042 |
| 30 | SiO2 | 48.35 | 1.476 |
| 31 | SiNx | 24.94 | 2.042 |
| 32 | SiO2 | 140.68 | 1.476 |
| N/A | Air | N/A | 1 |

TABLE 18-
Ex. 6A, First Surface Photopic Average % Reflectance (Y, D65)

| 1st surface photopic average | | | | | | | | |
|---|---|---|---|---|---|---|---|---|
| % Reflectance (Y, D65) | Coating Thickness Scaling Factor | | | | | | | |
| Angle of Incidence (AOI) | 1 | 0.9 | 0.8 | 0.7 | 0.6 | 0.5 | 0.4 | 0.3 |
| 5 degree AOI | 2.29 | 2.30 | 2.32 | 2.32 | 2.36 | 2.33 | 2.46 | 2.56 |
| 30 degree AOI | 2.37 | 2.39 | 2.42 | 2.41 | 2.48 | 2.47 | 2.69 | 3.02 |
| 45 degree AOI | 3.08 | 3.11 | 3.14 | 3.18 | 3.25 | 3.33 | 3.62 | 4.34 |
| 60 degree AOI | 6.64 | 6.68 | 6.75 | 6.85 | 6.93 | 7.26 | 7.51 | 8.89 |

As is evident from Table 18, the exemplary coated article of this example (Ex. 6A) has a single-surface photopic average reflectance of less than 3% at coating thickness scaling factors from 40% to 100% at all incident light (viewing) angles from 5 degrees to 30 degrees. The single-surface photopic average reflectance remains in a narrow range for coating thickness scaling factors from 0.3 to 1.0, where 1.0 represent the full 100% design thickness. Over this entire range of thickness scaling from 0.3 to 1.0, the single-surface photopic average reflectance remains from 2.2 to 2.6 at 5 deg. AOI, from 2.3 to 3.1 at 30 deg. AOI, from 3.0 to 4.4 at 45 deg. AOI, and from 6.6 to 8.9 at 60 deg. AOI.

As is also evident from FIG. 25, the coated article of this example (Ex. 6A) demonstrates a reflected color b*, where −2<b*<2 for thickness scaling factors from 35% to 100% for all viewing angles from 0 to 90 degrees. Further, Ex. 6A demonstrates a reflected color a*, where −2<a*<2 for thickness scaling factors from 35% to 100% for all viewing angles from 0 to 90 degrees.

### Example 7

A transparent article including a strengthened glass-ceramic substrate was prepared for this example with the structure delineated below in Table 19. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

TABLE 19
Ex. 7 transparent article design with
strengthened glass-ceramic substrate

| | | thickness | Index |
|---|---|---|---|
| Layer | Material | (nm) | (550 nm) |
| | Glass-ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiOxNy | 24.99 | 1.744 |
| 14 | SiNy | 11.11 | 2.042 |
| 15 | SiOxNy | 56.38 | 1.744 |
| 16 | SiNy | 6.85 | 2.042 |
| 17 | SiOxNy | 214.84 | 1.744 |
| 18 | SiNy | 12.22 | 2.042 |
| 19 | SiOxNy | 48.56 | 1.744 |
| 20 | SiNy | 33.69 | 2.042 |
| 21 | SiOxNy | 21.47 | 1.744 |
| 22 | SiNy | 164.48 | 2.042 |
| 23 | SiOxNy | 17.65 | 1.744 |
| 24 | SiNy | 17.99 | 2.042 |
| 25 | SiOxNy | 71.13 | 1.744 |
| 26 | SiO2 | 95 | 1.476 |
| | Medium | Air | 1 |

| | |
|---|---|
| Total thickness (nm): | 3174.7 |
| AR layers thickness (nm): | 796.4 |
| Low-RI in AR thickness (nm): | 95 |

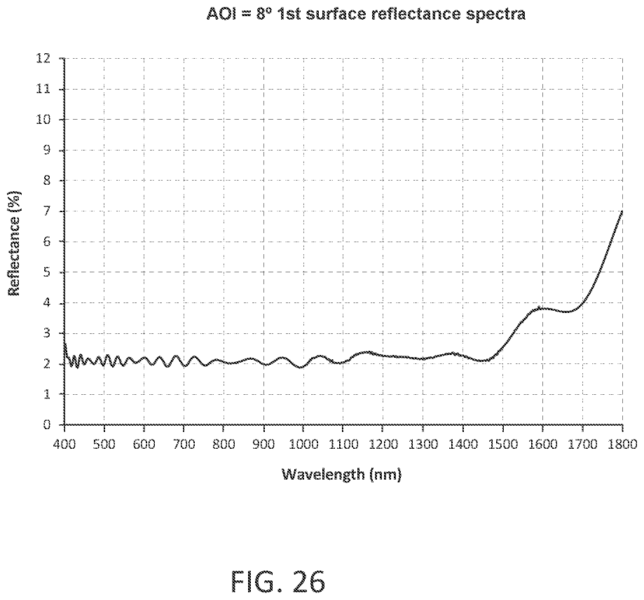

Referring to FIG. 26, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 2.5%.

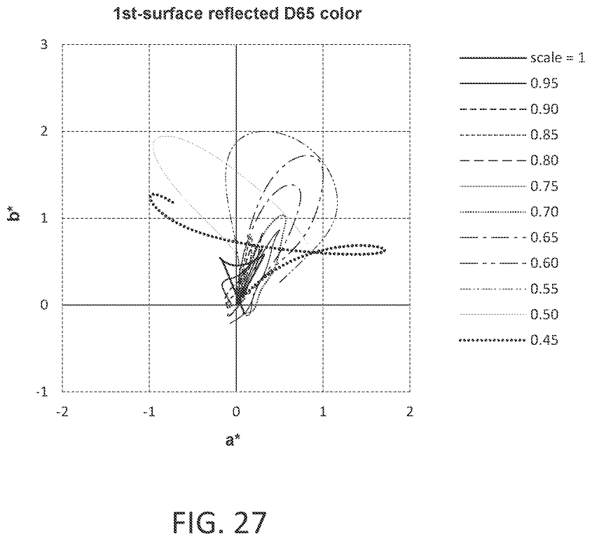

Referring to FIG. 27, a plot is provided of single-sided, reflected color for this inventive example, as measured at incident angles from 0° to 90° with various optical film structure thickness scaling factors. As is evident from FIG. 27, the color shift exhibited by this inventive example is fairly consistent and less than 4 for the full range of optical film structure thickness scaling factors from about 45 to 100% depicted in this figure.

### Example 8

A coated article including a glass substrate was prepared for this example with the structure delineated below in Table 20. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The layers of the optical film structure were deposited according to vapor deposition conditions set forth in U.S. Patent Application Publication No. 2020/0158916, the salient portions of which are incorporated herein by reference.

TABLE 20
Ex. 8 coated article design with strengthened
glass-ceramic substrate

| | | Thickness | Index |
|---|---|---|---|
| Layer | Material | (nm) | (550 nm) |
| | Glass | Substrate | 1.510 |
| 1 | SiO2 | 20 | 1.476 |
| 2 | SiOxNy | 9.13 | 1.943 |
| 3 | SiO2 | 70.52 | 1.476 |
| 4 | SiOxNy | 21.35 | 1.943 |
| 5 | SiO2 | 59.3 | 1.476 |
| 6 | SiOxNy | 35.98 | 1.943 |
| 7 | SiO2 | 39.4 | 1.476 |
| 8 | SiOxNy | 51.4 | 1.943 |
| 9 | SiO2 | 20.2 | 1.476 |
| 10 | SiOxNy | 63.7 | 1.943 |
| 11 | SiO2 | 6.4 | 1.476 |
| 12 | SiOxNy | 2050 | 1.943 |
| 13 | SiO2 | 16.28 | 1.476 |
| 14 | SiNy | 38.06 | 2.042 |
| 15 | SiO2 | 43.88 | 1.476 |
| 16 | SiNy | 23 | 2.042 |
| 17 | SiO2 | 129.82 | 1.476 |
| | Medium | Air | 1 |

| | |
|---|---|
| Total thickness (nm): | 2698.4 |
| AR layers thickness (nm): | 251.0 |
| Low-RI in AR thickness (nm): | 190.0 |

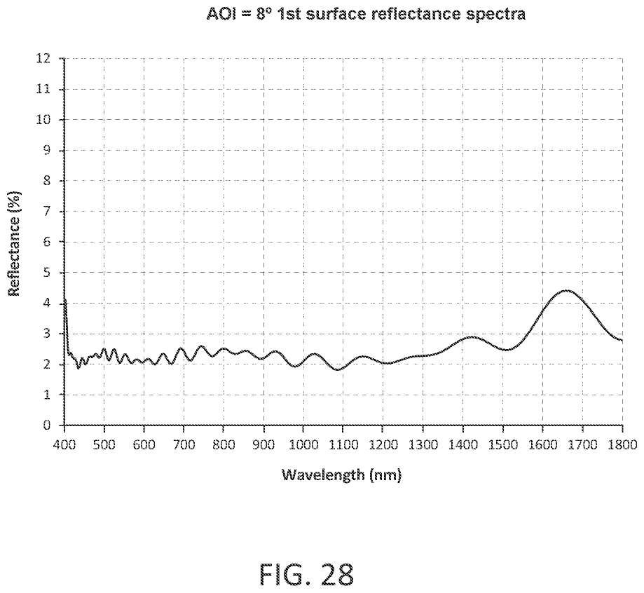

Referring to FIG. 28, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 3%.

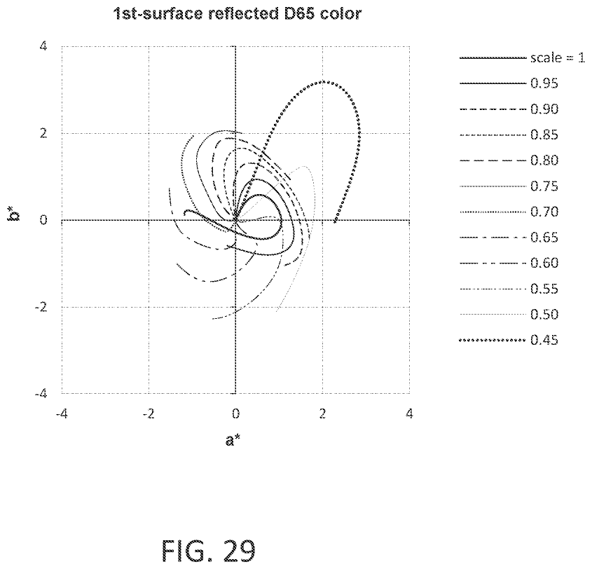

Referring to FIG. 29, a plot is provided of single-sided, reflected color for this inventive example, as measured at incident angles from 0° to 90° with various optical film structure thickness scaling factors. As is evident from FIG. 29, the color shift exhibited by this inventive example is fairly consistent and less than 4 for the full range of optical film structure thickness scaling factors from about 45 to 100% depicted in this figure.

### Example 9

A coated article including a strengthened glass-ceramic substrate was prepared for this example with the structure delineated below in Table 20. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

TABLE 21
Ex. 9 transparent article design with
strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiO2 | 17.73 | 1.476 |
| 14 | SiNy | 13.8 | 2.042 |
| 15 | SiO2 | 18.86 | 1.476 |
| 16 | SiNy | 10.35 | 2.042 |
| 17 | SiO2 | 105 | 1.476 |
| | Medium | Air | 1 |

| | |
|---|---|
| Total thickness (nm): | 2544.0 |
| AR layers thickness (nm): | 165.7 |
| Low-RI in AR thickness (nm): | 141.6 |

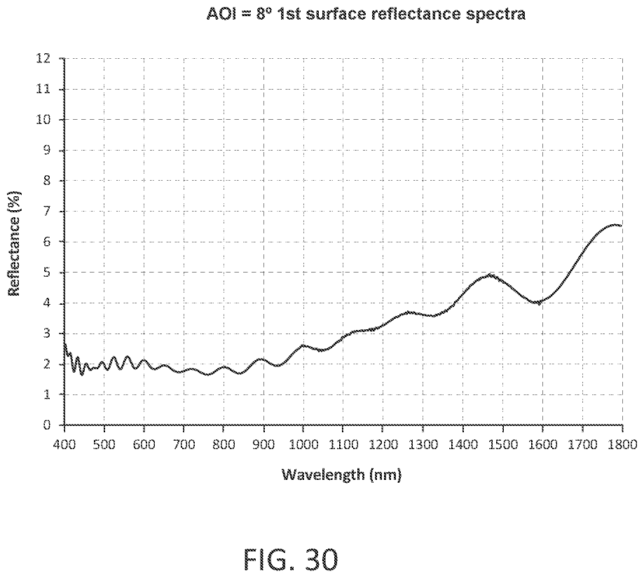

Referring to FIG. 30, a plot is provided of first-surface reflectance vs. wavelength for this inventive example, as measured at a near-normal incident angle of 8°. Notably, this example exhibits low maximum and minimum reflectance oscillations in the 1000 to 1700 nm wavelength band of less than 4%.

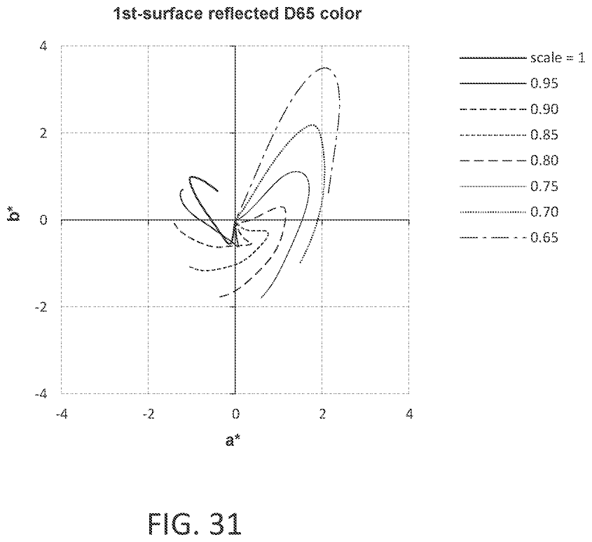

Referring to FIG. 31, a plot is provided of single-sided, reflected color for this inventive example, as measured at incident angles from 0° to 90° with various optical film structure thickness scaling factors. As is evident from FIG. 31, the color shift exhibited by this inventive example is fairly consistent and less than 4 for the full range of optical film structure thickness scaling factors from about 65 to 100% depicted in this figure.

### Example 10

A transparent article including a strengthened glass-ceramic substrate was prepared for this example with the structure delineated below in Table 22. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). In addition, the glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. The layers of the optical film structure were deposited according to vapor deposition conditions set forth in U.S. patent application Publication No. 2020/0158916, the salient portions of which are incorporated herein by reference.

TABLE 22
Ex. 10 transparent article design with
strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 1960 | 1.829 |
| 13 | SiNy | 20.8 | 2.042 |
| 14 | SiOxNy | 23.4 | 1.744 |
| 15 | SiNy | 141.5 | 2.042 |
| 16 | SiOxNy | 59.9 | 1.744 |
| 17 | SiO2 | 60 | 1.476 |
| | Medium | Air | 1 |

| | |
|---|---|
| Total thickness (nm): | 2684.0 |
| AR layers thickness (nm): | 305.7 |
| Low-RI in AR thickness (nm): | 60.0 |

Referring again to the transparent article of this example, the layers (e.g., layers 13-17 in Table 22) of the optical film structure above the scratch-resistant layer (e.g., layer 12 in Table 22) are configured to achieve high shallow hardness while not negatively affecting the optical properties of the article, including reflectance in the visible, IR, and near-IR spectra. As is evident from the optical film structure design of Table 22, medium index layers (SiOₓN_{y} layers 14, and 16) are disposed adjacent to high index layers (SiN_{y} layers 13, and 15), which drive shallow high hardness levels in the article. Similarly, as is evident in Table 22, the total thickness of the low refractive index layers (e.g., SiO₂ layer 17) in the outer structure of the optical film structure above the scratch-resistant layer is minimized to a level that is less than 75 nm, which also helps drive shallow high hardness levels in the article.

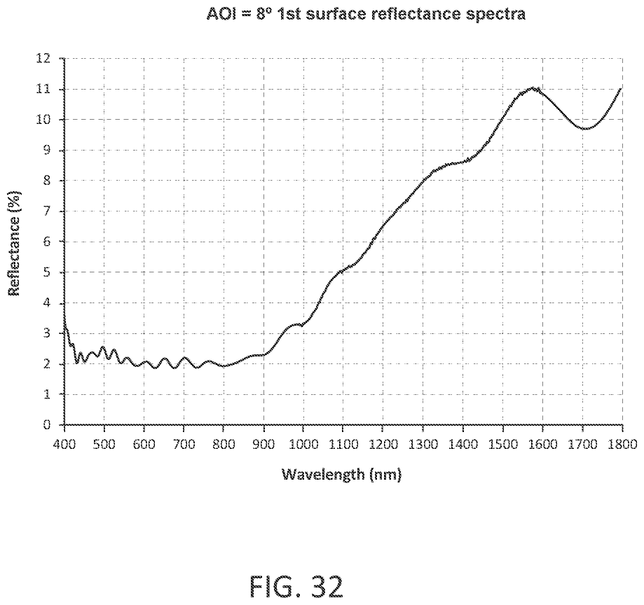

Referring to FIG. 32, a plot is provided of first-surface reflectance vs. wavelength for this example, as measured at a near-normal incident angle of 8°. This example exhibits a maximum reflectance of less than 11.5% in the near-IR spectrum from 1000 to 1700 nm.

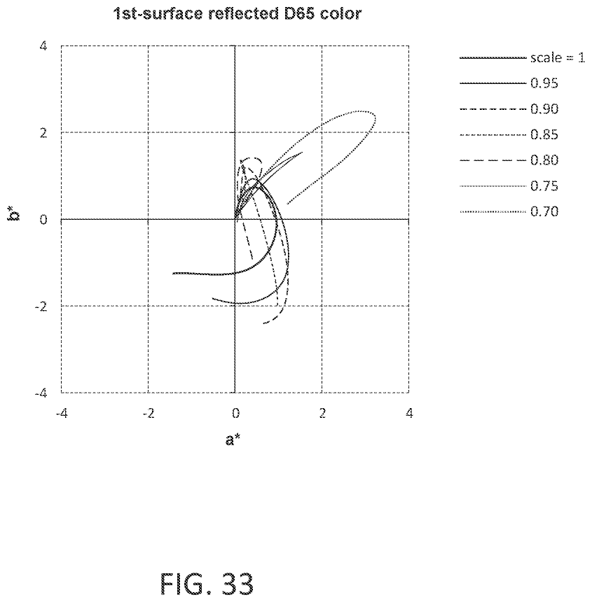

Referring to FIG. 33, a plot is provided of single-sided, reflected color for this inventive example, as measured at incident angles from 0° to 90° with various optical film structure thickness scaling factors. As is evident from FIG. 33, the color shift exhibited by this inventive example is fairly consistent and less than 4 for the full range of optical film structure thickness scaling factors from about 70 to 100% depicted in this figure.

### Example 11

A transparent article including a strengthened glass-ceramic substrate was prepared for this example with the structure delineated below in Table 23. The glass-ceramic substrate is an ion-exchanged, LAS glass-ceramic substrate having a thickness of 600 μm and a refractive index of 1.533. The glass-ceramic substrate has the following composition: 74.5% SiO₂; 7.53% Al₂O₃; 2.1% P₂O₅; 11.3% Li₂O; 0.06% Na₂O; 0.12% K₂O; 4.31% ZrO₂; 0.06% Fe₂O₃; and 0.02% SnO₂ (wt %, on an oxide basis). The glass-ceramic substrate was cerammed according to the following schedule: (a) ramp from room temperature to 580° C. at 5° C./min; (b) hold at 580° C. for 2.75 hours; (c) ramp to 755° C. at 2.5° C./min; (d) hold at 755° C. for 0.75 hours; and (e) cool at a furnace rate to room temperature. After ceramming, the glass-ceramic substrate was ion-exchange strengthened in a molten salt bath of 60% KNO₃/40% NaNO₃+0.12% LiNO₃ (wt. %) at 500° C. for 6 hours. Further, the layers of the optical film structure were deposited according to vapor deposition conditions set forth in U.S. Patent Application Publication No. 2020/0158916, the salient portions of which are incorporated herein by reference.

TABLE 23
Ex. 11 transparent article design with
strengthened glass-ceramic substrate

| | | thickness | Index |
|---|---|---|---|
| Layer | Material | (nm) | (550 nm) |
| | Glass-Ceramic | Substrate | 1.533 |
| 1 | SiO2 | 25 | 1.476 |
| 2 | SiOxNy | 13.7 | 1.829 |
| 3 | SiO2 | 66 | 1.476 |
| 4 | SiOxNy | 25.4 | 1.829 |
| 5 | SiO2 | 58.9 | 1.476 |
| 6 | SiOxNy | 38.6 | 1.829 |
| 7 | SiO2 | 40.9 | 1.476 |
| 8 | SiOxNy | 53.6 | 1.829 |
| 9 | SiO2 | 22.2 | 1.476 |
| 10 | SiOxNy | 66 | 1.829 |
| 11 | SiO2 | 8 | 1.476 |
| 12 | SiOxNy | 2020 | 1.829 |
| 13 | SiNy | 22.1 | 2.042 |
| 14 | SiOxNy | 22.0 | 1.744 |
| 15 | SiNy | 84.4 | 2.042 |
| 16 | SiOxNy | 21.5 | 1.744 |
| 17 | SiNy | 33.9 | 2.042 |
| 18 | SiO2 | 104.0 | 1.476 |
| | Medium | Air | 1 |

| | |
|---|---|
| Total thickness (nm): | 2726.1 |
| AR layers thickness (nm): | 287.8 |
| Low-RI in AR thickness (nm): | 104.0 |

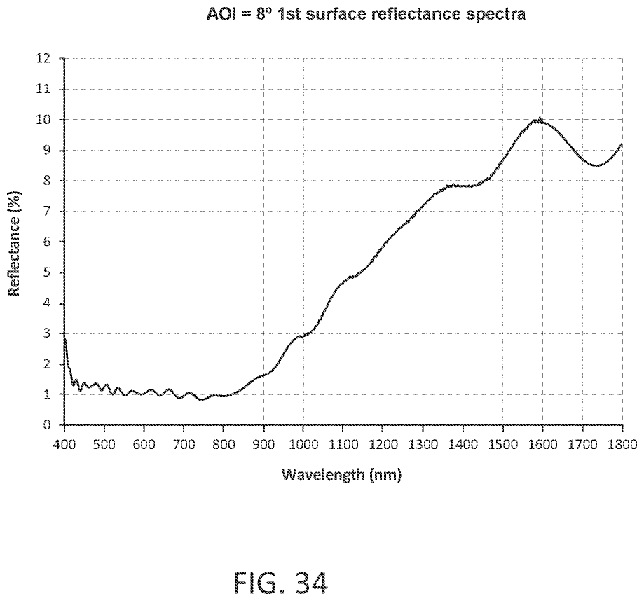

Referring to FIG. 34, a plot is provided of first-surface reflectance vs. wavelength for this inventive example, as measured at a near-normal incident angle of 8°. This example exhibits low maximum reflectance from 1000 to 1700 nm of less than about 10%.

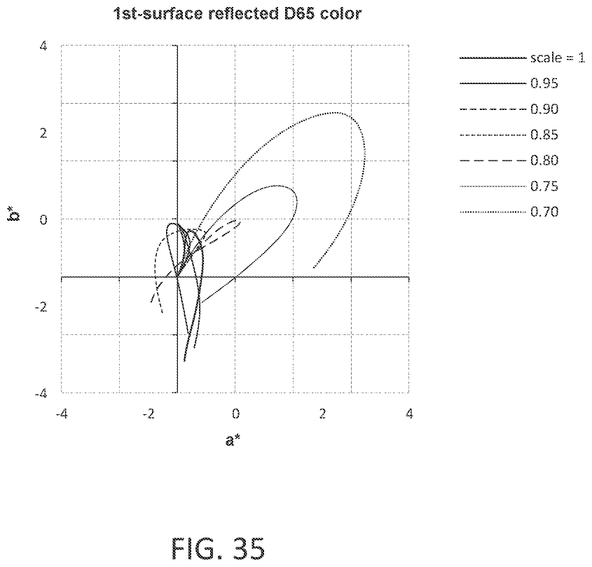

Referring to FIG. 35, a plot is provided of single-sided, reflected color for this inventive example, as measured at incident angles from 0° to 90° with various optical film structure thickness scaling factors. As is evident from FIG. 35, the color shift exhibited by this inventive example is fairly consistent and less than 4 for the full range of optical film structure thickness scaling factors from about 80 to 100% depicted in this figure.

### Example 12

A transparent article including a glass substrate was prepared for this example with the structure delineated below in Table 24. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. Further, the layers of the optical film structure were deposited according to vapor deposition conditions set forth in U.S. Patent Application Publication No. 2020/0158916, the salient portions of which are incorporated herein by reference.

TABLE 24
Ex. 12 transparent article design with
strengthened glass-ceramic substrate

| | | thickness | Index |
|---|---|---|---|
| Layer | Material | (nm) | (550 nm) |
| | Glass | Substrate | 1.51 |
| 1 | SiO2 | 25.0 | 1.465 |
| 2 | SiOxNy | 10.0 | 1.943 |
| 3 | SiO2 | 69.2 | 1.465 |
| 4 | SiOxNy | 21.4 | 1.943 |
| 5 | SiO2 | 57.9 | 1.465 |
| 6 | SiOxNy | 35.5 | 1.943 |
| 7 | SiO2 | 38.3 | 1.465 |
| 8 | SiOxNy | 51 | 1.943 |
| 9 | SiO2 | 19.6 | 1.465 |
| 10 | SiOxNy | 62.6 | 1.943 |
| 11 | SiO2 | 6.4 | 1.465 |
| 12 | SiOxNy | 1000.0 | 1.943 |
| 13 | SiOxNy | 17.1 | 1.744 |
| 14 | SiNy | 27.9 | 2.043 |
| 15 | SiOxNy | 41.6 | 1.788 |
| 16 | SiNy | 13.0 | 2.043 |
| 17 | SiOxNy | 34.0 | 1.788 |
| 18 | SiNy | 8.8 | 2.043 |
| 19 | SiOxNy | 88.2 | 1.788 |
| 20 | SiNy | 8.9 | 2.043 |
| 21 | SiOxNy | 78.7 | 1.788 |
| 22 | SiNy | 24.1 | 2.043 |
| 23 | SiOxNy | 35.4 | 1.788 |
| 24 | SiNy | 24.6 | 2.043 |
| 25 | SiOxNy | 14.7 | 1.788 |
| 26 | SiNy | 51.3 | 2.043 |
| 27 | SiOxNy | 20.7 | 1.788 |
| 28 | SiNy | 52.0 | 2.043 |
| 29 | SiOxNy | 9.6 | 1.788 |
| 30 | SiNy | 10.4 | 2.043 |
| 31 | SiOxNy | 36.3 | 1.788 |
| 32 | SiNy | 27.8 | 2.043 |
| 33 | SiOxNy | 75.2 | 1.788 |
| 34 | SiNy | 12.2 | 2.043 |
| 35 | SiOxNy | 13.0 | 1.788 |
| 36 | SiNy | 10.9 | 2.043 |
| 37 | SiOxNy | 38.5 | 1.788 |
| 38 | SiNy | 13.5 | 2.043 |
| 39 | SiOxNy | 11.9 | 1.788 |
| 40 | SiNy | 49.9 | 2.043 |
| 41 | SiOxNy | 11.4 | 1.788 |
| 42 | SiNy | 78.9 | 2.043 |
| 43 | SiOxNy | 8.6 | 1.788 |
| 44 | SiNy | 9.4 | 2.043 |
| 45 | SiOxNy | 57.5 | 1.788 |
| 46 | SiNy | 13.6 | 2.043 |
| 47 | SiO2 | 118.1 | 1.465 |
| | Medium | Air | 1 |

| | |
|---|---|
| Total thickness (nm): | 2544.0 |
| AR layers thickness (nm): | 1147.6 |
| Low-RI in AR thickness (nm): | 118.1 |

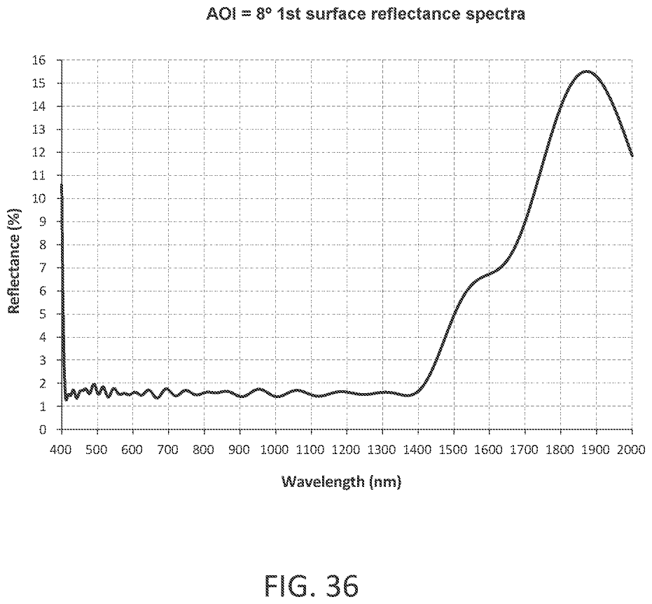

Referring to FIG. 36, a plot is provided of first-surface reflectance vs. wavelength for this inventive example, as measured at a near-normal incident angle of 8°. Notably, this example exhibits a maximum reflectance in the 1000 to 1700 nm wavelength band of less than about 10%.

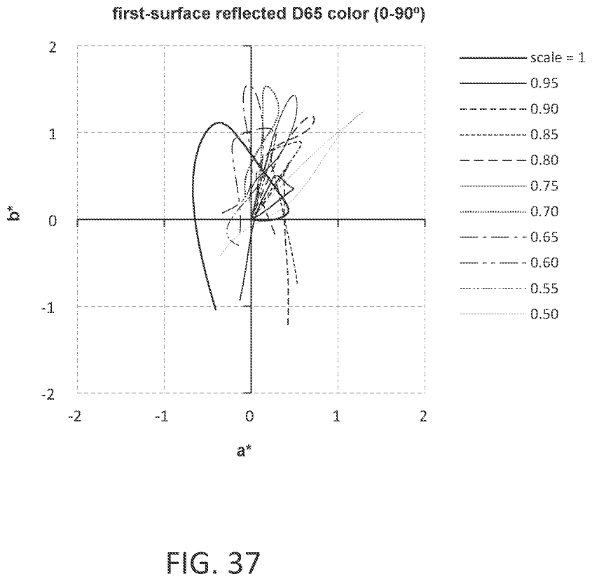

Referring to FIG. 37, a plot is provided of single-sided, reflected color for this inventive example, as measured at incident angles from 0° to 90° with various optical film structure thickness scaling factors. As is evident from FIG. 37, the color shift exhibited by this inventive example is fairly consistent and less than 4 for the full range of optical film structure thickness scaling factors from about 50 to 100% depicted in this figure.

### Example 13

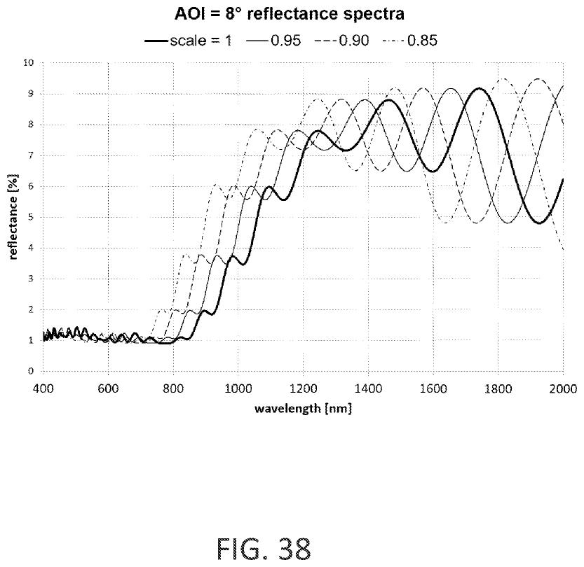

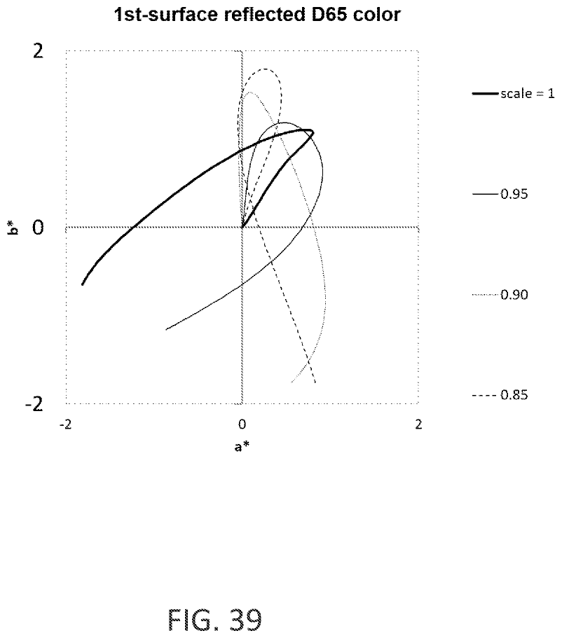

A glass substrate was coated with the exemplary coating of Table 25 below, designated Ex. 13, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 13 coated article comprises 51.9% SiNₓ by volume %. Optical properties of the Ex. 13 coated article are shown in FIGS. 38-39. In particular, FIG. 38 is a plot of first-surface photopic reflectance v. wavelength at a near-normal light incidence angle (8 degrees) for Ex. 13 at optical coating thickness scaling factor values of 1, 0.95, 0.90, and 0.85. Further, FIG. 39 is a plot of first-surface reflected color with a D65 illuminant for all viewing angles from 0 to 90 degrees at four optical coating thickness scaling factor values, 1, 0.95, 0.9, and 0.85.

TABLE 25
Ex. 13, Coated Glass Article

| | | thickness | Index |
|---|---|---|---|
| Layer | Material | (nm) | (550 nm) |
| | Glass | Substrate | 1.51 |
| 1 | SiO2 | 25.00 | 1.474 |
| 2 | SiOxNy | 8.00 | 1.975 |
| 3 | SiO2 | 73.38 | 1.474 |
| 4 | SiOxNy | 18.07 | 1.975 |
| 5 | SiO2 | 63.85 | 1.474 |
| 6 | SiOxNy | 30.27 | 1.975 |
| 7 | SiO2 | 45.31 | 1.474 |
| 8 | SiOxNy | 43.95 | 1.975 |
| 9 | SiO2 | 24.68 | 1.474 |
| 10 | SiOxNy | 56.63 | 1.975 |
| 11 | SiO2 | 8.00 | 1.474 |
| 12 | SiOxNy | 2000.00 | 1.975 |
| 13 | SiNx | 12.33 | 2.020 |
| 14 | SiO2 | 13.04 | 1.474 |
| 15 | SiNx | 47.79 | 2.020 |
| 16 | SiO2 | 28.99 | 1.474 |
| 17 | SiNx | 47.96 | 2.020 |
| 18 | SiO2 | 28.08 | 1.474 |
| 19 | SiNx | 66.54 | 2.020 |
| 20 | SiO2 | 22.48 | 1.474 |
| 21 | SiNx | 43.44 | 2.020 |
| 22 | SiO2 | 109.24 | 1.474 |
| | Medium | Air | 1 |

| | |
|---|---|
| Total thickness (nm): | 2817.0 |
| AR layers thickness (nm): | 419.9 |
| Low-RI in AR thickness (nm): | 201.8 |

As is evident from FIG. 38, this example exhibits a maximum reflectance in the 1000 to 1700 nm wavelength band of less than about 8%.

As is evident from FIG. 39, the color shift exhibited by this inventive example is fairly consistent and less than 2 for the full range of optical film structure thickness scaling factors from about 85% to 100% depicted in this figure.

### Example 14

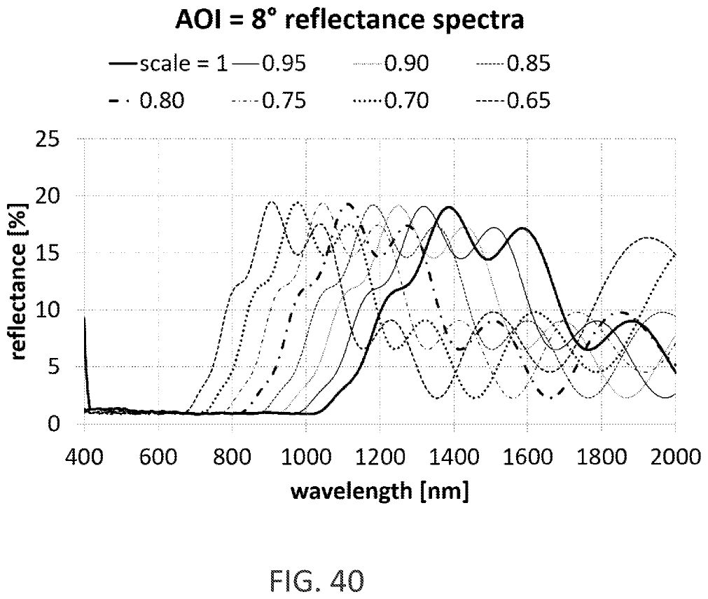

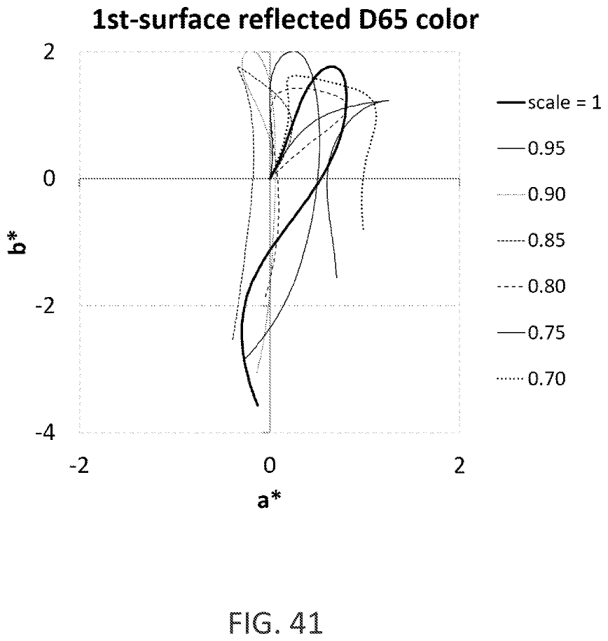

A glass substrate was coated with the exemplary coating of Table 26 below, designated Ex. 14, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 14 coated article comprises 49.1% SiOₓN_{y} by volume %. Optical properties of the Ex. 13 coated article are shown in FIGS. 40-41. In particular, FIG. 40 is a plot of first-surface photopic reflectance v. wavelength at a near-normal light incidence angle (8 degrees) for Ex. 14 at optical coating thickness scaling factor values of 1, 0.95, 0.90, 0.85, 0.80, 0.75, 0.70, and 0.65. Further, FIG. 41 is a plot of first-surface reflected color with a D65 illuminant for all viewing angles from 0 to 90 degrees at seven optical coating thickness scaling factor values, 1, 0.95, 0.9, 0.85, 0.80, 0.75, and 0.70.

TABLE 26
Ex. 14, Coated Glass Article

| | | thickness | Index |
|---|---|---|---|
| Layer | Material | (nm) | (550 nm) |
| | Glass | Substrate | 1.51 |
| 1 | SiO2 | 20.0 | 1.476 |
| 2 | SiOxNy | 12.0 | 1.744 |
| 3 | SiO2 | 62.4 | 1.476 |
| 4 | SiOxNy | 32.1 | 1.744 |
| 5 | SiO2 | 52.5 | 1.476 |
| 6 | SiOxNy | 31.9 | 1.943 |
| 7 | SiO2 | 36.7 | 1.476 |
| 8 | SiOxNy | 49.2 | 1.943 |
| 9 | SiO2 | 16.3 | 1.476 |
| 10 | SiOxNy | 60.4 | 1.943 |
| 11 | SiOxNy | 8.4 | 1.744 |
| 12 | SiOxNy | 1700.0 | 1.943 |
| 13 | SiNx | 17.9 | 2.043 |
| 14 | SiOxNy | 21.2 | 1.744 |
| 15 | SiNx | 38.5 | 2.043 |
| 16 | SiOxNy | 39.6 | 1.744 |
| 17 | SiNx | 22.3 | 2.043 |
| 18 | SiOxNy | 204.8 | 1.744 |
| 19 | SiNx | 30.1 | 2.043 |
| 20 | SiOxNy | 24.5 | 1.744 |
| 21 | SiNx | 89.9 | 2.043 |
| 22 | SiOxNy | 25.7 | 1.744 |
| 23 | SiNx | 33.7 | 2.043 |
| 24 | SiOxNy | 88.4 | 1.744 |
| 25 | SiNx | 19.6 | 2.043 |
| 26 | SiOxNy | 47.0 | 1.744 |
| 27 | SiNx | 85.1 | 2.043 |
| 28 | SiOxNy | 20.7 | 1.744 |
| 29 | SiNx | 40.7 | 2.043 |
| 30 | SiO2 | 111.1 | 1.476 |
| | Medium | Air | 1 |

| | |
|---|---|
| Total thickness (nm): | 3042.7 |
| AR layers thickness (nm): | 960.7 |
| Low-RI in AR thickness (nm): | 111.1 |

As is evident from FIG. 40, this example exhibits a maximum reflectance in the 400 to 1000 nm wavelength band of less than about 8% at an optical film structure thickness scaling factor range of 85% to 100%.

The first surface photopic average reflectance for Example 14 is less than 1.15% at a viewing angle (AOI) of 5 degrees for all optical film structure thickness scaling factors in the range of 60% to 100%.

As is evident from FIG. 41, the color shift exhibited by this inventive example is fairly consistent and less than 4 for the full range of optical film structure thickness scaling factors from about 70% to 100% depicted in this figure

### Example 15

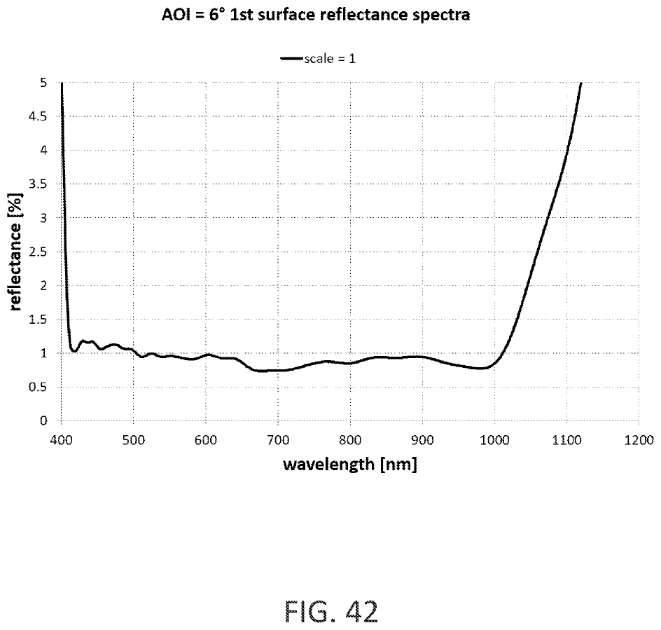

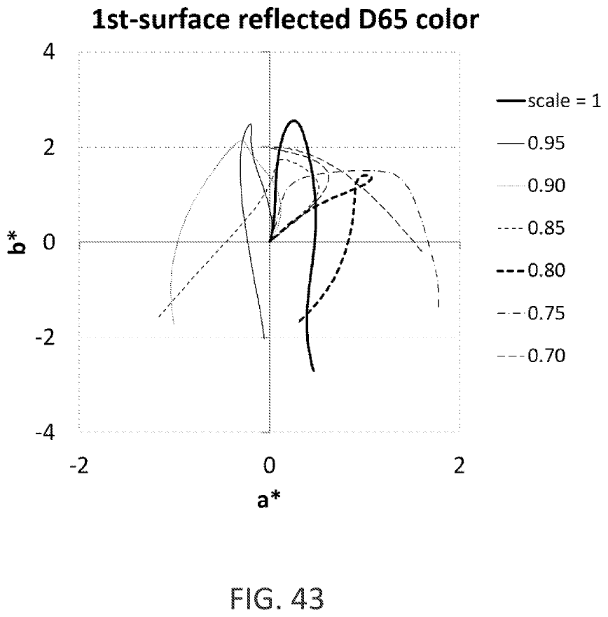

A glass substrate was coated with the exemplary coating of Table 27 below, designated Ex. 15, according to the principles of the disclosure. The glass substrate is a strengthened glass substrate. The glass substrate is an ion-exchanged, aluminosilicate glass substrate having a thickness of 550 μm and a refractive index of 1.51. The substrate has the following composition: 61.81% SiO₂; 3.9% B₂O₃; 19.69% Al₂O₃; 12.91% Na₂O; 0.018% K₂O; 1.43% MgO; 0.019% Fe₂O₃; and 0.223% SnO₂ (wt %, on an oxide basis). The substrate was strengthened using a molten salt bath to achieve a maximum compressive stress (CS) of 850 MPa with a depth-of-layer (DOL) of 40 μm. The antireflective layers of Ex. 15 coated article comprises 50.6% SiOₓN_{y} by volume %. Optical properties of the Ex. 13 coated article are shown in FIGS. 42-43. In particular, FIG. 42 is a plot of first-surface photopic reflectance v. wavelength at a near-normal light incidence angle (8 degrees) for Ex. 15 at an optical coating thickness scaling factor value of 1. Further, FIG. 43 is a plot of first-surface reflected color with a D65 illuminant for all viewing angles from 0 to 90 degrees at seven optical coating thickness scaling factor values, 1, 0.95, 0.9, 0.85, 0.80, 0.75, and 0.70.

TABLE 27
Ex. 15, Coated Glass Article

| | | thickness | Index |
|---|---|---|---|
| Layer | Material | (nm) | (550 nm) |
| | Glass | Substrate | 1.51 |
| 1 | SiO2 | 20.0 | 1.465 |
| 2 | SiOxNy | 12.8 | 1.744 |
| 3 | SiO2 | 62.3 | 1.465 |
| 4 | SiOxNy | 31.0 | 1.744 |
| 5 | SiO2 | 54.9 | 1.465 |
| 6 | SiOxNy | 30.8 | 1.943 |
| 7 | SiO2 | 39.1 | 1.465 |
| 8 | SiOxNy | 47.7 | 1.943 |
| 9 | SiO2 | 18.2 | 1.465 |
| 10 | SiOxNy | 58.7 | 1.943 |
| 11 | SiOxNy | 10.4 | 1.744 |
| 12 | SiOxNy | 1400.0 | 1.943 |
| 13 | SiNx | 9.5 | 2.043 |
| 14 | SiOxNy | 16.6 | 1.744 |
| 15 | SiNx | 28.1 | 2.043 |
| 16 | SiOxNy | 36.9 | 1.744 |
| 17 | SiNx | 18.3 | 2.043 |
| 18 | SiOxNy | 195.2 | 1.744 |
| 19 | SiNx | 28.4 | 2.043 |
| 20 | SiOxNy | 23.0 | 1.744 |
| 21 | SiNx | 92.1 | 2.043 |
| 22 | SiOxNy | 24.7 | 1.744 |
| 23 | SiNx | 29.7 | 2.043 |
| 24 | SiOxNy | 99.9 | 1.744 |
| 25 | SiNx | 15.1 | 2.043 |
| 26 | SiOxNy | 46.0 | 1.744 |
| 27 | SiNx | 83.1 | 2.043 |
| 28 | SiOxNy | 20.4 | 1.744 |
| 29 | SiNx | 39.5 | 2.043 |
| 30 | SiO2 | 108.5 | 1.465 |
| | Medium | Air | 1 |

| | |
|---|---|
| Total thickness (nm): | 2700.7 |
| AR layers thickness (nm): | 915.7 |
| Low-RI in AR thickness (nm): | 108.5 |

As is evident from FIG. 42, this example exhibits a maximum reflectance in the 400 to 1000 nm wavelength band of less than about 1.25% at an optical film structure thickness scaling factor range of 100%.

The first surface photopic average reflectance for Example 15 is less than 1.0% at a viewing angle (AOI) of 5 degrees for all optical film structure thickness scaling factors in the range of 70% to 100%.

As is evident from FIG. 43, the a* color shift exhibited by this inventive example is fairly consistent and less than 3 for the full range of optical film structure thickness scaling factors from about 70% to 100% depicted in this figure. Further, the b* color shift exhibited by this inventive example is fairly consistent and less than 3 for the full range of optical film structure thickness scaling factors from about 70% to 100% depicted in this figure.

Many variations and modifications may be made to the above-described embodiments of the disclosure without departing substantially from the spirit and various principles of the disclosure. All such modifications and variations are intended to be included herein within the scope of this disclosure and protected by the following claims. For example, the various features of the disclosure may be combined according to the following embodiments.

Embodiment 1. A coated article comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and an optical coating disposed on at least the first portion and the second portion of the major surface, the optical coating forming an anti-reflective surface, wherein: a thickness of the optical coating on the second portion as measured normal to the major surface at the second portion is 70% or less than a thickness of the optical coating on the first portion as measured normal to the major surface at the first portion; and the coated article exhibits a single side light reflectance of about 33% or less at all wavelengths from 410 nm to at least 1050 nm as measured at the first portion of the major surface at an angle of incidence of 5 degrees.

Embodiment 2. The coated article of Embodiment 1, wherein the thickness of the optical coating on the second portion as measured normal to the major surface at the second portion is 60% or less than the thickness of the optical coating on the first portion as measured normal to the major surface at the first portion.

Embodiment 3. The coated article of any one of the preceding Embodiments, wherein: the thickness of the optical coating on the second portion as measured normal to the major surface at the second portion is 60% or less than the thickness of the optical coating on the first portion as measured normal to the major surface at the first portion; the first surface reflected color of the coated article at the first portion is defined by −10<a*<10 and −10<b*−10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −10<a*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 4. The coated article of any one of the preceding Embodiments, wherein: the thickness of the optical coating on the second portion as measured normal to the major surface at the second portion is 60% or less than the thickness of the optical coating on the first portion as measured normal to the major surface at the first portion; the first surface reflected color of the coated article at the first portion is defined by b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and the first surface reflected color of the coated article at the second portion is defined by b*<4 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 5. The coated article of any one of the preceding Embodiments, wherein the thickness of the optical coating on the second portion as measured normal to the major surface at the second portion is 50% or less than the thickness of the optical coating on the first portion as measured normal to the major surface at the first portion.

Embodiment 6. The coated article of any one of the preceding Embodiments, wherein the thickness of the optical coating on the second portion as measured normal to the major surface at the second portion is 40% or less than the thickness of the optical coating on the first portion as measured normal to the major surface at the first portion.

Embodiment 7. The coated article of any one of the preceding Embodiments, wherein the thickness of the optical coating on the second portion as measured normal to the major surface at the second portion is 35% or less than the thickness of the optical coating on the first portion as measured normal to the major surface at the first portion; the first surface reflected color of the coated article at the first portion is defined by −10<a*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and the first surface reflected color of the coated article at the second portion is defined by −10<a*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 8. The coated article any one of the preceding Embodiments, wherein the thickness of the optical coating on the second portion as measured normal to the major surface at the second portion is 35% or less than the thickness of the optical coating on the first portion as measured normal to the major surface at the first portion; the first surface reflected color of the coated article at the second portion is defined by −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant; and the first surface reflected color of the coated article at the second portion is defined by −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 9. The coated article of any one of the preceding Embodiments, wherein the coated article exhibits a single side light reflectance of about 3% or less at wavelengths from 410 nm to at least 1050 nm as measured at the second portion of the major surface at an angle of incidence of 5 degrees.

Embodiment 10. The coated article of any one of the preceding Embodiments, wherein the coated article exhibits a residual compressive stress of greater than or equal to 700 MPa and an elastic modulus of greater than or equal to 140 GPa

Embodiment 11. The coated article of any one of the preceding Embodiments, wherein the coated article exhibits a residual compressive stress of from about 700 MPa to about 1100 MPa and an elastic modulus of from about 140 GPa to about 200 GPa.

Embodiment 12. The coated article of any one of the preceding Embodiments, wherein the coated article exhibits an elastic modulus of from about 140 GPa to about 180 GPa.

Embodiment 13. The coated article of any one of the preceding Embodiments, wherein the substrate has a surface compressive stress of from about 200 MPa to about 1200 MPa and a depth of compression of from about 5 μm to 150 μm.

Embodiment 14. The coated article of any one of the preceding Embodiments, wherein the substrate further exhibits a maximum central tension (CT) value from about 80 MPa to about 200 MPa, and further wherein the substrate has a thickness of about 1.5 mm or less.

Embodiment 15. The coated article of any one of the preceding Embodiments, wherein the substrate has a surface compressive stress of from about 200 MPa to about 400 MPa.

Embodiment 16. The coated article of any one of the preceding Embodiments, wherein the article exhibits an average failure stress of 700 MPa or greater in a ring-on-ring test with the outer surface of the optical coating structure placed in tension.

Embodiment 17. A consumer electronic device, comprising: a housing having a front surface, a back surface, and side surfaces; electrical components provided at least partially with the housing, the electrical components including at least a controller, a memory, and a display, the display being provided at or adjacent the front surface of the housing; wherein the front surface, back surface, or both the front surface and back surface of the housing includes the article of any one of the preceding Embodiments.

Embodiment 18. A coated article comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and an optical coating disposed on at least the first portion and the second portion of the major surface, the optical coating forming an anti-reflective surface, wherein the coated article exhibits a photopic average single side light reflectance of about 8% or less as measured at both the first portion and second portion of the major surface at an angle of incidence of 5 degrees.

Embodiment 19. The coated article of any one of the preceding Embodiments, wherein the angle between the first direction and the second direction is at least 40 degrees.

Embodiment 20. The coated article of any one of the preceding Embodiments, wherein the angle between the first direction and the second direction is at least 60 degrees.

Embodiment 21. The coated article of any one of the preceding Embodiments, wherein the coated article exhibits a photopic average single side light reflectance of about 5% or less at as measured at both the first portion and the second portion of the major surface at an angle of incidence of 5 degrees.

Embodiment 22. The coated article of any one of the preceding Embodiments, wherein the coated article exhibits a photopic average single side light reflectance of about 3% or less at as measured at both the first portion and the second portion of the major surface at an angle of incidence of 5 degrees.

Embodiment 23. The coated article of any one of the preceding Embodiments, wherein the coated article exhibits a photopic average single side light reflectance of about 2% or less as measured at both the first portion and second portion of the major surface at an angle of incidence of 5 degrees.

Embodiment 24. The coated article of any one of the preceding Embodiments, wherein the coated article exhibits a photopic average single side light reflectance of about 1.5% or less as measured at both the first portion and second portion of the major surface at an angle of incidence of 5 degrees.

Embodiment 25. The coated article of any one of the preceding Embodiments, wherein the coated article exhibits a photopic average single side light reflectance of about 1% or less as measured at both the first and second portion of the major surface at an angle of incidence of 5 degrees.

Embodiment 26. The coated article of any one the preceding Embodiments, wherein the coated article exhibits at the first portion of the substrate and at the second portion of the substrate a hardness of about 8 GPa or greater at an indentation depth of about 100 nm or greater as measured on the anti-reflective surface by a Berkovich Indenter Hardness Test.

Embodiment 27. The coated article of any one of the preceding Embodiments, wherein the coated article exhibits at the first portion of the substrate and at the second portion of the substrate a hardness of about 12 GPa or greater at an indentation depth of about 100 nm or greater as measured on the anti-reflective surface by a Berkovich Indenter Hardness Test.

Embodiment 28. The coated article of any one of the preceding Embodiments, wherein the coated article exhibits a residual compressive stress of greater than or equal to 700 MPa and an elastic modulus of greater than or equal to 140 GPa.

Embodiment 29. The coated article of any one of the preceding Embodiments, wherein the coated article exhibits a residual compressive stress of from about 700 MPa to about 1100 MPa and an elastic modulus of from about 140 GPa to about 200 GPa.

Embodiment 30. The coated article of any one of the preceding Embodiments, wherein the coated article exhibits an elastic modulus of from about 140 GPa to about 180 GPa.

Embodiment 31. The coated article of any one of the preceding Embodiments, wherein the substrate has a surface compressive stress of from about 200 MPa to about 1200 MPa and a depth of compression of from about 5 μm to 150 μm

Embodiment 32. The coated article of any one of the preceding Embodiments, wherein the substrate has a surface compressive stress of from about 200 MPa to about 400 MPa.

Embodiment 33. The coated article of any one of the preceding Embodiments, wherein the article exhibits an average failure stress of 700 MPa or greater in a ring-on-ring test with the outer surface of the optical coating structure placed in tension.

Embodiment 34. The coated article of any one of the preceding Embodiments, wherein the substrate has a depth of compression of from about 15 μm to 150 μm.

Embodiment 35. The coated article of any one of the preceding Embodiments, wherein the substrate has a depth of compression of from about 50 μm to 150 μm.

Embodiment 36. The coated article of any one of the preceding Embodiments, wherein the substrate further exhibits a maximum central tension (CT) value from about 80 MPa to about 200 MPa, and further wherein the substrate has a thickness of about 1.5 mm or less.

Embodiment 37. The coated article of anyone of the preceding Embodiments, further wherein the substrate has a thickness of 0.6 mm or less.

Embodiment 38. The coated article of any one of the preceding Embodiments, wherein the coated article has a transmitted color √(a*²+b*²) with a D65 illuminant of less than 4 at incident angles from 0 degrees to 10 degrees.

Embodiment 39. The coated article of any one of the preceding Embodiments, wherein: the first surface reflected color of the coated article at the first portion is defined by −4<a*<4 and −8<b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −4<a*<4 and −8<b*<4 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 40. The coated article of any one of the preceding Embodiments, wherein: the first surface reflected color of the coated article at the first portion is defined by −2<a*<2 and −2<b*<2 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −2<a*<2 and −2<b*<2 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 41. The coated article of any one of the preceding Embodiments, wherein the substrate is a glass-ceramic substrate.

Embodiment 42. The coated article of any one of the preceding Embodiments, wherein the optical coating comprises a first anti-reflective coating, a scratch-resistant layer over the first anti-reflective coating, and a second anti-reflective coating over the scratch-resistant layer which defines the anti-reflective surface, wherein the first anti-reflective coating comprises at least a low RI layer and a high RI layer, and the second anti-reflective coating comprises at least a low RI layer and a high RI layer.

Embodiment 43. The coated article of any one of the preceding Embodiments, wherein the thickness of the second anti-reflective coating is less than or equal to 1000 nm.

Embodiment 44. The coated article of any one of the preceding Embodiments, wherein the at least a low RI layer in each of the first and the second anti-reflective coatings comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, or a combination thereof, wherein subscripts “u,” “v,” “x,” and “y” are from 0 to 1, wherein the at least a high RI layer in each of the first and second anti-reflective coating comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or a combination thereof, wherein subscripts “u,” “v,” “x,” and “y” are from 0 to 1, and further wherein the scratch-resistant layer comprises silicon oxynitride.

Embodiment 45. The coated article of any one of the preceding Embodiments, wherein each adjacent low RI layer and high RI layer in each of the first and second anti-reflective coatings, respectively, define a period, N, and further wherein N is from 2 to 12.

Embodiment 46. The coated article of any one of the preceding Embodiments, wherein the total thickness of the optical coating is from about 2 μm to about 4 μm, and the combined total thickness of the first anti-reflective coating and the second anti-reflective coatings is from about 500 nm to about 1000 nm.

Embodiment 47. The coated article of any one of the preceding Embodiments, wherein the thickness of the scratch-resistant layer is from about 200 nm to about 3000 nm.

Embodiment 48. A consumer electronic device, comprising: a housing having a front surface, aback surface, and side surfaces; electrical components provided at least partially with the housing, the electrical components including at least a controller, a memory, and a display, the display being provided at or adjacent the front surface of the housing; wherein the front surface, back surface, or both the front surface and back surface of the housing includes the article of any one of any one of the preceding Embodiments.

Embodiment 49. A coated article comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and an optical coating disposed on at least the first portion and the second portion of the major surface, the optical coating forming an anti-reflective surface, wherein: a thickness of the optical coating on the second portion as measured normal to the major surface at the second portion is 70% or less than a thickness of the optical coating on the first portion as measured normal to the major surface at the first portion; a first surface reflected color of the coated article at the first portion is defined by b*<2.5 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and a first surface reflected color of the coated article at the second portion is defined by b*<2.5 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 50. The coated article of any one of the preceding Embodiments, wherein the thickness of the optical coating on the second portion as measured normal to the major surface at the second portion is 60% or less than the thickness of the optical coating on the first portion as measured normal to the major surface at the first portion.

Embodiment 51. The coated article of any one of the preceding Embodiments, wherein the thickness of the optical coating on the second portion as measured normal to the major surface at the second portion is 50% or less than the thickness of the optical coating on the first portion as measured normal to the major surface at the first portion.

Embodiment 52. The coated article of any one of the preceding Embodiments, wherein the thickness of the optical coating on the second portion as measured normal to the major surface at the second portion is 40% or less than the thickness of the optical coating on the first portion as measured normal to the major surface at the first portion.

Embodiment 53. The coated article of any one of the preceding Embodiments, wherein the thickness of the optical coating on the second portion as measured normal to the major surface at the second portion is 35% or less than the thickness of the optical coating on the first portion as measured normal to the major surface at the first portion.

Embodiment 54. The coated article of any one of the preceding Embodiments, wherein the coated article exhibits a residual compressive stress of greater than or equal to 700 MPa and an elastic modulus of greater than or equal to 140 GPa.

Embodiment 55. The coated article of any one of the preceding Embodiments, wherein the coated article exhibits a residual compressive stress of from about 700 MPa to about 1100 MPa and an elastic modulus of from about 140 GPa to about 200 GPa.

Embodiment 56. The coated article of any one of the preceding Embodiments, wherein the coated article exhibits an elastic modulus of from about 140 GPa to about 180 GPa.

Embodiment 57. The coated article of any one of the preceding Embodiments, wherein the substrate has a surface compressive stress of from about 200 MPa to about 1200 MPa and a depth of compression of from about 5 μm to 150 μm.

Embodiment 58. The coated article of any one of the preceding Embodiments, wherein the substrate has a surface compressive stress of from about 200 MPa to about 400 MPa.

Embodiment 59. The coated article of any one of the preceding Embodiments, wherein the article exhibits an average failure stress of 700 MPa or greater in a ring-on-ring test with the outer surface of the optical coating structure placed in tension.

Embodiment 60. The coated article of any one of the preceding Embodiments, wherein the substrate has a depth of compression of from about 15 μm to 150 μm.

Embodiment 61. A coated article comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and an optical coating disposed on at least the first portion and the second portion of the major surface, the optical coating forming an anti-reflective surface, wherein: a first surface reflected color of the coated article at the first portion is defined by b*<4. for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and a first surface reflected color of the coated article at the second portion is defined by b*<4. for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 62. The coated article of any one of the preceding Embodiments, wherein the coated article exhibits at the first portion of the substrate and at the second portion of the substrate a hardness of about 8 GPa or greater at an indentation depth of about 100 nm or greater as measured on the anti-reflective surface by a Berkovich Indenter Hardness Test.

Embodiment 63. The coated article of any one of the preceding Embodiments, wherein the coated article exhibits a photopic average reflectance of less than 8% at both the first portion of the substrate and at the second portion of the substrate.

Embodiment 64. The coated article of any one the preceding Embodiments, where the angle between the first direction and the second direction is at least 60 degrees.

Embodiment 65. The coated article of any one of the preceding Embodiments, wherein the coated article exhibits a single side light reflectance of about 3% or less at all wavelengths from 425 nm to at least 1400 nm as measured at the first portion of the major surface at an angle of incidence of 5 degrees.

Embodiment 66. The coated article of any one of the preceding Embodiments, wherein the coated article exhibits an average single side light reflectance of about 3% or less at wavelengths from 410 nm to at least 1050 nm as measured at the first portion of the major surface at an angle of incidence of 5 degrees.

Embodiment 67. The coated article of any one the preceding Embodiments, wherein the coated article exhibits an average single side light reflectance of about 3% or less at wavelengths from 410 nm to at least 1600 nm as measured at the first portion of the major surface at an angle of incidence of 5 degrees.

Embodiment 68. The coated article of any one of the preceding Embodiments, wherein: the first surface reflected color of the coated article at the first portion is defined by −10<a*<4 and −10<b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −10<a*<4 and −10<b*<4 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 69. The coated article of any one of the preceding Embodiments, wherein: a first surface reflected color of the coated article at the first portion is defined by a*<4. for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and a first surface reflected color of the coated article at the second portion is defined by a*<4. for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 70. The coated article of any one of the preceding Embodiments, wherein: the first surface reflected color of the coated article at the first portion is defined by a*<2 b*<2 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by a*<2 and −b*<2 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 71. The coated article of any one of the preceding Embodiments, wherein: the first surface reflected color of the coated article at the first portion is defined by −2<a*<2 and −2<b*<2 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −2<a*<2 and −2<b*<2 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 72. The coated article of any one of the preceding Embodiments, wherein the coated article exhibits a residual compressive stress of greater than or equal to 700 MPa and an elastic modulus of greater than or equal to 140 GPa

Embodiment 73. The coated article of any one of the preceding Embodiments, wherein the coated article exhibits a residual compressive stress of from about 700 MPa to about 1100 MPa and an elastic modulus of from about 140 GPa to about 200 GPa.

Embodiment 74. The coated article of any one of the preceding Embodiments, wherein the coated article exhibits an elastic modulus of from about 140 GPa to about 180 GPa.

Embodiment 75. The coated article of any one of the preceding Embodiments, wherein the substrate has a surface compressive stress of from about 200 MPa to about 1200 MPa and a depth of compression of from about 5 μm to 150 μm.

Embodiment 76. The coated article of any one of the preceding Embodiments, wherein the substrate has a surface compressive stress of from about 200 MPa to about 400 MPa.

Embodiment 77. The coated article of any one of the preceding Embodiments, wherein the article exhibits an average failure stress of 700 MPa or greater in a ring-on-ring test with the outer surface of the optical coating structure placed in tension.

Embodiment 78. The coated article of any one of the preceding Embodiments, wherein the substrate has a depth of compression of from about 15 μm to 150 μm.

Embodiment 79. The coated article of any one of the preceding Embodiments, wherein the substrate further exhibits a maximum central tension (CT) value from about 80 MPa to about 200 MPa, and further wherein the substrate has a thickness of about 1.5 mm or less.

Embodiment 80. The coated article of anyone of the preceding Embodiments, further wherein the substrate has a thickness of 0.6 mm or less.

Embodiment 81. The coated article of any one of the preceding Embodiments, wherein the substrate is a glass-ceramic substrate.

Embodiment 82. The coated article of any one of the preceding Embodiments, wherein the optical coating comprises a first anti-reflective coating, a scratch-resistant layer over the first anti-reflective coating, and a second anti-reflective coating over the scratch-resistant layer which defines the anti-reflective surface, wherein the first anti-reflective coating comprises at least a low RI layer and a high RI layer, and the second anti-reflective coating comprises at least a low RI layer and a high RI layer.

Embodiment 83. The coated article of any one of the preceding Embodiments, wherein the thickness of the second anti-reflective coating is less than or equal to 1000 nm.

Embodiment 84. The coated article of any one of the preceding Embodiments, wherein the thickness of the second anti-reflective coating is less than or equal to 500 nm.

Embodiment 85. The coated article of any one of the preceding Embodiments, wherein the at least a low RI layer in each of the first and the second anti-reflective coatings comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, or a combination thereof, wherein subscripts “u,” “v,” “x,” and “y” are from 0 to 1, wherein the at least a high RI layer in each of the first and second anti-reflective coating comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or a combination thereof, wherein subscripts “u,” “v,” “x,” and “y” are from 0 to 1, and further wherein the scratch-resistant layer comprises silicon oxynitride.

Embodiment 86. The coated article of any one of the preceding Embodiments, wherein each adjacent low RI layer and high RI layer in each of the first and second anti-reflective coatings, respectively, define a period, N, and further wherein N is from 2 to 12.

Embodiment 87. The coated article of any one of the preceding Embodiments, wherein the total thickness of the optical coating is from about 2 μm to about 4 μm, and the combined total thickness of the first anti-reflective coating and the second anti-reflective coatings is from about 500 nm to about 1000 nm.

Embodiment 88. The coated article of any one of the preceding Embodiments, wherein the thickness of the scratch-resistant layer is from about 200 nm to about 3000 nm.

Embodiment 89. A consumer electronic device, comprising: a housing having a front surface, aback surface, and side surfaces; electrical components provided at least partially with the housing, the electrical components including at least a controller, a memory, and a display, the display being provided at or adjacent the front surface of the housing; wherein the front surface, back surface, or both the front surface and back surface of the housing includes the article of any one of the preceding Embodiments.

Embodiment 90. A coated article comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and an optical coating disposed on at least the first portion and the second portion of the major surface, the optical coating forming an anti-reflective surface, wherein: a thickness of the optical coating on the second portion as measured normal to the major surface at the second portion is 50% or less than a thickness of the optical coating on the first portion as measured normal to the major surface at the first portion; a first surface reflected color of the coated article at the first portion is defined by −10<a*<10 and −10<b*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and a first surface reflected color of the coated article at the second portion is defined by −10<a*<10 and −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 91. The coated article of any one of the preceding Embodiments, wherein the coated article exhibits at the first portion of the substrate and at the second portion of the substrate a hardness of about 8 GPa or greater at an indentation depth of about 100 nm or greater as measured on the anti-reflective surface by a Berkovich Indenter Hardness Test.

Embodiment 92. The coated article of any one of the preceding Embodiments, wherein the coated article exhibits a photopic reflectance of less than 8% at both the first portion of the substrate and at the second portion of the substrate.

Embodiment 93. The coated article of any one of any one of the preceding Embodiments, wherein the coated article exhibits a photopic reflectance of less than 5% at both the first portion of the substrate and at the second portion of the substrate.

Embodiment 94. The coated article of any one of the preceding Embodiments, wherein the coated article exhibits a photopic reflectance of less than 4% at both the first portion of the substrate and at the second portion of the substrate.

Embodiment 95. The coated article of any one of the preceding Embodiments, wherein the coated article exhibits a photopic reflectance of less than 3% at both the first portion of the substrate and at the second portion of the substrate.

Embodiment 96. The coated article of any one of the preceding Embodiments, wherein the thickness of the optical coating on the second portion as measured normal to the major surface at the second portion is 40% or less than the thickness of the optical coating on the first portion as measured normal to the major surface at the first portion.

Embodiment 97. The coated article of any one of the preceding Embodiments, wherein the coated article exhibits a single side light reflectance of about 3% or less at all wavelengths from 425 nm to at least 1400 nm as measured at the first portion of the major surface at an angle of incidence of 5 degrees.

Embodiment 98. The coated article of any one of the preceding Embodiments, wherein the coated article exhibits an average single side light reflectance of about 3% or less at wavelengths from 410 nm to at least 1050 nm as measured at the first portion of the major surface at an angle of incidence of 5 degrees.

Embodiment 99. The coated article of any one of the preceding Embodiments, wherein the coated article exhibits an average single side light reflectance of about 3% or less at wavelengths from 410 nm to at least 1600 nm as measured at the first portion of the major surface at an angle of incidence of 5 degrees.

Embodiment 100. The coated article of any one of the preceding Embodiments, wherein: the first surface reflected color of the coated article at the first portion is defined by −2<a*<2 and −2<b*<2 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; the first surface reflected color of the coated article at the second portion is defined by −2<a*<2 and −2<b*<2 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 101. The coated article of any one of the preceding Embodiments, wherein: the first surface reflected color of the coated article at the first portion is defined by b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and the first surface reflected color of the coated article at the second portion is defined by b*<4 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

Embodiment 102. The coated article of any one of the preceding Embodiments, wherein the thickness of the optical coating on the second portion as measured normal to the major surface at the second portion is 35% or less than the thickness of the optical coating on the first portion as measured normal to the major surface at the first portion.

Embodiment 103. The coated article of any one of the preceding Embodiments, wherein the coated article exhibits a residual compressive stress of greater than or equal to 700 MPa and an elastic modulus of greater than or equal to 140 GPa.

Embodiment 104. The coated article of any one of the preceding Embodiments, wherein the coated article exhibits a residual compressive stress of from about 700 MPa to about 1100 MPa and an elastic modulus of from about 140 GPa to about 200 GPa.

Embodiment 105. The coated article of any one of the preceding Embodiments, wherein the coated article exhibits an elastic modulus of from about 140 GPa to about 180 GPa.

Embodiment 106. The coated article of any one of the preceding Embodiments, wherein the substrate has a surface compressive stress of from about 200 MPa to about 1200 MPa and a depth of compression of from about 5 μm to 150 μm.

Embodiment 107. The coated article of any one of the preceding Embodiments, wherein the substrate has a surface compressive stress of from about 200 MPa to about 400 MPa.

Embodiment 108. The coated article of any one of the preceding Embodiments, wherein the article exhibits an average failure stress of 700 MPa or greater in a ring-on-ring test with the outer surface of the optical coating structure placed in tension.

Embodiment 109. The coated article of any one of the preceding Embodiments, wherein the substrate has a depth of compression of from about 15 μm to 150 μm.

Embodiment 110. The coated article of any one of the preceding Embodiments, wherein the substrate further exhibits a maximum central tension (CT) value from about 80 MPa to about 200 MPa, and further wherein the substrate has a thickness of about 1.5 mm or less.

Embodiment 111. The coated article of any one of the preceding Embodiments, further wherein the substrate has a thickness of 0.6 mm or less.

Embodiment 112. The coated article of any one of the preceding Embodiments, wherein the substrate is a glass-ceramic substrate.

Embodiment 113. The coated article of any one of the preceding Embodiments, wherein the optical coating comprises a first anti-reflective coating, a scratch-resistant layer over the first anti-reflective coating, and a second anti-reflective coating over the scratch-resistant layer which defines the anti-reflective surface, wherein the first anti-reflective coating comprises at least a low RI layer and a high RI layer, and the second anti-reflective coating comprises at least a low RI layer and a high RI layer.

Embodiment 114. The coated article of any one of the preceding Embodiments, wherein the thickness of the second anti-reflective coating is less than or equal to 1000 nm.

Embodiment 115. The coated article of any one of the preceding Embodiments, wherein the at least a low RI layer in each of the first and the second anti-reflective coatings comprises SiO₂, Al₂O₃, GeO₂, SiO, AlOₓN_{y}, SiOₓNᵤ, SiAlₓO_{y}, SiᵤAlᵥOₓN_{y}, MgO, MgAl₂O₄, MgF₂, BaF₂, CaF₂, DyF₃, YbF₃, CeF₃, or a combination thereof, wherein subscripts “u,” “v,” “x,” and “y” are from 0 to 1, wherein the at least a high RI layer in each of the first and second anti-reflective coating comprises SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, MoO₃, diamond-like carbon, or a combination thereof, wherein subscripts “u,” “v,” “x,” and “y” are from 0 to 1, and further wherein the scratch-resistant layer comprises silicon oxynitride.

Embodiment 116. The coated article of any one of the preceding Embodiments, wherein each adjacent low RI layer and high RI layer in each of the first and second anti-reflective coatings, respectively, define a period, N, and further wherein N is from 2 to 12.

Embodiment 117. The coated article of any one of the preceding Embodiments, wherein the total thickness of the optical coating is from about 2 μm to about 4 μm, and the combined total thickness of the first anti-reflective coating and the second anti-reflective coatings is from about 500 nm to about 1000 nm.

Embodiment 118. The coated article of any one of any one of the preceding Embodiments, wherein the thickness of the scratch-resistant layer is from about 200 nm to about 3000 nm.

Embodiment 119. A consumer electronic device, comprising: a housing having a front surface, a back surface, and side surfaces; electrical components provided at least partially with the housing, the electrical components including at least a controller, a memory, and a display, the display being provided at or adjacent the front surface of the housing; wherein the front surface, back surface, or both the front surface and back surface of the housing includes the article of any one of the preceding Embodiments.

Embodiment 120. A coated article, comprising: a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and an optical film structure defining an outer surface, the optical film structure disposed on the major surface, wherein the optical film structure comprises a scratch-resistant layer and a plurality of alternating high refractive index (RI) and low RI layers, wherein the optical film structure further comprises an outer structure and an inner structure, the scratch-resistant layer disposed between the outer and inner structures, wherein the outer structure comprises at least one medium RI layer in contact with one of the high RI layers or the scratch-resistant layer, and further wherein the medium RI layer comprises a refractive index from 1.55 to 1.80, each of the high RI layers comprises a refractive index of greater than 1.80, and each of the low RI layers comprises a refractive index of less than 1.55.

Embodiment 121. The coated article of any one of any one of the preceding Embodiments, wherein a sum of the physical thicknesses of all of the low RI layers in the outer structure is less than about 200 nm.

Embodiment 122. The coated article of any one of any one of the preceding Embodiments, wherein a sum of the physical thicknesses of all of the low RI layers in the outer structure is less than about 150 nm.

Embodiment 123. The coated article of any one of any one of the preceding Embodiments, wherein a sum of the physical thicknesses of all of the low RI layers in the outer structure is less than about 100 nm.

Embodiment 124. The coated article of any one of any one of the preceding Embodiments, wherein the article exhibits an average first-surface photopic reflectance of less than 3% at both the first portion of the substrate and at the second portion of the substrate.

Embodiment 125. The coated article of any one of any one of the preceding Embodiments, wherein the article exhibits a first-surface reflectance at a wavelength of 940 nm of less than 5% at the first portion of the substrate.

Embodiment 126. The coated article of any one of any one of the preceding Embodiments, wherein the substrate is a glass-ceramic substrate that comprises an elastic modulus of greater than 85 GPa and a fracture toughness of greater than 0.8 MPa·√m, and further wherein the optical film structure exhibits a residual compressive stress of greater than or equal to 700 MPa and an elastic modulus of greater than or equal to 140 GPa.

Embodiment 127. The coated article of any one of any one of the preceding Embodiments, wherein the substrate is a glass-ceramic substrate that comprises an elastic modulus of greater than 85 GPa and a fracture toughness of greater than 0.8 MPa·√m, and further wherein the optical film structure exhibits a residual compressive stress of greater than or equal to 700 MPa and an elastic modulus of greater than or equal to 140 GPa.

Embodiment 128. The coated article of any one of any one of the preceding Embodiments, wherein the coated article exhibits an elastic modulus of from about 140 GPa to about 180 GPa.

Embodiment 129. The coated article of any one of any one of the preceding Embodiments, wherein the article exhibits a hardness of greater than 12 GPa, as measured by a Berkovich Hardness Test at an indentation depth of about 125 nm from the outer surface of the optical film structure.

What is claimed is:

1. A coated article comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and
an optical coating disposed on at least the first portion and the second portion of the major surface, the optical coating forming an anti-reflective surface, wherein:
a thickness of the optical coating on the second portion as measured normal to the major surface at the second portion is 70% or less than a thickness of the optical coating on the first portion as measured normal to the major surface at the first portion; and
the coated article exhibits a single side light reflectance of about 3% or less at all wavelengths from 410 nm to at least 1050 nm as measured at the first portion of the major surface at an angle of incidence of 5 degrees.

2. The coated article of claim 1, wherein the thickness of the optical coating on the second portion as measured normal to the major surface at the second portion is 60% or less than the thickness of the optical coating on the first portion as measured normal to the major surface at the first portion.

3. The coated article of claim 1, wherein:
the thickness of the optical coating on the second portion as measured normal to the major surface at the second portion is 60% or less than the thickness of the optical coating on the first portion as measured normal to the major surface at the first portion;
the first surface reflected color of the coated article at the first portion is defined by −10<a*<10 and −10<b*−10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant
the first surface reflected color of the coated article at the second portion is defined by −10<a*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

4. The coated article of claim 1, wherein:
the thickness of the optical coating on the second portion as measured normal to the major surface at the second portion is 60% or less than the thickness of the optical coating on the first portion as measured normal to the major surface at the first portion;
the first surface reflected color of the coated article at the first portion is defined by b*<4 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
the first surface reflected color of the coated article at the second portion is defined by b*<4 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

5. The coated article of claim 1, wherein the thickness of the optical coating on the second portion as measured normal to the major surface at the second portion is 50% or less than the thickness of the optical coating on the first portion as measured normal to the major surface at the first portion.

6. The coated article of claim 1, wherein the thickness of the optical coating on the second portion as measured normal to the major surface at the second portion is 40% or less than the thickness of the optical coating on the first portion as measured normal to the major surface at the first portion.

7. The coated article of claim 1, wherein the thickness of the optical coating on the second portion as measured normal to the major surface at the second portion is 35% or less than the thickness of the optical coating on the first portion as measured normal to the major surface at the first portion;
the first surface reflected color of the coated article at the first portion is defined by −10<a*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
the first surface reflected color of the coated article at the second portion is defined by −10<a*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

8. The coated article of claim 1, wherein the thickness of the optical coating on the second portion as measured normal to the major surface at the second portion is 35% or less than the thickness of the optical coating on the first portion as measured normal to the major surface at the first portion;
the first surface reflected color of the coated article at the first portion is defined by −10<b*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
the first surface reflected color of the coated article at the second portion is defined by −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

9. The coated article of claim 1, wherein the coated article exhibits a single side light reflectance of about 30% or less at all wavelengths from 410 nm to at least 1050 nm as measured at the second portion of the major surface at an angle of incidence of 5 degrees.

10. The coated article of claim 1, wherein the coated article exhibits a residual compressive stress of greater than or equal to 700 MPa and an elastic modulus of greater than or equal to 140 GPa.

11. The coated article of claim 1, wherein the coated article exhibits a residual compressive stress of from about 700 MPa to about 1100 MPa and an elastic modulus of from about 140 GPa to about 200 GPa.

12. The coated article of claim 1, wherein the coated article exhibits an elastic modulus of from about 140 GPa to about 180 GPa.

13. The coated article of claim 1, wherein the substrate has a surface compressive stress of from about 200 MPa to about 1200 MPa and a depth of compression of from about 5 μm to 150 μm.

14. The coated article of claim 1, wherein the substrate further exhibits a maximum central tension (CT) value from about 80 MPa to about 200 MPa, and further wherein the substrate has a thickness of about 1.5 mm or less.

15. The coated article of claim 1, wherein the substrate has a surface compressive stress of from about 200 MPa to about 400 MPa.

16. The coated article of claim 1, wherein the article exhibits an average failure stress of 700 MPa or greater in a ring-on-ring test with the outer surface of the optical coating structure placed in tension.

17. A consumer electronic device, comprising:
a housing having a front surface, a back surface, and side surfaces;
electrical components provided at least partially with the housing, the electrical components including at least a controller, a memory, and a display, the display being provided at or adjacent the front surface of the housing;
wherein the front surface, back surface, or both the front surface and back surface of the housing includes the article of claim 1.

18. A coated article comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and
an optical coating disposed on at least the first portion and the second portion of the major surface, the optical coating forming an anti-reflective surface, wherein the coated article exhibits a photopic average single side light reflectance of about 8% or less as measured at both the first portion and the second portion of the major surface at an angle of incidence of 5 degrees.

19. A coated article comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and
an optical coating disposed on at least the first portion and the second portion of the major surface, the optical coating forming an anti-reflective surface, wherein:
a thickness of the optical coating on the second portion as measured normal to the major surface at the second portion is 70% or less than a thickness of the optical coating on the first portion as measured normal to the major surface at the first portion;
a first surface reflected color of the coated article at the first portion is defined by b*<2.5 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
a first surface reflected color of the coated article at the second portion is defined by b*<2.5 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

20. A coated article comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and
an optical coating disposed on at least the first portion and the second portion of the major surface, the optical coating forming an anti-reflective surface, wherein:
a first surface reflected color of the coated article at the first portion is defined by b*<4. for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
a first surface reflected color of the coated article at the second portion is defined by b*<4. for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

21. A coated article comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 15 degrees; and
an optical coating disposed on at least the first portion and the second portion of the major surface, the optical coating forming an anti-reflective surface, wherein:
a thickness of the optical coating on the second portion as measured normal to the major surface at the second portion is 50% or less than a thickness of the optical coating on the first portion as measured normal to the major surface at the first portion;
a first surface reflected color of the coated article at the first portion is defined by −10<a*<10 and −10<b*<10 for all angles of incidence from 0 degrees to 90 degrees as measured normal to the first portion of the major surface, as measured by the reflectance color coordinates in the (L*, a*, b*) colorimetry system under an International Commission on Illumination D65 illuminant; and
a first surface reflected color of the coated article at the second portion is defined by −10<a*<10 and −10<b*<10 for all angles of incidence from 0 degrees to 90 degrees as measured normal to the second portion of the major surface, as measured by the reflectance color coordinates in the (L*, a*, b*) colorimetry system under an International Commission on Illumination D65 illuminant.

22. A coated article, comprising:
a substrate having a major surface, the major surface comprising a first portion and a second portion, wherein a first direction that is normal to the first portion of the major surface is not equal to a second direction that is normal to the second portion of the major surface, and the angle between the first direction and the second direction is at least 30 degrees; and
an optical film structure defining an outer surface, the optical film structure disposed on the major surface,
wherein the optical film structure comprises a scratch-resistant layer and a plurality of alternating high refractive index (RI) and low RI layers,
wherein the optical film structure further comprises an outer structure and an inner structure, the scratch-resistant layer disposed between the outer and inner structures,
wherein the outer structure comprises at least one medium RI layer in contact with one of the high RI layers or the scratch-resistant layer, and
further wherein the medium RI layer comprises a refractive index from 1.55 to 1.80, each of the high RI layers comprises a refractive index of greater than 1.80, and each of the low RI layers comprises a refractive index of less than 1.55.

23. The coated article of claim 22, wherein the substrate is a glass-ceramic substrate that comprises an elastic modulus of greater than 85 GPa and a fracture toughness of greater than 0.8 MPa·√m, and further wherein the optical film structure exhibits a residual compressive stress of greater than or equal to 700 MPa and an elastic modulus of greater than or equal to 140 GPa.
